(19) United States
(12) Patent Application Publication
(10) Pub. No.: US 2025/0380000 A1
(43) Pub. Date: Dec. 11, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Zhipin DENG, Beijing (CN); Kai ZHANG, Los Angeles, CA (US); Li ZHANG, Los Angeles, CA (US)

(21) Appl. No.: 19/312,243

(22) Filed: Aug. 27, 2025

Related U.S. Application Data
(63) Continuation of application No. PCT/CN2024/078865, filed on Feb. 27, 2024.

(30) Foreign Application Priority Data
Apr. 5, 2023 (WO) PCT/CN2023/078821

(51) Int. Cl. H04N 19/513; H04N 19/105; H04N 19/184; H04N 19/196; H04N 19/54

(52) U.S. Cl. CPC H04N 19/521; H04N 19/105; H04N 19/184; H04N 19/196; H04N 19/54

(57) ABSTRACT

Embodiments of the present disclosure provide a solution for video processing. A method for video processing is proposed. The method comprises: obtaining, for a conversion between a current video unit of a video and a bitstream of the video, first information regarding whether to apply a sample-based affine scheme to the current video unit, wherein the first information is determined based on second information regarding usage of an overlap subblock based motion compensation (OBMC) on the current video unit, and the current video unit is coded with an affine-based mode; and performing the conversion based on the first information.

### CROSS REFERENCE TO RELATED APPLICATIONS

This application is a continuation of International Application No. PCT/CN2024/078865, filed on Feb. 27, 2024, which claims the benefit of International Application No. PCT/CN2023/078821, filed on Feb. 28, 2023. The entire contents of these applications are hereby incorporated by reference in their entireties.

### FIELDS

Embodiments of the present disclosure relates generally to video processing techniques, and more particularly, to coding tool control.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding quality of video coding techniques is generally expected to be further improved.

### SUMMARY

Embodiments of the present disclosure provide a solution for video processing.

In a first aspect, a method for video processing is proposed. The method comprises: obtaining, for a conversion between a current video unit of a video and a bitstream of the video, first information regarding whether to apply a sample-based affine scheme to the current video unit, wherein the first information is determined based on second information regarding usage of an overlap subblock based motion compensation (OBMC) on the current video unit, and the current video unit is coded with an affine-based mode; and performing the conversion based on the first information.

According to the method in accordance with the first aspect of the present disclosure, the information regarding whether to apply a sample-based affine scheme to an affine coded video unit is dependent on the usage of OBMC. Compared with the conventional solution, the proposed method can advantageously enable adaptive control of the sample-based affine scheme, and thus the sample-based affine scheme can be controlled more flexibly. Thereby, the coding quality can be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: obtaining first information regarding whether to apply a sample-based affine scheme to a current video unit of the video, wherein the first information is determined based on second information regarding usage of an overlap subblock based motion compensation (OBMC) on the current video unit, and the current video unit is coded with an affine-based mode; and generating the bitstream based on the first information.

In a fifth aspect, a method for storing a bitstream of a video is proposed. The method comprises: obtaining first information regarding whether to apply a sample-based affine scheme to a current video unit of the video, wherein the first information is determined based on second information regarding usage of an overlap subblock based motion compensation (OBMC) on the current video unit, and the current video unit is coded with an affine-based mode; generating the bitstream based on the first information; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates intra prediction modes;

FIG. 5A illustrates reference samples for wide-angular intra prediction;

FIG. 5B illustrates reference samples for wide-angular intra prediction;

FIG. 6 illustrates problem of discontinuity in case of directions beyond 45°;

FIG. 7A illustrates a schematic diagram of a definition of samples used by PDPC applied to a diagonal top-right mode of diagonal and adjacent angular intra modes;

FIG. 7B illustrates a schematic diagram of a definition of samples used by PDPC applied to a diagonal bottom-left mode of diagonal and adjacent angular intra modes;

FIG. 7C illustrates a schematic diagram of a definition of samples used by PDPC applied to an adjacent diagonal top-right mode of diagonal and adjacent angular intra modes;

FIG. 7D illustrates a schematic diagram of a definition of samples used by PDPC applied to an adjacent diagonal bottom-left mode of diagonal and adjacent angular intra modes;

FIG. 8 illustrates an example of four reference lines neighboring to a prediction block;

FIG. 9A illustrates a schematic diagram of a process of sub-partition depending on the block size;

FIG. 9B illustrates a schematic diagram of a process of sub-partition depending on the block size;

FIG. 10 illustrates matrix weighted intra prediction process;

FIG. 11 illustrates spatial GPM candidates;

FIG. 12 illustrates GPM template;

FIG. 13 illustrates GPM blending;

FIG. 14 illustrates positions of spatial merge candidate;

FIG. 15 illustrates candidate pairs considered for redundancy check of spatial merge candidates;

FIG. 16 illustrates illustration of motion vector scaling for temporal merge candidate;

FIG. 17 illustrates candidate positions for temporal merge candidate, C₀ and C₁;

FIG. 18 illustrates MMVD Search Point;

FIG. 19 illustrates extended CU region used in BDOF;

FIG. 20 illustrates illustration for symmetrical MVD mode;

FIG. 21 illustrates decoding side motion vector refinement;

FIG. 22 illustrates top and left neighboring blocks used in CIIP weight derivation;

FIG. 23 illustrates examples of the GPM splits grouped by identical angles;

FIG. 24 illustrates uni-prediction MV selection for geometric partitioning mode;

FIG. 25 illustrates exemplified generation of a bending weight w₀ using geometric partitioning mode;

FIG. 26 illustrates current CTU processing order and its available reference samples in current and left CTU;

FIG. 27 illustrates residual coding passes for transform skip blocks;

FIG. 28 illustrates an example of a block coded in palette mode;

FIG. 29 illustrates subblock-based index map scanning for palette, left for horizontal scanning and right for vertical scanning;

FIG. 30 illustrates decoding flowchart with ACT;

FIG. 31 illustrates intra template matching search area used;

FIG. 32 illustrates the five locations in reconstructed luma samples;

FIG. 33 illustrates the prediction process of DBV mode;

FIG. 34 illustrates Low-Frequency Non-Separable Transform (LFNST) process;

FIG. 35 illustrates SBT position, type and transform type;

FIG. 36 illustrates the ROI for LFNST16;

FIG. 37 illustrates the ROI for LFNST8;

FIG. 38 illustrates discontinuity measure;

FIG. 39 illustrates a flowchart of a method for video processing in accordance with embodiments of the present disclosure; and

FIG. 40 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

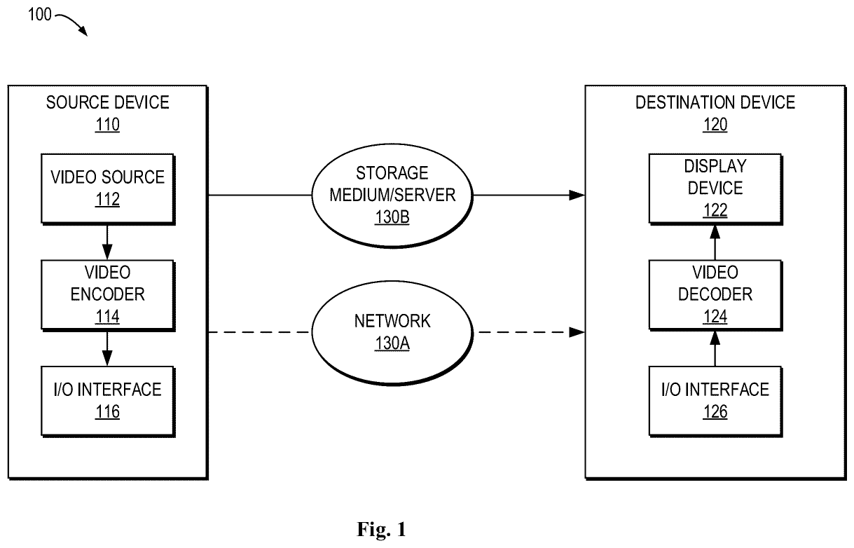

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

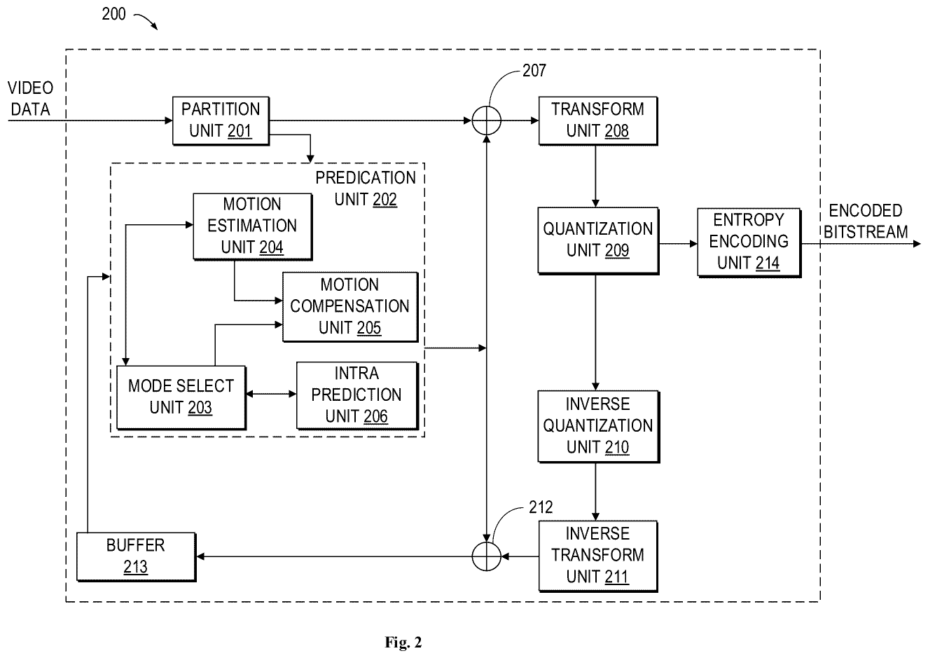

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

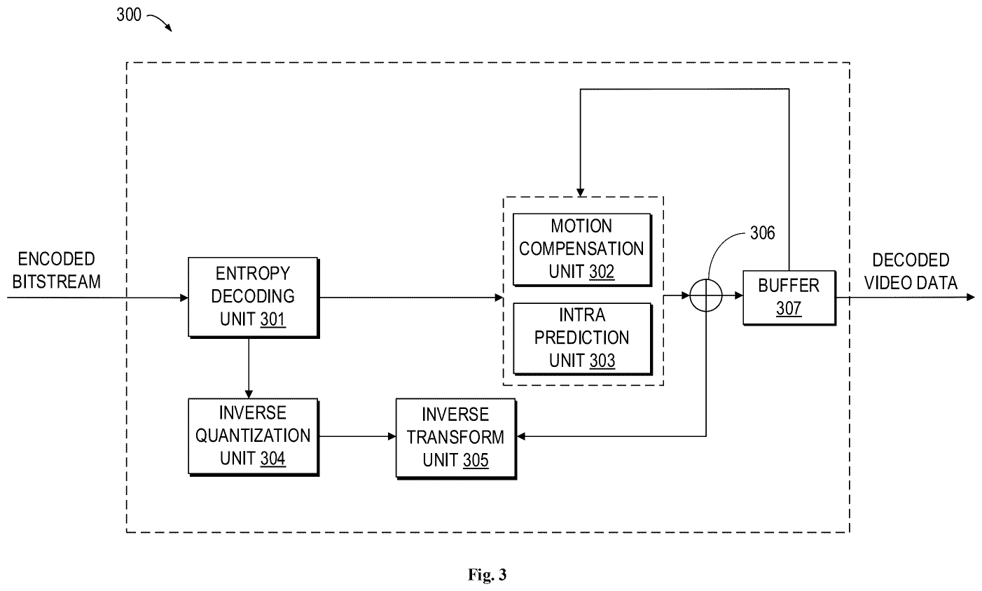

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video coding technologies. Specifically, it is about coding tool on/off control and related techniques in image/video coding. It may be applied to the existing video coding standard like HEVC, VVC, and etc. It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

### 2.1 Existing Coding Tools

### 2.1.1 Intra Prediction

2.1.1.1 Intra Mode Coding with 67 Intra Prediction Modes

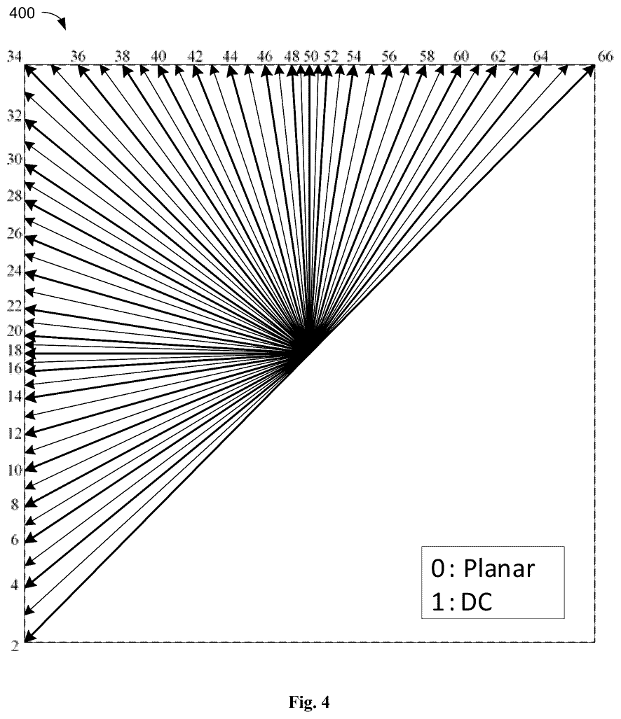

To capture the arbitrary edge directions presented in natural video, the number of directional intra modes in VVC is extended from 33, as used in HEVC, to 65. The new directional modes not in HEVC are depicted as red dotted arrows in FIG. 4, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.1.1.2 Intra Mode Coding

FIG. 4 illustrates intra prediction modes. To keep the complexity of the most probable mode (MPM) list generation low, an intra mode coding method with 6 MPMs is used by considering two available neighboring intra modes. The following three aspects are considered to construct the MPM list:
Default intra modes,
Neighbouring intra modes,
Derived intra modes.

A unified 6-MPM list is used for intra blocks irrespective of whether MRL and ISP coding tools are applied or not. The MPM list is constructed based on intra modes of the left and above neighboring block. Suppose the mode of the left is denoted as Left and the mode of the above block is denoted as Above, the unified MPM list is constructed as follows:
When a neighboring block is not available, its intra mode is set to Planar by default.
If both modes Left and Above are non-angular modes:
   MPM list→{Planar, DC, V, H, V−4, V+4}.
If one of modes Left and Above is angular mode, and the other is non-angular:
   Set a mode Max as the larger mode in Left and Above.
   MPM list→{Planar, Max, DC, Max−1, Max+1, Max−2}.
If Left and Above are both angular and they are different:
   Set a mode Max as the larger mode in Left and Above.
   if the difference of mode Left and Above is in the range of 2 to 62, inclusive.
      MPM list→{Planar, Left, Above, DC, Max−1, Max+1}.
   Otherwise,
      MPM list→{Planar, Left, Above, DC, Max−2, Max+2}.
If Left and Above are both angular and they are the same:
   MPM list→{Planar, Left, Left−1, Left+1, DC, Left−2}.

Besides, the first bin of the mpm index codeword is CABAC context coded. In total three contexts are used, corresponding to whether the current intra block is MRL enabled, ISP enabled, or a normal intra block. During 6 MPM list generation process, pruning is used to remove duplicated modes so that only unique modes can be included into the MPM list. For entropy coding of the 61 non-MPM modes, a Truncated Binary Code (TBC) is used.

### 2.1.1.3 Wide-Angle Intra Prediction for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

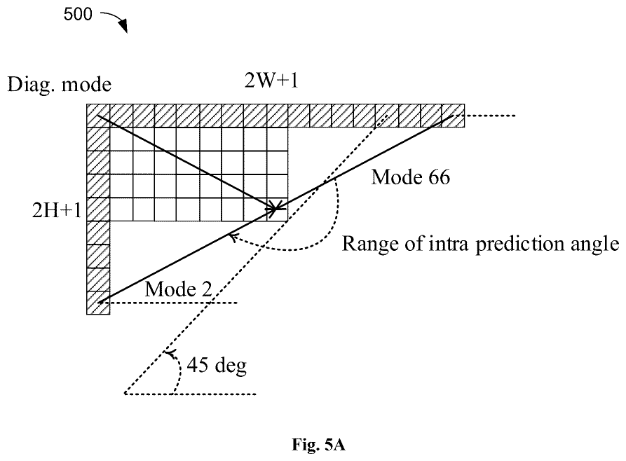

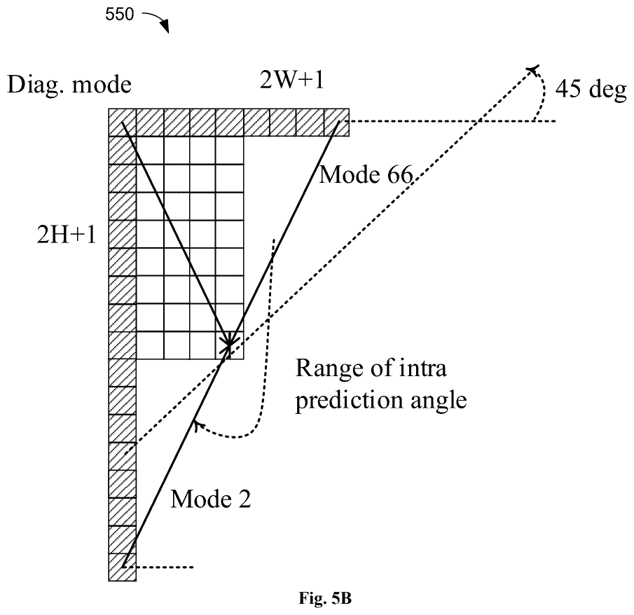

To support these prediction directions, the top reference with length 2W+1, and the left reference with length 2H+1, are defined as shown in FIGS. 5A and 5B.

The number of replaced modes in wide-angular direction mode depends on the aspect ratio of a block. The replaced intra prediction modes are illustrated in Table 2-1.

TABLE 2-1
Intra prediction modes replaced by wide-angular modes

| Aspect ratio | Replaced intra prediction modes |
|---|---|
| W/H == 16 | Modes 12, 13, 14, 15 |
| W/H == 8 | Modes 12, 13 |
| W/H == 4 | Modes 2, 3, 4, 5, 6, 7, 8, 9, 10, 11 |
| W/H == 2 | Modes 2, 3, 4, 5, 6, 7, |
| W/H == 1 | None |
| W/H == ½ | Modes 61, 62, 63, 64, 65, 66 |
| W/H == ¼ | Mode 57, 58, 59, 60, 61, 62, 63, 64, 65, 66 |
| W/H == ⅛ | Modes 55, 56 |
| W/H == 1/16 | Modes 53, 54, 55, 56 |

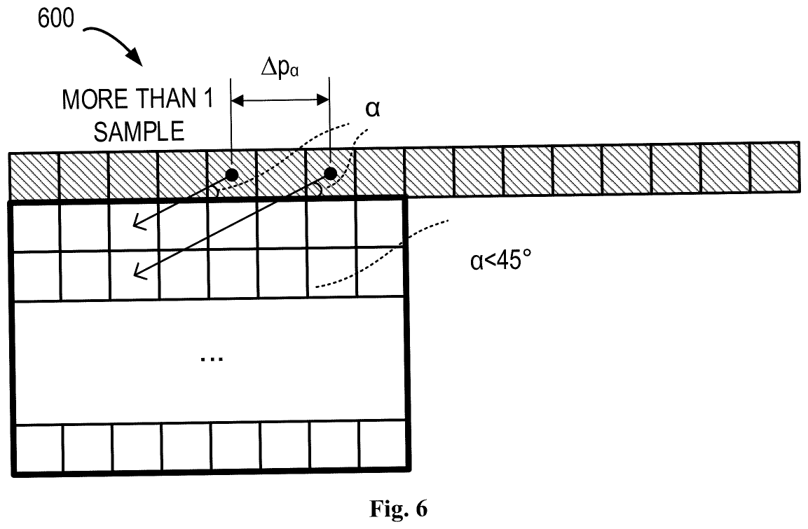

As shown in FIG. 6, two vertically-adjacent predicted samples may use two non-adjacent reference samples in the case of wide-angle intra prediction. Hence, low-pass reference samples filter and side smoothing are applied to the wide-angle prediction to reduce the negative effect of the increased gap Δp_{α}. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### 2.1.1.4 Mode Dependent Intra Smoothing (MDIS)

Four-tap intra interpolation filters are utilized to improve the directional intra prediction accuracy. In HEVC, a two-tap linear interpolation filter has been used to generate the intra prediction block in the directional prediction modes (i.e., excluding Planar and DC predictors). In VVC, simplified 6-bit 4-tap Gaussian interpolation filter is used for only directional intra modes. Non-directional intra prediction process is unmodified. The selection of the 4-tap filters is performed according to the MDIS condition for directional intra prediction modes that provide non-fractional displacements, i.e. to all the directional modes excluding the following: 2, HOR_IDX, DIA_IDX, VER_IDX, 66.

Depending on the intra prediction mode, the following reference samples processing is performed:
The directional intra-prediction mode is classified into one of the following groups:
   vertical or horizontal modes (HOR_IDX, VER_IDX),
   diagonal modes that represent angles which are multiple of 45 degree (2, DIA_IDX, VDIA_IDX),
   remaining directional modes;
If the directional intra-prediction mode is classified as belonging to group A, then then no filters are applied to reference samples to generate predicted samples;
Otherwise, if a mode falls into group B, then a [1, 2, 1] reference sample filter may be applied (depending on the MDIS condition) to reference samples to further copy these filtered values into an intra predictor according to the selected direction, but no interpolation filters are applied;
Otherwise, if a mode is classified as belonging to group C, then only an intra reference sample interpolation filter is applied to reference samples to generate a predicted sample that falls into a fractional or integer position between reference samples according to a selected direction (no reference sample filtering is performed).

### 2.1.1.5 Position Dependent Intra Prediction Combination

In VVC, the results of intra prediction of DC, planar and several angular modes are further modified by a position dependent intra prediction combination (PDPC) method. PDPC is an intra prediction method which invokes a combination of the un-filtered boundary reference samples and HEVC style intra prediction with filtered boundary reference samples. PDPC is applied to the following intra modes without signalling: planar, DC, horizontal, vertical, bottom-left angular mode and its eight adjacent angular modes, and top-right angular mode and its eight adjacent angular modes.

The prediction sample pred(x′,y′) is predicted using an intra prediction mode (DC, planar, angular) and a linear combination of reference samples according to the Equation 3-8 as follows:

$$pred ( {x}^{′} , {y}^{′} ) = ( w L \times {R}_{- 1 , {y}^{′}} + wT \times {R}_{{x}^{′} , - 1} - wTL \times {R}_{- 1 , - 1} + ( 64 - w L - w T + w T L ) \times p red ( {x}^{′} , {y}^{′} ) + 32 ) ≫ 6 \qquad ( 2 - 1 )$$

where R_{x,-1}, R_{-1,y} represent the reference samples located at the top and left boundaries of current sample (x,y), respectively, and R_{-1,-1} represents the reference sample located at the top-left corner of the current block. If PDPC is applied to DC, planar, horizontal, and vertical intra modes, additional boundary filters are not needed, as required in the case of HEVC DC mode boundary filter or horizontal/vertical mode edge filters. PDPC process for DC and Planar modes is identical and clipping operation is avoided. For angular modes, pdpc scale factor is adjusted such that range check is not needed and condition on angle to enable pdpc is removed (scale>=0 is used). In addition, PDPC weight is based on 32 in all angular mode cases. The PDPC weights are dependent on prediction modes and are shown in Table 2-2. PDPC is applied to the block with both width and height greater than or equal to 4.

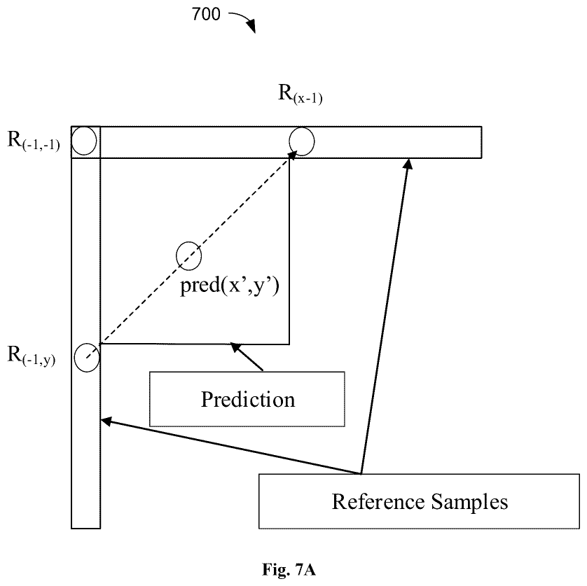

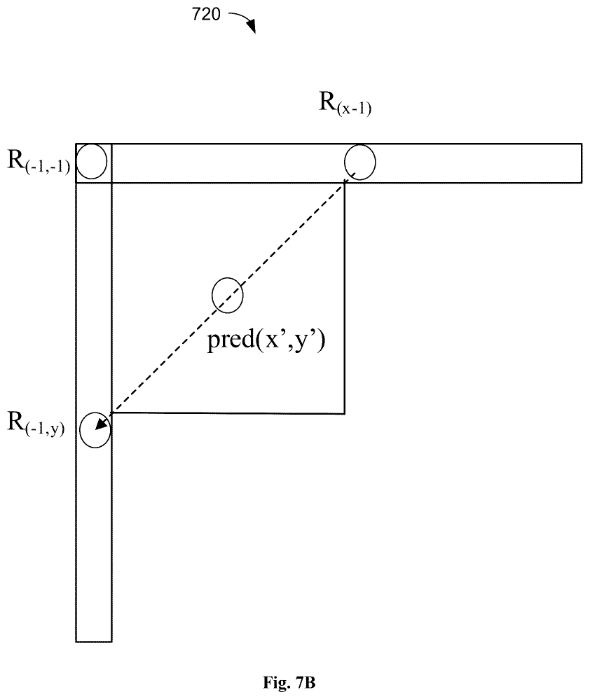

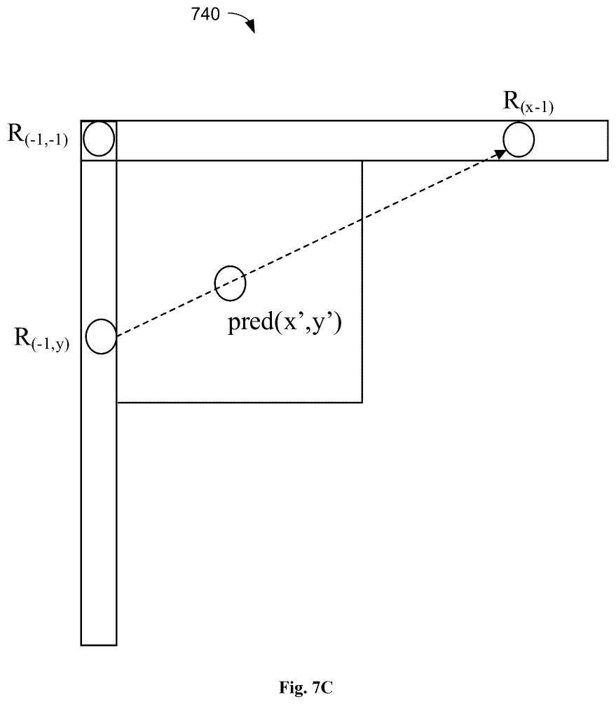

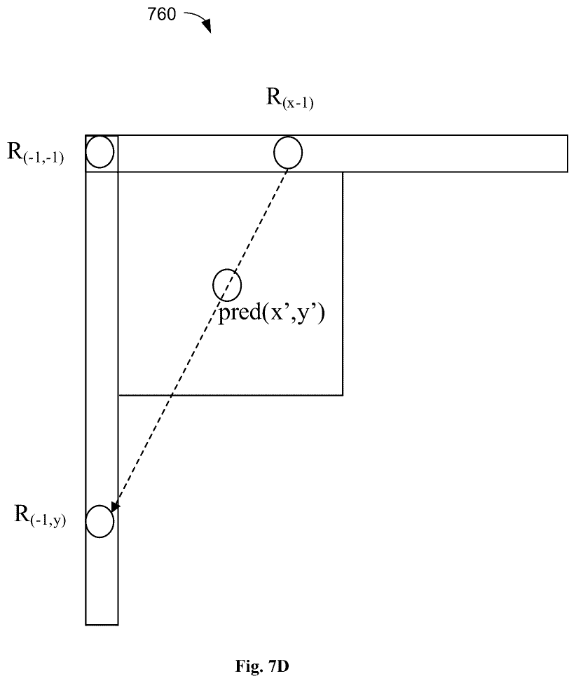

FIGS. 7A-7D illustrate the definition of reference samples (R_{x,-1}, R_{-1,y} and R_{-1,-1}) for PDPC applied over various prediction modes. The prediction sample pred(x′, y′) is located at (x′, y′) within the prediction block. As an example, the coordinate x of the reference sample R_{x,-1} is given by: x=x′+y′+1, and the coordinate y of the reference sample R_{-1,y} is similarly given by: y=x′+y′+1 for the diagonal modes. For the other annular mode, the reference samples R_{x,-1} and R_{-1,y} could be located in fractional sample position. In this case, the sample value of the nearest integer sample location is used.

TABLE 2-2
Example of PDPC weights according to prediction modes

| Prediction modes | wT | wL | wTL |
|---|---|---|---|
| Diagonal top-right | 16 >> ((y′ << 1) >> | 16 >> ((x′ << 1) >> | 0 |
| | shift) | shift) | |
| Diagonal bottom-left | 16 >> ((y′ << 1) >> | 16 >> ((x′ << 1) >> | 0 |
| | shift) | shift) | |
| Adjacent diagonal | 32 >> ((y′ << 1) >> | 0 | 0 |
| top-right | shift) | | |
| Adjacent diagonal | 0 | 32 >> ((x′ << 1) >> | 0 |
| bottom-left | | shift) | |

### 2.1.1.6 Multiple Reference Line (MRL) Intra Prediction

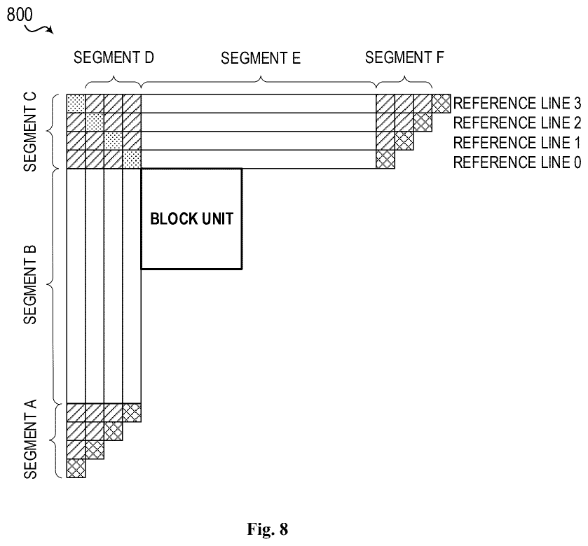

Multiple reference line (MRL) intra prediction uses more reference lines for intra prediction. In FIG. 8, an example of 4 reference lines is depicted, where the samples of segments A and F are not fetched from reconstructed neighbouring samples but padded with the closest samples from Segment B and E, respectively. HEVC intra-picture prediction uses the nearest reference line (i.e., reference line 0). In MRL, 2 additional lines (reference line 1 and reference line 3) are used.

The index of selected reference line (mrl_idx) is signalled and used to generate intra predictor. For reference line idx, which is greater than 0, only include additional reference line modes in MPM list and only signal mpm index without remaining mode. The reference line index is signalled before intra prediction modes, and Planar mode is excluded from intra prediction modes in case a nonzero reference line index is signalled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices is aligned with that of reference line index 0. MRL requires the storage of 3 neighboring luma reference lines with a CTU to generate predictions. The Cross-Component Linear Model (CCLM) tool also requires 3 neighboring luma reference lines for its downsampling filters. The definition of MLR to use the same 3 lines is aligned as CCLM to reduce the storage requirements for decoders.

### 2.1.1.7 Intra Sub-Partitions (ISP)

The intra sub-partitions (ISP) divides luma intra-predicted blocks vertically or horizontally into 2 or 4 sub-partitions depending on the block size. For example, minimum block size for ISP is 4×8 (or 8×4). If block size is greater than 4×8 (or 8×4) then the corresponding block is divided by 4 sub-partitions. It has been noted that the M×128 (with M≤64) and 128×N (with N≤64) ISP blocks could generate a potential issue with the 64×64 VDPU. For example, an M×128 CU in the single tree case has an M×128 luma TB and two corresponding

$$\frac{M}{2} \times 64$$

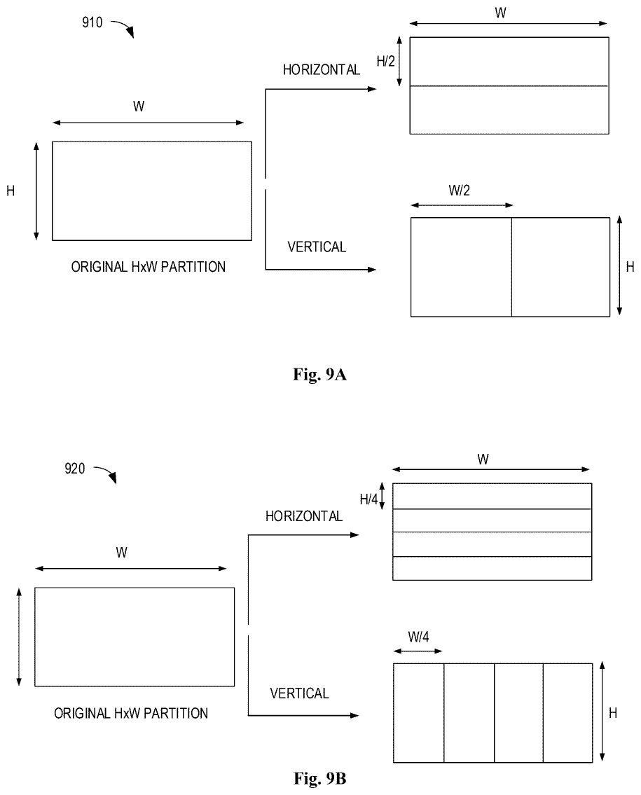

chroma TBs. If the CU uses ISP, then the luma TB will be divided into four M×32 TBs (only the horizontal split is possible), each of them smaller than a 64×64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64×64 decoder pipeline. For this reason, the CU sizes that can use ISP is restricted to a maximum of 64×64. FIGS. 9A and 9B shows examples of the two possibilities. FIG. 9A illustrates examples of sub-partitions for 4×8 and 8×4 CUs, and FIG. 9B illustrates examples of sub-partitions for CUs other than 4×8, 8×4 and 4×4. All sub-partitions fulfill the condition of having at least 16 samples.

In ISP, the dependence of 1×N/2×N subblock prediction on the reconstructed values of previously decoded 1×N/2×N subblocks of the coding block is not allowed so that the minimum width of prediction for subblocks becomes four samples. For example, an 8×N (N>4) coding block that is coded using ISP with vertical split is split into two prediction regions each of size 4×N and four transforms of size 2×N. Also, a 4×N coding block that is coded using ISP with vertical split is predicted using the full 4×N block; four transform each of 1×N is used. Although the transform sizes of 1×N and 2×N are allowed, it is asserted that the transform of these blocks in 4×N regions can be performed in parallel. For example, when a 4×N prediction region contains four 1×N transforms, there is no transform in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, there is no delay added in processing these smaller blocks than processing 4×4 regular-coded intra blocks.

TABLE 2-3
Entropy coding coefficient group size

| Block Size | Coefficient group Size |
|---|---|
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode. The followings are summary of interaction of ISP with other coding tools.
Multiple Reference Line (MRL): if a block has an MRL index other than 0, then the ISP coding mode will be inferred to be 0 and therefore ISP mode information will not be sent to the decoder.
Entropy coding coefficient group size: the sizes of the entropy coding subblocks have been modified so that they have 16 samples in all possible cases, as shown in Table 2-3. Note that the new sizes only affect blocks produced by ISP in which one of the dimensions is less than 4 samples. In all other cases coefficient groups keep the 4×4 dimensions.
CBF coding: it is assumed to have at least one of the sub-partitions has a non-zero CBF. Hence, if n is the number of sub-partitions and the first n−1 sub-partitions have produced a zero CBF, then the CBF of the n-th sub-partition is inferred to be 1.
MPM usage: the MPM flag will be inferred to be one in a block coded by ISP mode, and the MPM list is modified to exclude the DC mode and to prioritize horizontal intra modes for the ISP horizontal split and vertical intra modes for the vertical one.
Transform size restriction: all ISP transforms with a length larger than 16 points uses the DCT-II.
PDPC: when a CU uses the ISP coding mode, the PDPC filters will not be applied to the resulting sub-partitions.
MTS flag: if a CU uses the ISP coding mode, the MTS CU flag will be set to 0 and it will not be sent to the decoder. Therefore, the encoder will not perform RD tests for the different available transforms for each resulting sub-partition. The transform choice for the ISP mode will instead be fixed and selected according the intra mode, the processing order and the block size utilized. Hence, no signalling is required. For example, let ty and ty be the horizontal and the vertical transforms selected respectively for the w×h sub-partition, where w is the width and h is the height. Then the transform is selected according to the following rules:
   If w=1 or h=1, then there is no horizontal or vertical transform respectively.
   If w=2 or w>32, t_{H}=DCT-II.
   If h=2 or h>32, t_{V}=DCT-II.
   Otherwise, the transform is selected as in Table 2-4.

TABLE 2-4
Transform selection depends on intra mode

| Intra mode | t_{H} | t_{V} |
|---|---|---|
| Planar | DST-VII | DST-VII |
| Ang. 31, 32, 34, 36, 37 | | |
| DC | DCT-II | DCT-II |
| Ang. 33, 35 | | |
| Ang. 2, 4, 6 . . . 28, 30 | DST-VII | DCT-II |
| Ang. 39, 41, 43 . . . 63, 65 | | |
| Ang. 3, 5, 7 . . . 27, 29 | DCT-II | DST-VII |
| Ang. 38, 40, 42 . . . 64, 66 | | |

In ISP mode, all 67 intra modes are allowed. PDPC is also applied if corresponding width and height is at least 4 samples long. In addition, the condition for intra interpolation filter selection doesn't exist anymore, and Cubic (DCT-IF) filter is always applied for fractional position interpolation in ISP mode.

### 2.1.1.8 Matrix Weighted Intra Prediction (MIP)

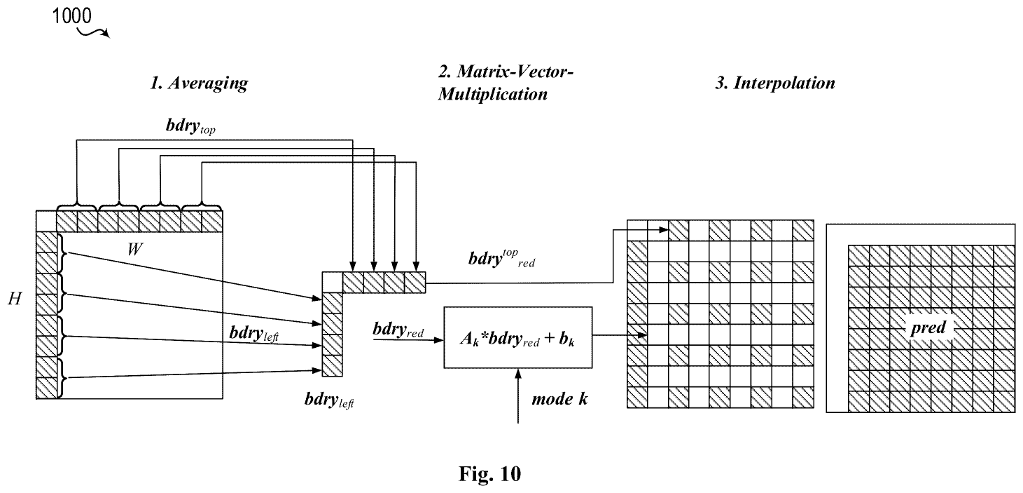

Matrix weighted intra prediction (MIP) method is a newly added intra prediction technique into VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, which are averaging, matrix vector multiplication and linear interpolation as shown in FIG. 10.

### Averaging Neighboring Samples

Among the boundary samples, four samples or eight samples are selected by averaging based on block size and shape. Specifically, the input boundaries bdry^{top} and bdry^{left} are reduced to smaller boundaries

$$b d r {y}_{red}^{top} and {bdry}_{red}^{left}$$

by averaging neighboring boundary samples according to predefined rule depends on block size. Then, the two reduced boundaries

$$b d r {y}_{red}^{top} and {bdry}_{red}^{left}$$

are concatenated to a reduced boundary vector bdry_{red} which is thus of size four for blocks of shape 4×4 and of size eight for blocks of all other shapes. If mode refers to the MIP-mode, this concatenation is defined as follows.

$$b d r {y}_{red} = \{ \begin{matrix}[ {bdry}_{red}^{top} , {bdry}_{red}^{left} ] & for W = H = 4 and mode < 18 \\ [ {bdry}_{red}^{left} , {bdry}_{red}^{top} ] & for W = H = 4 and mode \geq 18 \\ [ {bdry}_{red}^{top} , {bdry}_{red}^{left} ] & for max ( W , H ) = 8 and mode < 10 \\ [ {bdry}_{red}^{left} , {bdry}_{red}^{top} ] & for max ( W , H ) = 8 and mode \geq 10 \\ [ {bdry}_{red}^{top} , {bdry}_{red}^{left} ] & for max ( W , H ) > 8 and mode < 6 \\ [ {bdry}_{red}^{left} , {bdry}_{red}^{top} ] & for max ( W , H ) > 8 and mode \geq 6.\end{matrix} \qquad ( 2 - 2 )$$

### Matrix Multiplication

A matrix vector multiplication, followed by addition of an offset, is carried out with the averaged samples as an input. The result is a reduced prediction signal on a subsampled set of samples in the original block. Out of the reduced input vector bdry_{red} a reduced prediction signal pred_{red}, which is a signal on the downsampled block of width W_{red} and height H_{red} is generated. Here, W_{red} and H_{red} are defined as:

$${W}_{red} = \{ \begin{matrix}4 & for max ( W , H ) \leq 8 \\ min ( W , 8 ) & for max ( W , H ) > 8\end{matrix} \qquad ( 2 - 3 )$$

$${H}_{red} = \{ \begin{matrix}4 & for max ( W , H ) \leq 8 \\ min ( H , 8 ) & for max ( W , H ) > 8\end{matrix} \qquad ( 2 - 4 )$$

The reduced prediction signal pred_{red} is computed by calculating a matrix vector product and adding an offset:

$${pred}_{red} = A \cdot {bdry}_{red} + b .$$

Here, A is a matrix that has W_{red}·H_{red} rows and 4 columns if W=H=4 and 8 columns in all other cases. b is a vector of size W_{red}·H_{red}. The matrix A and the offset vector b are taken from one of the sets S₀, S₁, S₂. One defines an index idx=idx(W,H) as follows:

$$idx ( W , H ) = \{ \begin{matrix}0 & for W = H = 4 \\ 1 & for max ( W , H ) = 8 \\ 2 & for max ( W , H > 8 )\end{matrix} \qquad ( 2 - 5 )$$

Here, each coefficient of the matrix A is represented with 8 bit precision. The set S₀ consists of 16 matrices

$${A}_{0}^{i} ,$$

i∈{0, . . . , 15} each of which has 16 rows and 4 columns and 16 offset vectors

$${b}_{0}^{i} ,$$

i∈{0, . . . , 16} each of size 16. Matrices and offset vectors of that set are used for blocks of size 4×4. The set S₁ consists of 8 matrices

$${A}_{1}^{i} ,$$

i∈{0, . . . , 7}, each of which has 16 rows and 8 columns and 8 offset vectors b₁ⁱ, i∈{0, . . . , 7} each of size 16.

The set S₂ consists of 6 matrices

$${A}_{2}^{i} ,$$

i∈{0, . . . , 5}, each of which has 64 rows and 8 columns and of 6 offset vectors

$${b}_{2}^{i} ,$$

i∈{0, . . . , 5} of size 64.

### Interpolation

The prediction signal at the remaining positions is generated from the prediction signal on the subsampled set by linear interpolation which is a single step linear interpolation in each direction. The interpolation is performed firstly in the horizontal direction and then in the vertical direction regardless of block shape or block size.

Signaling of MIP Mode and Harmonization with Other Coding Tools

For each Coding Unit (CU) in intra mode, a flag indicating whether an MIP mode is to be applied or not is sent. If an MIP mode is to be applied, MIP mode (predModeIntra) is signaled. For an MIP mode, a transposed flag (isTransposed), which determines whether the mode is transposed, and MIP mode Id (modeId), which determines which matrix is to be used for the given MIP mode is derived as follows:

$$\begin{matrix}isTransposed = predModeIntra \& 1 \\ modeId = predModeIntra ≫ 1\end{matrix} \qquad ( 2 - 6 )$$

MIP coding mode is harmonized with other coding tools by considering following aspects:
LFNST is enabled for MIP on large blocks. Here, the LFNST transforms of planar mode are used.
The reference sample derivation for MIP is performed exactly as for the conventional intra prediction modes.
For the upsampling step used in the MIP-prediction, original reference samples are used instead of downsampled ones.
Clipping is performed before upsampling and not after upsampling.
MIP is allowed up to 64×64 regardless of the maximum transform size.
The number of MIP modes is 32 for sizeId=0, 16 for sizeId=1 and 12 for sizeId=2.

### 2.1.1.9 Spatial GPM (SGPM)

In spatial GPM, a candidate list is built which includes partition split and two intra prediction modes. Up to 11 MPMs of intra prediction modes are used to form the combinations, the length of the candidate list is set equal to 16. The selected candidate index is signalled.

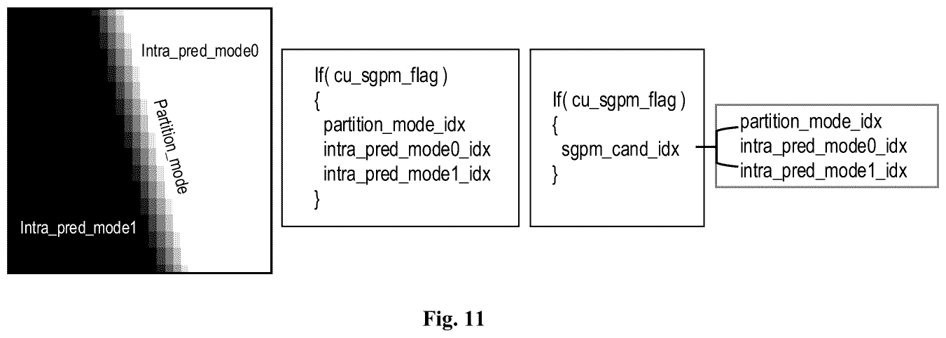

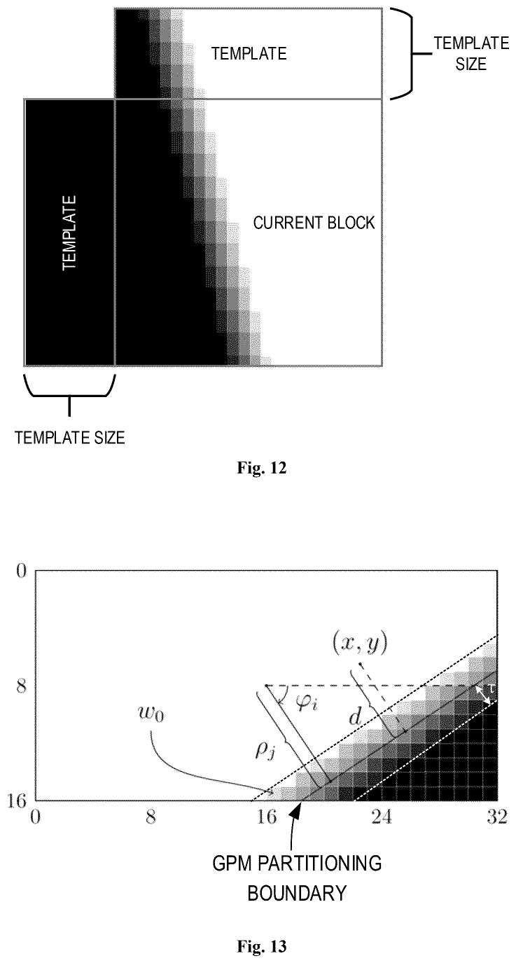

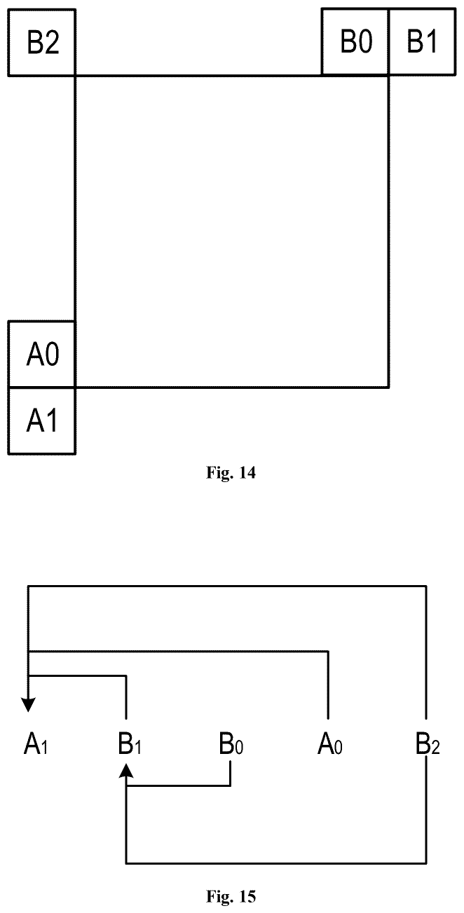

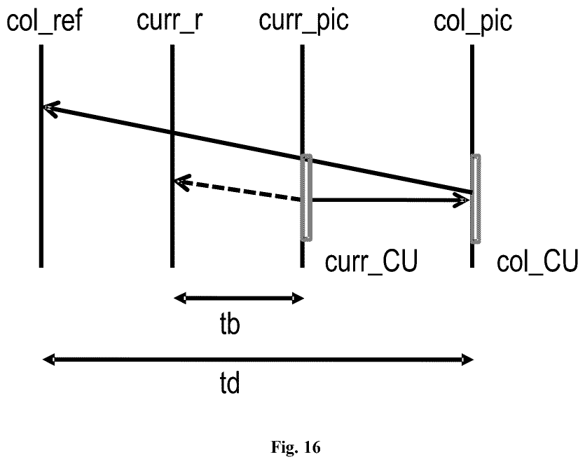

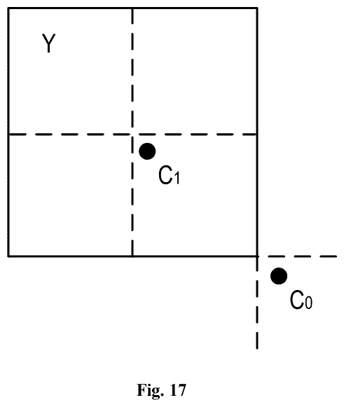

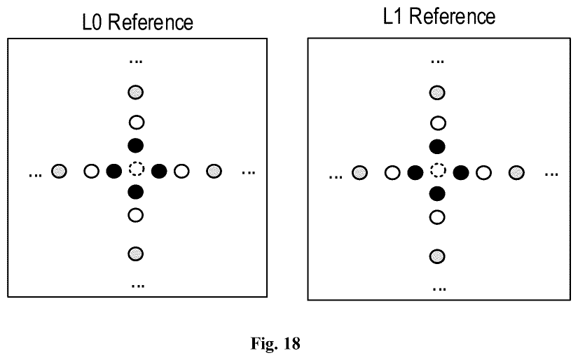

The list is reordered using template shown in FIG. 11. GPM blending process is not used in the template, and SAD between the prediction and reconstruction of the template is used for ordering.

The SGPM mode is applied to blocks whose width and height meet the same restrictions as in inter GPM.

The following items are considered:
Spatial GPM partition modes:
   26 predefined modes.
   Adaptive derivation algorithm based on the horizontal and vertical gradients ratio.
Intra prediction mode selection:
   IPM list with and without TIMD:
      For each partition mode, an IPM list is derived for each part using intra-inter GPM list derivation. The IPM list size is 3. In the list, TIMD derived mode is replaced by 2 derived modes with horizontal and vertical orientations (using top or left templates) or TIMD derived mode is excluded.
   MPM list:
      A uniform MPM list, up to 11 elements, is used for all partition modes.
Template size (left and above): 1 or 4.
Extended block size:
   Spatial GPM is extended to be further applied to 4×8, 8×4, 4×16 and 16×4 blocks, which can be described as 4<=width<=64, 4<=height<=64, width<height*8, height<width*8, width*height>=32.
Adaptive blending:
   Adaptive blending is tested for spatial GPM, where blending depth t is derived as follows:
      If min(width, height)==4, ½ τ is selected.
      else if min(width, height)==8, τ is selected.
      else if min(width, height)==16, 2 τ is selected.
      else if min(width, height)==32, 4 τ is selected.
      else, 8 τ is selected.

### 2.1.2 Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction.
Merge mode with MVD (MMVD).
Symmetric MVD (SMVD) signalling.
Affine motion compensated prediction.
Subblock-based temporal motion vector prediction (SbTMVP).
Adaptive motion vector resolution (AMVR).
Motion field storage: 1/16th luma sample MV storage and 8×8 motion field compression.
Bi-prediction with CU-level weight (BCW).
Bi-directional optical flow (BDOF).
Decoder side motion vector refinement (DMVR).
Geometric partitioning mode (GPM).
Combined inter and intra prediction (CIIP).

The following text provides the details on those inter prediction methods specified in VVC.

### 2.1.2.1 Extended Merge Prediction

In VVC, the merge candidate list is constructed by including the following five types of candidates in order:
1) Spatial MVP from spatial neighbour CUs.
2) Temporal MVP from collocated CUs.
3) History-based MVP from an FIFO table.
4) Pairwise average MVP.
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### 2.1.2.1.1 Spatial Candidates Derivation

The derivation of spatial merge candidates in VVC is same to that in HEVC except the positions of first two merge candidates are swapped. A maximum of four merge candidates are selected among candidates located in the positions depicted in the above Figure. The order of derivation is B₀, A₀, B₁, A₁ and B₂. Position B₂ is considered only when one or more than one CUs of position B₀, A₀, B₁, A₁ are not available (e.g. because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. Instead only the pairs linked with an arrow in below Figure are considered and a candidate is only added to the list if the corresponding candidate used for redundancy check has not the same motion information.

### 2.1.2.1.2 Temporal Candidates Derivation

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. The scaled motion vector for temporal merge candidate is obtained as illustrated by the dotted line in below Figure, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in below Figure. If CU at position C₀ is not available, is intra coded, or is outside of the current row of CTUs, position C₁ is used. Otherwise, position C₀ is used in the derivation of the temporal merge candidate.

### 2.1.2.1.3 History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate. To reduce the number of redundancy check operations, the following simplifications are introduced:
1. Number of HMPV candidates is used for merge list generation is set as (N<=4)?M:(8−N), wherein N indicates number of existing candidates in the merge list and M indicates number of available HMVP candidates in the table.
2. Once the total number of available merge candidates reaches the maximally allowed merge candidates minus 1, the merge candidate list construction process from HMVP is terminated.

### 2.1.2.1.4 Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid.

When the merge list is not full after pair-wise average merge candidates are added, the zero MVPs are inserted in the end until the maximum merge candidate number is encountered.

### 2.1.2.2 Merge Estimation Region

Merge estimation region (MER) allows independent derivation of merge candidate list for the CUs in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)>>Log 2ParMrgLevel is greater than xCb>>Log 2ParMrgLevel and (yCb+cbHeight)>>Log 2ParMrgLevel is great than (yCb>>Log 2ParMrgLevel) and where (xCb, yCb) is the top-left luma sample position of the current CU in the picture and (cbWidth, cbHeight) is the CU size. The MER size is selected at encoder side and signalled as log 2_parallel_merge_level_minus2 in the sequence parameter set.

2.1.2.3 Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a skip flag and merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The merge candidate flag is signalled to specify which one is used.

Distance index specifies motion magnitude information and indicate the pre-defined offset from the starting point. As shown in above Figure, an offset is added to either horizontal component or vertical component of starting MV. The relation of distance index and pre-defined offset is specified in Table 2-5.

TABLE 2-5
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 2-6. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 2-6 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), the sign in Table 2-6 specifies the sign of MV offset added to the list0 MV component of starting MV and the sign for the list1 MV has opposite value.

TABLE 2-6
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

2.1.2.4 Bi-Prediction with CU-Level Weight (BCW)

In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals.

$${P}_{bi - pred} = ( ( 8 - w ) * {P}_{0} + w * {P}_{1} + 4 ) ≫ 3 \qquad ( 2 - 7 )$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w={3, 4, 5}) are used.
At the encoder, fast search algorithms are applied to find the weight index without significantly increasing the encoder complexity. These algorithms are summarized as follows. When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP was also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e. equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CHIP mode, the BCW index of the current CU is set to 2, e.g. equal weight.

### 2.1.2.5 Bi-Directional Optical Flow (BDOF)

The bi-directional optical flow (BDOF) tool is included in VVC. BDOF, previously referred to as BIO, was included in the JEM. Compared to the JEM version, the BDOF in VVC is a simpler version that requires much less computation, especially in terms of number of multiplications and the size of the multiplier.

BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order.
The distances (i.e. POC difference) from two reference pictures to the current picture are same.
Both reference pictures are short-term reference pictures.
The CU is not coded using affine mode or the ATMVP merge mode.
CU has more than 64 luma samples.
Both CU height and CU width are larger than or equal to 8 luma samples.
BCW weight index indicates equal weight.
WP is not enabled for the current CU.
CIIP mode is not used for the current CU.

BDOF is only applied to the luma component. As its name indicates, the BDOF mode is based on the optical flow concept, which assumes that the motion of an object is smooth. For each 4×4 subblock, a motion refinement (vₓ,v_{y}) is calculated by minimizing the difference between the L0 and L1 prediction samples. The motion refinement is then used to adjust the bi-predicted sample values in the 4×4 subblock. The following steps are applied in the BDOF process.

First, the horizontal and vertical gradients,

$$\frac{\partial {I}^{( k )}}{\partial x} ( i , j ) and \frac{\partial {I}^{( k )}}{\partial x} ( i , j ) ,$$

k=0, 1, or the two prediction signals are computed by directly calculating the difference between two neighboring samples, i.e.,

$$\begin{matrix}\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) ) \\ \frac{\partial {I}^{( k )}}{\partial y} ( i , j ) = ( ( {I}^{( k )} ( i , j + 1 ) ≫ shift 1 ) - ( {I}^{( k )} ( i , j - 1 ) ≫ shift 1 ) )\end{matrix} \qquad ( 2 - 8 )$$

where I^{(k)}(i,j) are the sample value at coordinate (i,j) of the prediction signal in list k, k=0, 1, and shift1 is calculated based on the luma bit depth, bitDepth, as shift1=max(6, bitDepth−6).

Then, the auto- and cross-correlation of the gradients, S₁, S₂, S₃, S₅ and S₆, are calculated as:

$$\begin{matrix}{S}_{1} = {\sum }_{( i , j ) ∈ Ω} Abs ( {ψ}_{x} ( i , j ) ) , {S}_{3} = {\sum }_{( i , j ) ∈ Ω} θ ( i , j ) \cdot Sign ( {ψ}_{x} ( i , j ) ) \\ {S}_{2} = {\sum }_{( i , j ) ∈ Ω} {ψ}_{x} ( i , j ) \cdot Sign ( {ψ}_{y} ( i , j ) ) \\ {S}_{5} = {\sum }_{( i , j ) ∈ Ω} Abs ( {ψ}_{y} ( i , j ) ) , {S}_{6} = {\sum }_{( i , j ) ∈ Ω} θ ( i , j ) \cdot Sign ( {ψ}_{y} ( i , j ) )\end{matrix} \qquad ( 2 - 9 )$$

$$where$$

$$\begin{matrix}{ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a} \\ {ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a} \\ θ ( i , j ) = ( {I}^{( 1 )} ( i , j ) ≫ {n}_{b} ) - ( {I}^{( 0 )} ( i , j ) ≫ {n}_{b} )\end{matrix} \qquad ( 2 - 10 )$$

where Ω is a 6×6 window around the 4×4 subblock, and the values of nₐ and n_{b} are set equal to min(1, bitDepth−11) and min(4, bitDepth−8), respectively.

The motion refinement (vₓ, v_{y}) is then derived using the cross- and auto-correlation terms using the following:

$$\begin{matrix}{v}_{x} = {S}_{1} > 0 ? clip 3 ( - {th}_{BIO}^{′} , {th}_{BIO}^{′} , - ( ( {S}_{3} \cdot {2}^{{n}_{b} - {n}_{a}} ) ≫ ⌊ {log}_{2} {S}_{1} ⌋ ) ) : 0 \\ {v}_{y} = {S}_{5} > 0 ? clip 3 ( - {th}_{BIO}^{′} , {th}_{BIO}^{′} , - ( ( {S}_{6} \cdot {2}^{{n}_{b} - {n}_{a}} - ( ( {v}_{x} {S}_{2 , m} ) ≪ {n}_{{S}_{2}} + {v}_{x} {S}_{2 , s} ) / 2 ) ≫ ⌊ {log}_{2} {S}_{5} ⌋ ) ) : 0\end{matrix} \qquad ( 2 - 11 )$$

where

$${S}_{2 , m} = {S}_{2} ≫ {n}_{{S}_{2}} , {S}_{2 , s} = {S}_{2} \& ( {2}^{{n}_{{S}_{2}}} - 1 ) , {th}_{BIO}^{′} = {2}^{max ( 5 , BD - 7 )} .$$

└·┘ is the floor function, and n_{S}_{₂}=12.

Based on the motion refinement and the gradients, the following adjustment is calculated for each sample in the 4×4 subblock:

$$b ( x , y ) = rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial x} - \frac{\partial {I}^{( 0 )} ( x , y )}{\partial x} ) + 1 ) / 2 ) \qquad ( 2 - 12 )$$

Finally, the BDOF samples of the CU are calculated by adjusting the bi-prediction samples as follows:

$${pred}_{BDOF} ( x , y ) = ( {I}^{( 0 )} ( x , y ) + {I}^{( 1 )} ( x , y ) + b ( x , y ) + {o}_{offset} ) ≫ shift \qquad ( 2 - 13 )$$

These values are selected such that the multipliers in the BDOF process do not exceed 15-bit, and the maximum bit-width of the intermediate parameters in the BDOF process is kept within 32-bit.

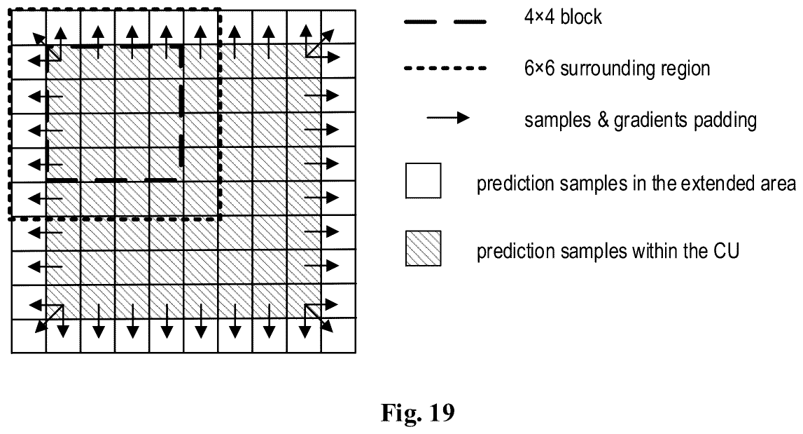

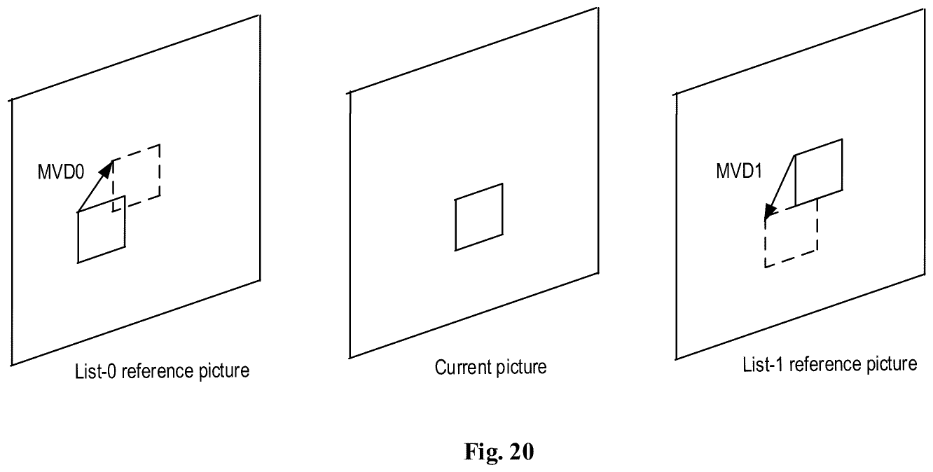

In order to derive the gradient values, some prediction samples I^{(k)}(i,j) in list k (k=0,1) outside of the current CU boundaries need to be generated. As depicted in FIG. 19, the BDOF in VVC uses one extended row/column around the CU's boundaries. In order to control the computational complexity of generating the out-of-boundary prediction samples, prediction samples in the extended area (white positions) are generated by taking the reference samples at the nearby integer positions (using floor( ) operation on the coordinates) directly without interpolation, and the normal 8-tap motion compensation interpolation filter is used to generate prediction samples within the CU (gray positions). These extended sample values are used in gradient calculation only. For the remaining steps in the BDOF process, if any sample and gradient values outside of the CU boundaries are needed, they are padded (i.e. repeated) from their nearest neighbors.

When the width and/or height of a CU are larger than 16 luma samples, it will be split into subblocks with width and/or height equal to 16 luma samples, and the subblock boundaries are treated as the CU boundaries in the BDOF process. The maximum unit size for BDOF process is limited to 16×16. For each subblock, the BDOF process could skipped. When the SAD of between the initial L0 and L1 prediction samples is smaller than a threshold, the BDOF process is not applied to the subblock. The threshold is set equal to (8*W*(H>>1), where W indicates the subblock width, and H indicates subblock height. To avoid the additional complexity of SAD calculation, the SAD between the initial L0 and L1 prediction samples calculated in DVMR process is reused here.

If BCW is enabled for the current block, i.e., the BCW weight index indicates unequal weight, then bi-directional optical flow is disabled. Similarly, if WP is enabled for the current block, i.e., the luma_weight_lx_flag is 1 for either of the two reference pictures, then BDOF is also disabled. When a CU is coded with symmetric MVD mode or CIIP mode, BDOF is also disabled.

### 2.1.2.6 Symmetric MVD Coding

In VVC, besides the normal unidirectional prediction and bi-directional prediction mode MVD signalling, symmetric MVD mode for bi-predictional MVD signalling is applied. In the symmetric MVD mode, motion information including reference picture indices of both list-0 and list-1 and MVD of list-1 are not signaled but derived.

The decoding process of the symmetric MVD mode is as follows:
1) At slice level, variables BiDirPredFlag, RefIdxSymL0 and RefIdxSymL1 are derived as follows:
   If mvd_11_zero_flag is 1, BiDirPredFlag is set equal to 0.
   Otherwise, if the nearest reference picture in list-0 and the nearest reference picture in list-1 form a forward and backward pair of reference pictures or a backward and forward pair of reference pictures, BiDirPredFlag is set to 1, and both list-0 and list-1 reference pictures are short-term reference pictures. Otherwise BiDirPredFlag is set to 0.
2) At CU level, a symmetrical mode flag indicating whether symmetrical mode is used or not is explicitly signaled if the CU is bi-prediction coded and BiDirPredFlag is equal to 1.

When the symmetrical mode flag is true, only mvp_10_flag, mvp_11_flag and MVD0 are explicitly signaled. The reference indices for list-0 and list-1 are set equal to the pair of reference pictures, respectively. MVD1 is set equal to (−MVD0). The final motion vectors are shown in below formula.)

$$\{ \begin{matrix}( {mvx}_{0} , {mvy}_{0} ) = ( {mvpx}_{0} + {mvdx}_{0} , {mvpy}_{0} + {mvdy}_{0} ) \\ ( {mvx}_{1} , {mvy}_{1} ) = ( {mvpx}_{1} - {mvdx}_{0} , {mvpy}_{1} - {mvdy}_{0} )\end{matrix} \qquad ( 2 - 14 )$$

In the encoder, symmetric MVD motion estimation starts with initial MV evaluation. A set of initial MV candidates comprising of the MV obtained from uni-prediction search, the MV obtained from bi-prediction search and the MVs from the AMVP list. The one with the lowest rate-distortion cost is chosen to be the initial MV for the symmetric MVD motion search.

### 2.1.2.7 Decoder Side Motion Vector Refinement (DMVR)

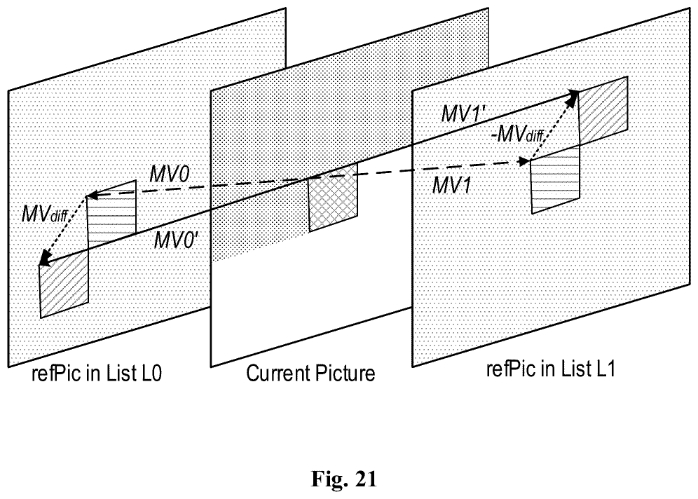

In order to increase the accuracy of the MVs of the merge mode, a bilateral-matching based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. As illustrated in FIG. 21, the SAD between the red blocks based on each MV candidate around the initial MV is calculated. The MV candidate with the lowest SAD becomes the refined MV and used to generate the bi-predicted signal.

In VVC, the DMVR can be applied for the CUs which are coded with following modes and features:
CU level merge mode with bi-prediction MV.
One reference picture is in the past and another reference picture is in the future with respect to the current picture.
The distances (i.e. POC difference) from two reference pictures to the current picture are same.
Both reference pictures are short-term reference pictures.
CU has more than 64 luma samples.
Both CU height and CU width are larger than or equal to 8 luma samples.
BCW weight index indicates equal weight.
WP is not enabled for the current block.
CIIP mode is not used for the current block.

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

### 2.1.2.7.1 Searching Scheme

In DVMR, the search points are surrounding the initial MV and the MV offset obey the MV difference mirroring rule. In other words, any points that are checked by DMVR, denoted by candidate MV pair (MV0, MV1) obey the following two equations:

$$MV {0}^{′} = MV 0 + MV\_offset \qquad ( 2 - 15 )$$

$$MV {1}^{′} = MV 1 + MV\_offset \qquad ( 2 - 16 )$$

where MV_offset represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form:

$$E ( x , y ) = {A ( x - {x}_{min} )}^{2} + {B ( y - {y}_{min} )}^{2} + C \qquad ( 2 - 17 )$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) ) \qquad ( 2 - 18 )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) ) \qquad ( 2 - 19 )$$

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

### 2.1.2.7.2 Bilinear-Interpolation and Sample Padding

In VVC, the resolution of the MVs is 1/16 luma samples. The samples at the fractional position are interpolated using a 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

### 2.1.2.7.3 Maximum DMVR Processing Unit

When the width and/or height of a CU are larger than 16 luma samples, it will be further split into subblocks with width and/or height equal to 16 luma samples. The maximum unit size for DMVR searching process is limit to 16×16.

### 2.1.2.8 Combined Inter and Intra Prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value is calculated depending on the coding modes of the top and left neighbouring blocks as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - wt ) * {P}_{inter} + wt * {P}_{intra} + 2 ) ≫ 2$$

### 2.1.2.9 Multi-Hypothesis Prediction (MHP)

Up to two additional predictors are signalled on top of inter AMVP mode, regular merge mode, and MMVD mode. The resulting overall prediction signal is accumulated iteratively with each additional prediction signal.

$${p}_{n + 1} = ( 1 - {α}_{n + 1} ) {p}_{n} + {α}_{n + 1} {h}_{n + 1}$$

The weighting factor α is specified according to the following table:

| add_hyp_weight_idx | α |
|---|---|
| 0 | ¼ |
| 1 | −⅛ |

For inter AMVP mode, MHP is only applied if non-equal weight in BCW is selected in bi-prediction mode.

### 2.1.2.10 Overlap Subblock Based Motion Compensation (OBMC)

When OBMC is applied, top and left boundary pixels of a CU are refined using neighboring block's motion information with a weighted prediction.

Conditions of not applying OBMC are as follows:
When OBMC is disabled at SPS level.
When current block has intra mode or IBC mode.
When current block applies LIC.
When current luma block area is smaller or equal to 32.

A subblock-boundary OBMC is performed by applying the same blending to the top, left, bottom, and right subblock boundary pixels using neighboring subblocks' motion information. It is enabled for the subblock based coding tools:
Affine AMVP modes;
Affine merge modes and subblock-based temporal motion vector prediction (SbTMVP);
Subblock-based bilateral matching.

### 2.1.2.11 Local Illumination Compensation (LIC)

LIC is an inter prediction technique to model local illumination variation between current block and its prediction block as a function of that between current block template and reference block template. The parameters of the function can be denoted by a scale α and an offset β, which forms a linear equation, that is, α*p[x]+β to compensate illumination changes, where p[x] is a reference sample pointed to by MV at a location x on reference picture. When wrap around motion compensation is enabled, the MV shall be clipped with wrap around offset taken into consideration. Since α and β can be derived based on current block template and reference block template, no signaling overhead is required for them, except that an LIC flag is signaled for AMVP mode to indicate the use of LIC.

The local illumination compensation proposed in JVET-00066 is used for uni-prediction inter CUs with the following modifications.
Intra neighbor samples can be used in LIC parameter derivation;
LIC is disabled for blocks with less than 32 luma samples;
For both non-subblock and affine modes, LIC parameter derivation is performed based on the template block samples corresponding to the current CU, instead of partial template block samples corresponding to first top-left 16×16 unit;
Samples of the reference block template are generated by using MC with the block MV without rounding it to integer-pel precision.

### 2.1.2.12 Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6} excluding 8×64 and 64×8.

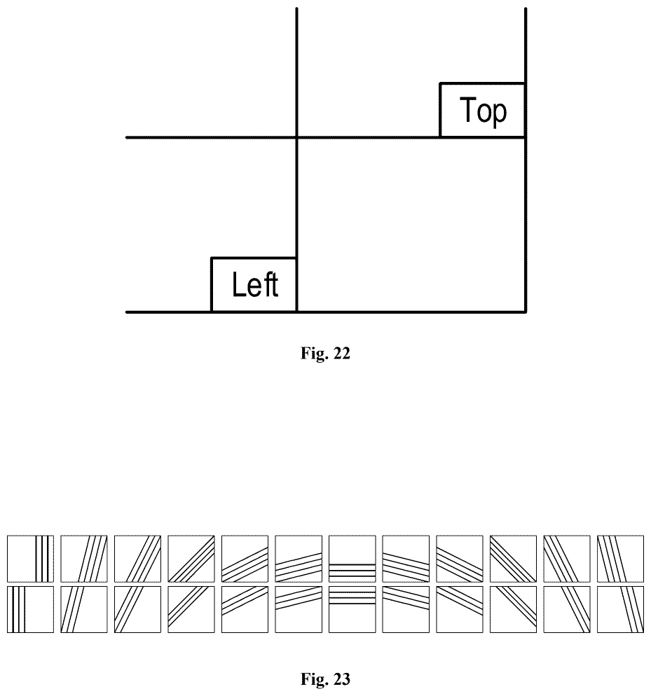

When this mode is used, a CU is split into two parts by a geometrically located straight line (FIG. 23). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights. This is the prediction signal for the whole CU, and transform and quantization process will be applied to the whole CU as in other prediction modes. Finally, the motion field of a CU predicted using the geometric partition modes is stored.

### 2.1.2.12.1 Uni-Prediction Candidate List Construction

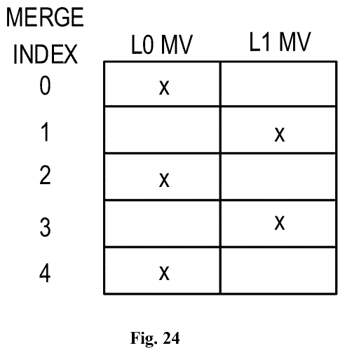

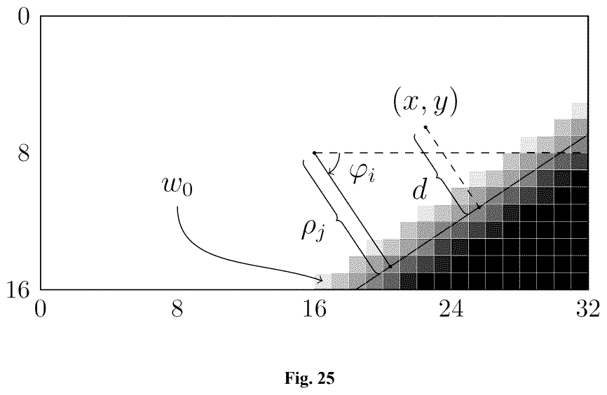

The uni-prediction candidate list is derived directly from the merge candidate list constructed according to the extended merge prediction process. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. These motion vectors are marked with “x” in FIG. 24. In case a corresponding LX motion vector of the n-the extended merge candidate does not exist, the L(1−X) motion vector of the same candidate is used instead as the uni-prediction motion vector for geometric partitioning mode.

### 2.1.2.12.2 Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x,y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 2 - 21 )$$

$${ρ}_{j} = {ρ}_{x , j} cos ( {φ}_{i} ) + {ρ}_{y , j} sin ( {φ}_{i} ) \qquad ( 2 - 22 )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix} \qquad ( 2 - 23 )$$

$${ρ}_{y , j} = \{ \begin{matrix}\pm ( j \times h ) ≫ 2 & i \% 16 = 8 or ( i \% 16 \neq 0 and h \geq w ) \\ 0 & otherwise\end{matrix} \qquad ( 2 - 24 )$$

where i,j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdxL ( x , y ) = partIdx ? 32 + d ( x , y ) : 32 - d ( x , y ) \qquad ( 2 - 25 )$$

$${w}_{0} ( x , y ) = \frac{Clip 3 ( 0 , 8 , ( wIdxL ( x , y ) + 4 ) ≫ 3 )}{8} \qquad ( 2 - 26 )$$

$${w}_{1} ( x , y ) = 1 - {w}_{0} ( x , y ) \qquad ( 2 - 27 )$$

The partIdx depends on the angle index i. One example of weigh w₀ is illustrated below.

### 2.1.2.12.3 Motion Field Storage for Geometric Partitioning Mode

Mv1 from the first part of the geometric partition, Mv2 from the second part of the geometric partition and a combined Mv of Mv1 and Mv2 are stored in the motion filed of a geometric partitioning mode coded CU.

The stored motion vector type for each individual position in the motion filed are determined as:

$$sType = abs ( motionIdx ) < 32 ? 2 : ( motionIdx \leq 0 ? ( 1 - partIdx ) : partIdx ) \qquad ( 2 - 28 )$$

where motionIdx is equal to d(4x+2,4y+2). The partIdx depends on the angle index i.

If sType is equal to 0 or 1, Mv0 or Mv1 are stored in the corresponding motion field, otherwise if sType is equal to 2, a combined Mv from Mv0 and Mv2 are stored. The combined Mv are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.
   2.1.2.12.4 GPM with Inter and Intra Prediction (GPM Inter-Intra)

With the GPM inter-intra, pre-defined intra prediction modes against geometric partitioning line can be selected in addition to merge candidates for each non-rectangular split region in the GPM-applied CU. In the proposed method, whether intra or inter prediction mode is determined for each GPM-separated region with a flag from the encoder. When the inter prediction mode, a uni-prediction signal is generated by MVs from the merge candidate list. On the other hand, when the intra prediction mode, a uni-prediction signal is generated from the neighboring pixels for the intra prediction mode specified by an index from the encoder. The variation of the possible intra prediction modes is restricted by the geometric shapes. Finally, the two uni-prediction signals are blended with the same way of ordinary GPM.

### 2.1.3 Screen Content Coding Tools

### 2.1.3.1 Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signaled as IBC AMVP mode or IBC skip/merge mode as follows:
IBC skip/merge mode: a merge candidate index is used to indicate which of the block vectors in the list from neighboring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### 2.1.3.1.1 IBC Reference Region

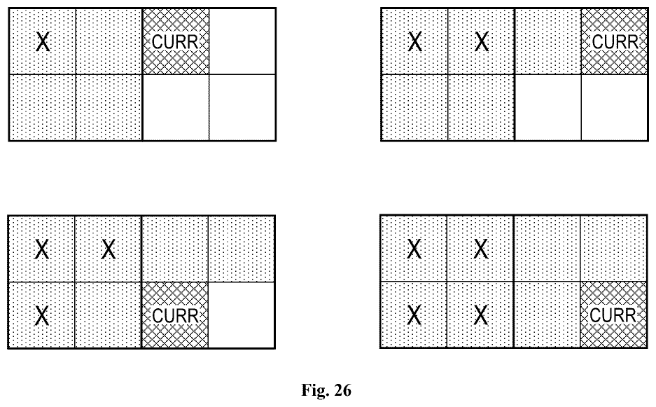

To reduce memory consumption and decoder complexity, the IBC in VVC allows only the reconstructed portion of the predefined area including the region of current CTU and some region of the left CTU. FIG. 26 illustrates the reference region of IBC Mode, where each block represents 64×64 luma sample unit.

Depending on the location of the current coding CU location within the current CTU, the following applies:
If current block falls into the top-left 64×64 block of the current CTU, then in addition to the already reconstructed samples in the current CTU, it can also refer to the reference samples in the bottom-right 64×64 blocks of the left CTU, using CPR mode. The current block can also refer to the reference samples in the bottom-left 64×64 block of the left CTU and the reference samples in the top-right 64×64 block of the left CTU, using CPR mode.
If current block falls into the top-right 64×64 block of the current CTU, then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.
If current block falls into the bottom-left 64×64 block of the current CTU, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.
If current block falls into the bottom-right 64×64 block of the current CTU, it can only refer to the already reconstructed samples in the current CTU, using CPR mode.

This restriction allows the IBC mode to be implemented using local on-chip memory for hardware implementations.

2.1.3.1.2 IBC Interaction with Other Coding Tools

The interaction between IBC mode and other inter coding tools in VVC, such as pairwise merge candidate, history based motion vector predictor (HMVP), combined intra/inter prediction mode (CIIP), merge mode with motion vector difference (MMVD), and geometric partitioning mode (GPM) are as follows:
IBC can be used with pairwise merge candidate and HMVP. A new pairwise IBC merge candidate can be generated by averaging two IBC merge candidates. For HMVP, IBC motion is inserted into history buffer for future referencing.
IBC cannot be used in combination with the following inter tools: affine motion, CIIP, MMVD, and GPM.
IBC is not allowed for the chroma coding blocks when DUAL_TREE partition is used.

Unlike in the HEVC screen content coding extension, the current picture is no longer included as one of the reference pictures in the reference picture list 0 for IBC prediction. The derivation process of motion vectors for IBC mode excludes all neighboring blocks in inter mode and vice versa. The following IBC design aspects are applied:
IBC shares the same process as in regular MV merge including with pairwise merge candidate and history based motion predictor, but disallows TMVP and zero vector because they are invalid for IBC mode.
Separate HMVP buffer (5 candidates each) is used for conventional MV and IBC.
Block vector constraints are implemented in the form of bitstream conformance constraint, the encoder needs to ensure that no invalid vectors are present in the bitsream, and merge shall not be used if the merge candidate is invalid (out of range or 0). Such bitstream conformance constraint is expressed in terms of a virtual buffer as described below.
For deblocking, IBC is handled as inter mode.
If the current block is coded using IBC prediction mode, AMVR does not use quarter-pel; instead, AMVR is signaled to only indicate whether MV is inter-pel or 4 integer-pel.
The number of IBC merge candidates can be signalled in the slice header separately from the numbers of regular, subblock, and geometric merge candidates.

A virtual buffer concept is used to describe the allowable reference region for IBC prediction mode and valid block vectors. Denote CTU size as ctbSize, the virtual buffer, ibcBuf, has width being wIbcBuf=128×128/ctbSize and height hIbcBuf=ctbSize. For example, for a CTU size of 128×128, the size of ibcBuf is also 128×128; for a CTU size of 64×64, the size of ibcBuf is 256×64; and a CTU size of 32×32, the size of ibcBuf is 512×32.

The size of a VPDU is min (ctbSize, 64) in each dimension, Wᵥ=min(ctbSize, 64).

The virtual IBC buffer, ibcBuf is maintained as follows.
At the beginning of decoding each CTU row, refresh the whole ibcBuf with an invalid value−1.
At the beginning of decoding a VPDU (xVPDU, yVPDU) relative to the top-left corner of the picture, set the ibcBuf [x][y]=−1, with x=xVPDU % wIbcBuf, . . . , xVPDU % wIbcBuf+Wᵥ−1; y=yVPDU % ctbSize, . . . , yVPDU % ctbSize+Wᵥ−1.
After decoding a CU contains (x,y) relative to the top-left corner of the picture, set

$$ibcBuf [ x \% wIbcBuf ] [ y \% ctbSize ] = recSample [ x ] [ y ] .$$

For a block covering the coordinates (x,y), if the following is true for a block vector bv=(bv[0], bv[1]), then it is valid; otherwise, it is not valid:

$$ibcBuf [ ( x + bv [ 0 ] ) \% wIbcBuf ] [ ( y + bv [ 1 ] ) \% ctbSize ] shall not be equal to - 1.$$

### 2.1.3.2 Block Differential Pulse Coded Modulation (BDPCM)

VVC supports block differential pulse coded modulation (BDPCM) for screen content coding. At the sequence level, a BDPCM enable flag is signalled in the SPS; this flag is signalled only if the transform skip mode (described in the next section) is enabled in the SPS.

When BDPCM is enabled, a flag is transmitted at the CU level if the CU size is smaller than or equal to MaxTsSize by MaxTsSize in terms of luma samples and if the CU is intra coded, where MaxTsSize is the maximum block size for which the transform skip mode is allowed. This flag indicates whether regular intra coding or BDPCM is used. If BDPCM is used, a BDPCM prediction direction flag is transmitted to indicate whether the prediction is horizontal or vertical. Then, the block is predicted using the regular horizontal or vertical intra prediction process with unfiltered reference samples. The residual is quantized and the difference between each quantized residual and its predictor, i.e. the previously coded residual of the horizontal or vertical (depending on the BDPCM prediction direction) neighbouring position, is coded.

For a block of size M (height)×N (width), let r_{i,j}, 0≤i≤M−1, 0≤j≤N−1 be the prediction residual. Let Q(r_{i,j}), 0≤i≤M−1, 0≤j≤N−1 denote the quantized version of the residual r_{i,j}. BDPCM is applied to the quantized residual values, resulting in a modified M×N array \tilde{R} with elements \tilde{r}_{i,j}, where \tilde{r}_{i,j} is predicted from its neighboring quantized residual value. For vertical BDPCM prediction mode, for 0≤j≤(N−1), the following is used to derive \tilde{r}_{i,j}:

$${\tilde{r}}_{i , j} = \{ \begin{matrix}Q ( {r}_{i , j} ) , & i = 0 \\ Q ( {r}_{i , j} ) - Q ( {r}_{( i - 1 ) , j} ) , & 1 \leq i \leq ( M - 1 )\end{matrix} \qquad ( 2 - 29 )$$

For horizontal BDPCM prediction mode, for 0≤i≤(M−1), the following is used to derive \tilde{r}_{i,j}:

$${\tilde{r}}_{i , j} = \{ \begin{matrix}Q ( {r}_{i , j} ) , & j = 0 \\ Q ( {r}_{i , j} ) - Q ( {r}_{i , ( j - 1 )} ) , & 1 \leq j \leq ( N - 1 )\end{matrix} \qquad ( 2 - 30 )$$

At the decoder side, the above process is reversed to compute Q(r_{i,j}), 0≤i≤M−1, 0≤j≤N−1, as follows:

$$Q ( {r}_{i , j} ) = {\sum }_{k = 0}^{j} {\tilde{r}}_{i , k} , if vertical BDPCM is used \qquad ( 2 - 31 )$$

$$Q ( {r}_{i , j} ) = {\sum }_{k = 0}^{j} {\tilde{r}}_{i , k} , if horizontal BDPCM is used \qquad ( 2 - 32 )$$

The inverse quantized residuals, Q⁻¹(Q(r_{i,j})), are added to the intra block prediction values to produce the reconstructed sample values.

The predicted quantized residual values \tilde{r}_{i,j} are sent to the decoder using the same residual coding process as that in transform skip mode residual coding. For lossless coding, if slice_ts_residual_coding_disabled_flag is set to 1, the quantized residual values are sent to the decoder using regular transform residual coding. In terms of the MPM mode for future intra mode coding, horizontal or vertical prediction mode is stored for a BDPCM-coded CU if the BDPCM prediction direction is horizontal or vertical, respectively. For deblocking, if both blocks on the sides of a block boundary are coded using BDPCM, then that particular block boundary is not deblocked.

### 2.1.3.3 Residual Coding for Transform Skip Mode

VVC allows the transform skip mode to be used for luma blocks of size up to MaxTsSize by MaxTsSize, where the value of MaxTsSize is signaled in the PPS and can be at most 32. When a CU is coded in transform skip mode, its prediction residual is quantized and coded using the transform skip residual coding process. This process is modified from the transform coefficient coding process. In transform skip mode, the residuals of a TU are also coded in units of non-overlapped subblocks of size 4×4. For better coding efficiency, some modifications are made to customize the residual coding process towards the residual signal's characteristics. The following summarizes the differences between transform skip residual coding and regular transform residual coding:
Forward scanning order is applied to scan the subblocks within a transform block and also the positions within a subblock;
no signalling of the last (x, y) position;
coded_sub_block_flag is coded for every subblock except for the last subblock when all previous flags are equal to 0;
sig_coeff_flag context modelling uses a reduced template, and context model of sig_coeff_flag depends on top and left neighbouring values;
context model of abs_level_gt1 flag also depends on the left and top sig_coeff_flag values;
par_level_flag using only one context model;
additional greater than 3, 5, 7, 9 flags are signalled to indicate the coefficient level, one context for each flag;
rice parameter derivation using fixed order=1 for the binarization of the remainder values;
context model of the sign flag is determined based on left and above neighbouring values and the sign flag is parsed after sig_coeff_flag to keep all context coded bins together.

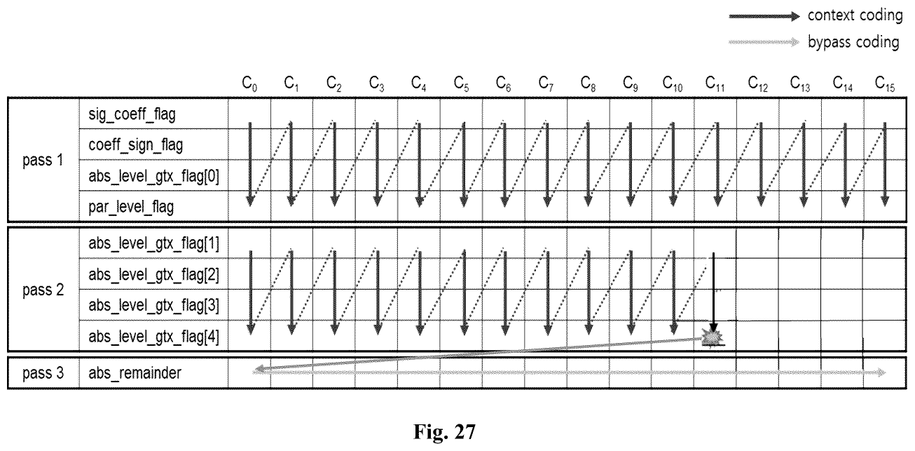

For each subblock, if the coded_subblock_flag is equal to 1 (i.e., there is at least one non-zero quantized residual in the subblock), coding of the quantized residual levels is performed in three scan passes (see FIG. 27):
First scan pass: significance flag (sig_coeff_flag), sign flag (coeff_sign_flag), absolute level greater than 1 flag (abs_level_gtx_flag[0]), and parity (par_level_flag) are coded. For a given scan position, if sig_coeff_flag is equal to 1, then coeff_sign_flag is coded, followed by the abs_level_gtx_flag[0] (which specifies whether the absolute level is greater than 1). If abs_level_gtx_flag[0] is equal to 1, then the par_level_flag is additionally coded to specify the parity of the absolute level.
Greater-than-x scan pass: for each scan position whose absolute level is greater than 1, up to four abs_level_gtx_flag[i] for i=1 . . . 4 are coded to indicate if the absolute level at the given position is greater than 3, 5, 7, or 9, respectively.
Remainder scan pass: The remainder of the absolute level abs_remainder are coded in bypass mode. The remainder of the absolute levels are binarized using a fixed rice parameter value of 1.

The bins in scan passes #1 and #2 (the first scan pass and the greater-than-x scan pass) are context coded until the maximum number of context coded bins in the TU have been exhausted. The maximum number of context coded bins in a residual block is limited to 1.75*block_width*block_height, or equivalently, 1.75 context coded bins per sample position on average. The bins in the last scan pass (the remainder scan pass) are bypass coded. A variable, RemCcbs, is first set to the maximum number of context-coded bins for the block and is decreased by one each time a context-coded bin is coded. While RemCcbs is larger than or equal to four, syntax elements in the first coding pass, which includes the sig_coeff_flag, coeff_sign_flag, abs_level_gt1_flag and par_level_flag, are coded using context-coded bins. If RemCcbs becomes smaller than 4 while coding the first pass, the remaining coefficients that have yet to be coded in the first pass are coded in the remainder scan pass (pass #3).

After completion of first pass coding, if RemCcbs is larger than or equal to four, syntax elements in the second coding pass, which includes abs_level_gt3_flag, abs_level_gt5_flag, abs_level_gt7_flag, and abs_level_gt9_flag, are coded using context coded bins. If the RemCcbs becomes smaller than 4 while coding the second pass, the remaining coefficients that have yet to be coded in the second pass are coded in the remainder scan pass (pass #3).

FIG. 27 illustrates the transform skip residual coding process. The star marks the position when context coded bins are exhausted, at which point all remaining bins are coded using bypass coding.

Further, for a block not coded in the BDPCM mode, a level mapping mechanism is applied to transform skip residual coding until the maximum number of context coded bins has been reached. Level mapping uses the top and left neighbouring coefficient levels to predict the current coefficient level in order to reduce signalling cost. For a given residual position, denote absCoeff as the absolute coefficient level before mapping and absCoeffMod as the coefficient level after mapping. Let X₀ denote the absolute coefficient level of the left neighbouring position and let X₁ denote the absolute coefficient level of the above neighbouring position. The level mapping is performed as follows:

$$pred = max ( X 0 , X 1 ) ; if ( abs Coeff == pred ) abs CoeffMod = 1 ; else abs CoeffMod = ( abs Coeff < pred ) ? abs Coeff + 1 : abs Coeff ;$$

Then, the absCoeffMod value is coded as described above. After all context coded bins have been exhausted, level mapping is disabled for all remaining scan positions in the current block.

### 2.1.3.4 Palette Mode

In VVC, the palette mode is used for screen content coding in all of the chroma formats supported in a 4:4:4 profile (that is, 4:4:4, 4:2:0, 4:2:2 and monochrome). When palette mode is enabled, a flag is transmitted at the CU level if the CU size is smaller than or equal to 64×64, and the amount of samples in the CU is greater than 16 to indicate whether palette mode is used. Considering that applying palette mode on small CUs introduces insignificant coding gain and brings extra complexity on the small blocks, palette mode is disabled for CU that are smaller than or equal to 16 samples. A palette coded coding unit (CU) is treated as a prediction mode other than intra prediction, inter prediction, and intra block copy (IBC) mode.

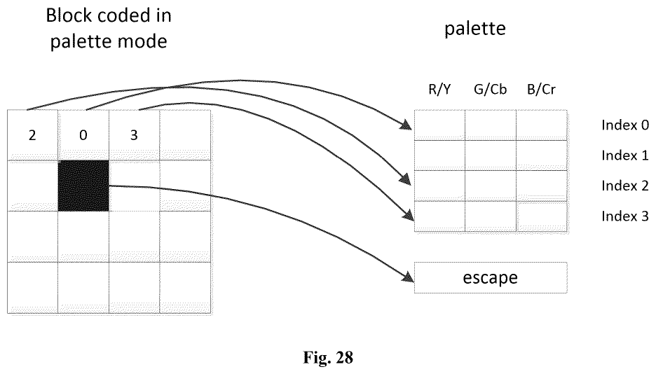

If the palette mode is utilized, the sample values in the CU are represented by a set of representative colour values. The set is referred to as the palette. For positions with sample values close to the palette colours, the palette indices are signalled. It is also possible to specify a sample that is outside the palette by signalling an escape symbol. For samples within the CU that are coded using the escape symbol, their component values are signalled directly using (possibly) quantized component values. This is illustrated in FIG. 28. The quantized escape symbol is binarized with fifth order Exp-Golomb binarization process (EG5).

For coding of the palette, a palette predictor is maintained. The palette predictor is initialized to 0 at the beginning of each slice for non-wavefront case. For WPP case, the palette predictor at the beginning of each CTU row is initialized to the predictor derived from the first CTU in the previous CTU row so that the initialization scheme between palette predictors and CABAC synchronization is unified. For each entry in the palette predictor, a reuse flag is signalled to indicate whether it is part of the current palette in the CU. The reuse flags are sent using run-length coding of zeros. After this, the number of new palette entries and the component values for the new palette entries are signalled. After encoding the palette coded CU, the palette predictor will be updated using the current palette, and entries from the previous palette predictor that are not reused in the current palette will be added at the end of the new palette predictor until the maximum size allowed is reached. An escape flag is signaled for each CU to indicate if escape symbols are present in the current CU. If escape symbols are present, the palette table is augmented by one and the last index is assigned to be the escape symbol.

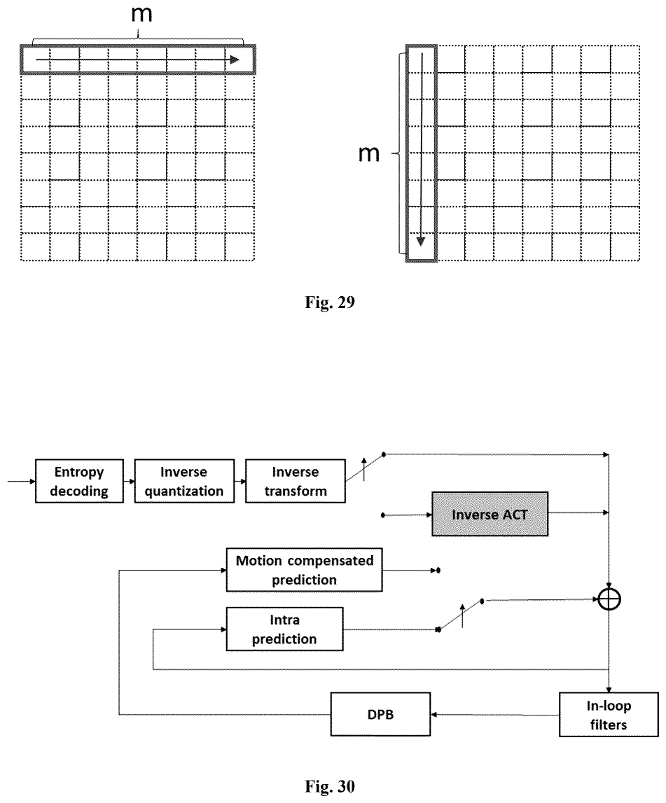

In a similar way as the coefficient group (CG) used in transform coefficient coding, a CU coded with palette mode is divided into multiple line-based coefficient group, each consisting of m samples (i.e., m=16), where index runs, palette index values, and quantized colors for escape mode are encoded/parsed sequentially for each CG. Same as in HEVC, horizontal or vertical traverse scan can be applied to scan the samples, as shown in FIG. 29.

The encoding order for palette run coding in each segment is as follows: For each sample position, 1 context coded bin run_copy_flag=0 is signalled to indicate if the pixel is of the same mode as the previous sample position, i.e., if the previously scanned sample and the current sample are both of run type COPY_ABOVE or if the previously scanned sample and the current sample are both of run type INDEX and the same index value. Otherwise, run_copy_flag=1 is signaled. If the current sample and the previous sample are of different modes, one context coded bin copy_above_palette_indices_flag is signaled to indicate the run type, i.e., INDEX or COPY_ABOVE, of the current sample. Here, decoder doesn't have to parse run type if the sample is in the first row (horizontal traverse scan) or in the first column (vertical traverse scan) since the INDEX mode is used by default. With the same way, decoder doesn't have to parse run type if the previously parsed run type is COPY_ABOVE. After palette run coding of samples in one coding pass, the index values (for INDEX mode) and quantized escape colors are grouped and coded in another coding pass using CABAC bypass coding. Such separation of context coded bins and bypass coded bins can improve the throughput within each line CG. For slices with dual luma/chroma tree, palette is applied on luma (Y component) and chroma (Cb and Cr components) separately, with the luma palette entries containing only Y values and the chroma palette entries containing both Cb and Cr values. For slices of single tree, palette will be applied on Y, Cb, Cr components jointly, i.e., each entry in the palette contains Y, Cb, Cr values, unless when a CU is coded using local dual tree, in which case coding of luma and chroma is handled separately. In this case, if the corresponding luma or chroma blocks are coded using palette mode, their palette is applied in a way similar to the dual tree case (this is related to non-4:4:4 coding and will be further explained in 2.1.3.4.1).

For slices coded with dual tree, the maximum palette predictor size is 63, and the maximum palette table size for coding of the current CU is 31. For slices coded with dual tree, the maximum predictor and palette table sizes are halved, i.e., maximum predictor size is 31 and maximum table size is 15, for each of the luma palette and the chroma palette. For deblocking, the palette coded block on the sides of a block boundary is not deblocked.

### 2.1.3.4.1 Palette Mode for Non-4:4:4 Content

Palette mode in VVC is supported for all chroma formats in a similar manner as the palette mode in HEVC SCC. For non-4:4:4 content, the following customization is applied:
1. When signaling the escape values for a given sample position, if that sample position has only the luma component but not the chroma component due to chroma subsampling, then only the luma escape value is signaled. This is the same as in HEVC SCC.
2. For a local dual tree block, the palette mode is applied to the block in the same way as the palette mode applied to a single tee block with two exceptions:
   a. The process of palette predictor update is slightly modified as follows. Since the local dual tree block only contains luma (or chroma) component, the predictor update process uses the signalled value of luma (or chroma) component and fills the “missing” chroma (or luma) component by setting it to a default value of (1<<(component bit depth−1)).
   b. The maximum palette predictor size is kept at 63 (since the slice is coded using single tree) but the maximum palette table size for the luma/chroma block is kept at 15 (since the block is coded using separate palette).
3. For palette mode in monochrome format, the number of colour components in a palette coded block is set to 1 instead of 3.

### 2.1.3.4.2 Encoder Algorithm for Palette Mode

At the encoder side, the following steps are used to produce the palette table of the current CU:
1. First, to derive the initial entries in the palette table of the current CU, a simplified K-means clustering is applied. The palette table of the current CU is initialized as an empty table. For each sample position in the CU, the SAD between this sample and each palette table entry is calculated and the minimum SAD among all palette table entries is obtained. If the minimum SAD is smaller than a pre-defined error limit, errorLimit, then the current sample is clustered together with the palette table entry with the minimum SAD. Otherwise, a new palette table entry is created. The threshold errorLimit is QP-dependent and is retrieved from a look-up table containing 57 elements covering the entire QP range. After all samples of the current CU have been processed, the initial palette entries are sorted according to the number of samples clustered together with each palette entry, and any entry after the 31^{st} entry is discarded.
2. In the second step, the initial palette table colours are adjusted by considering two options: using the centroid of each cluster from step 1 or using one of the palette colours in the palette predictor. The option with lower rate-distortion cost is selected to be the final colours of the palette table. If a cluster has only a single sample and the corresponding palette entry is not in the palette predictor, the corresponding sample is converted to an escape symbol in the next step.
3. A palette table thus generated contains some new entries from the centroids of the clusters in step 1, and some entries from the palette predictor. So this table is reordered again such that all new entries (i.e. the centroids) are put at the beginning of the table, followed by entries from the palette predictor.

Given the palette table of the current CU, the encoder selects the palette index of each sample position in the CU. For each sample position, the encoder checks the RD cost of all index values corresponding to the palette table entries, as well as the index representing the escape symbol, and selects the index with the smallest RD cost using the following equation:

$$RD cost = distortion \times ( isChroma ? 0.8 : 1 ) + lambda \times bypass coded bits \qquad ( 2 - 33 )$$

After deciding the index map of the current CU, each entry in the palette table is checked to see if it is used by at least one sample position in the CU. Any unused palette entry will be removed.

After the index map of the current CU is decided, trellis RD optimization is applied to find the best values of run_copy_flag and run type for each sample position by comparing the RD cost of three options: same as the previously scanned position, run type COPY_ABOVE, or run type INDEX. When calculating the SAD values, sample values are scaled down to 8 bits, unless the CU is coded in lossless mode, in which case the actual input bit depth is used to calculate the SAD. Further, in the case of lossless coding, only rate is used in the rate-distortion optimization steps mentioned above (because lossless coding incurs no distortion).

### 2.1.3.5 Adaptive Color Transform

In HEVC SCC extension, adaptive color transform (ACT) was applied to reduce the redundancy between three color components in 444 chroma format. The ACT is also adopted into the VVC standard to enhance the coding efficiency of 444 chroma format coding. Same as in HEVC SCC, the ACT performs in-loop color space conversion in the prediction residual domain by adaptively converting the residuals from the input color space to YCgCo space. FIG. 30 illustrates the decoding flowchart with the ACT being applied. Two color spaces are adaptively selected by signaling one ACT flag at CU level. When the flag is equal to one, the residuals of the CU are coded in the YCgCo space; otherwise, the residuals of the CU are coded in the original color space. Additionally, same as the HEVC ACT design, for inter and IBc CUs, the ACT is only enabled when there is at least one non-zero coefficient in the CU. For intra CUs, the ACT is only enabled when chroma components select the same intra prediction mode of luma component, i.e., DM mode.

### 2.1.3.5.1 ACT Mode

In HEVC SCC extension, the ACT supports both lossless and lossy coding based on lossless flag (i.e., cu_transquant_bypass_flag). However, there is no flag signalled in the bitstream to indicate whether lossy or lossless coding is applied. Therefore, YCgCo-R transform is applied as ACT to support both lossy and lossless cases. The YCgCo-R reversible colour transform is shown as below.

| Forward Conversion: GBR to | Backward Conversion: YCgCo to |
|---|---|
| YCgCo | GBR |
| Co = R − B; | t = Y − (Cg >> 1) |
| t = B+ (Co >> 1); | G = Cg + t |
| Cg = G − t; | B = t − (Co >> 1) |
| Y = t + (Cg >> 1); | R = Co + B |

Since the YCgCo-R transform are not normalized. To compensate the dynamic range change of residuals signals before and after color transform, the QP adjustments of (−5, 1, 3) are applied to the transform residuals of Y, Cg and Co components, respectively. The adjusted quantization parameter only affects the quantization and inverse quantization of the residuals in the CU. For other coding processes (such as deblocking), original QP is still applied.

Additionally, because the forward and inverse color transforms need to access the residuals of all three components, the ACT mode is always disabled for separate-tree partition and ISP mode where the prediction block size of different color component is different. Transform skip (TS) and block differential pulse coded modulation (BDPCM), which are extended to code chroma residuals, are also enabled when the ACT is applied.

### 2.1.3.5.2 ACT Fast Encoding Algorithms

To avoid brutal R-D search in both the original and converted color spaces, the following fast encoding algorithms are applied in the VTM reference software to reduce the encoder complexity when the ACT is enabled.
The order of RD checking of enabling/disabling ACT is dependent on the original color space of input video. For RGB videos, the RD cost of ACT mode is checked first; for YCbCr videos, the RD cost of non-ACT mode is checked first. The RD cost of the second color space is checked only if there is at least one non-zero coefficient in the first color space.
The same ACT enabling/disabling decision is reused when one CU is obtained through different partition path. Specifically, the selected color space for coding the residuals of one CU will be stored when the CU is coded at the first time. Then, when the same CU is obtained by another partition path, instead of checking the RD costs of the two spaces, the stored color space decision will be directly reused.
The RD cost of a parent CU is used to decide whether to check the RD cost of the second color space for the current CU. For instance, if the RD cost of the first color space is smaller than that of the second color space for the parent CU, then for the current CU, the second color space is not checked.
To reduce the number of tested coding modes, the selected coding mode is shared between two color spaces. Specifically, for intra mode, the preselected intra mode candidates based on SATD-based intra mode selection are shared between two color spaces. For inter and IBC modes, block vector search or motion estimation is performed only once. The block vectors and motion vectors are shared by two color spaces.

### 2.1.3.6 Intra Template Matching (IntraTMP)

Intra template matching prediction (IntraTM) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

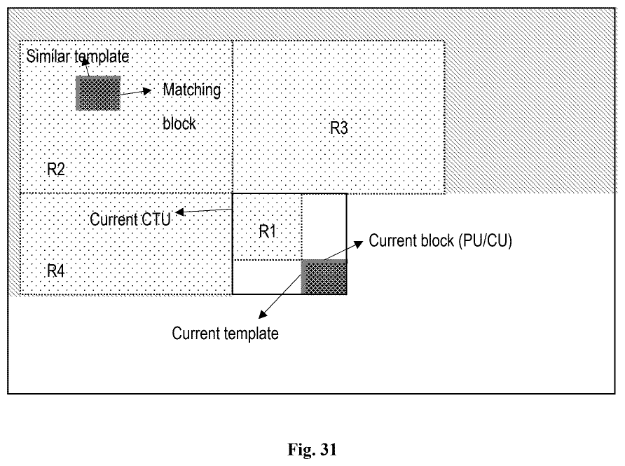

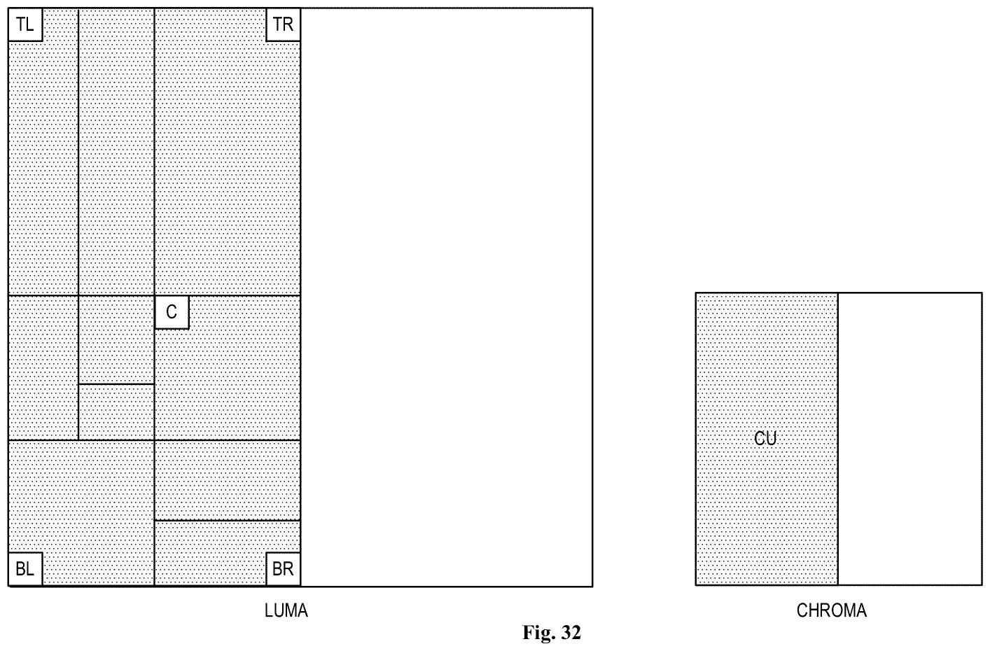

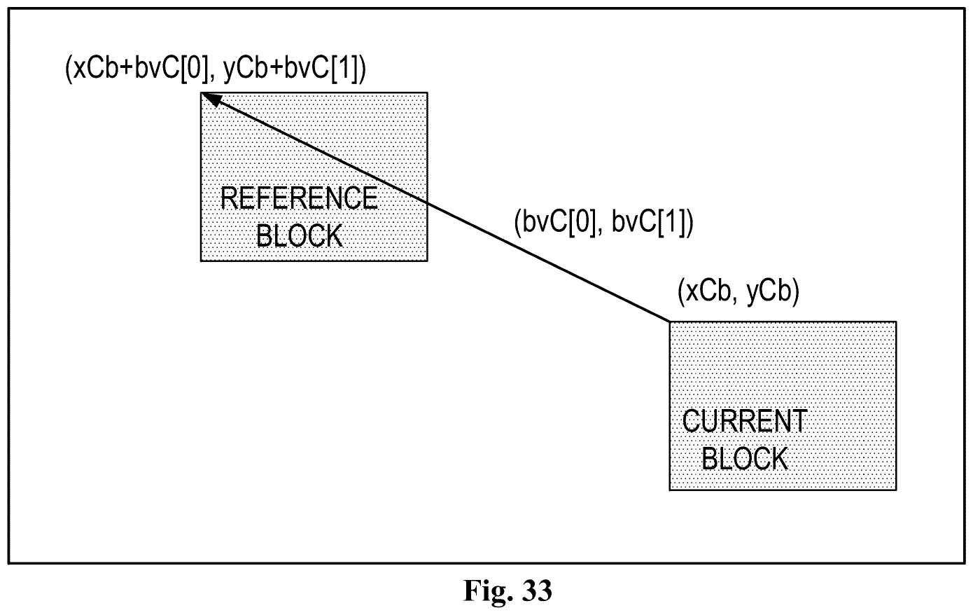

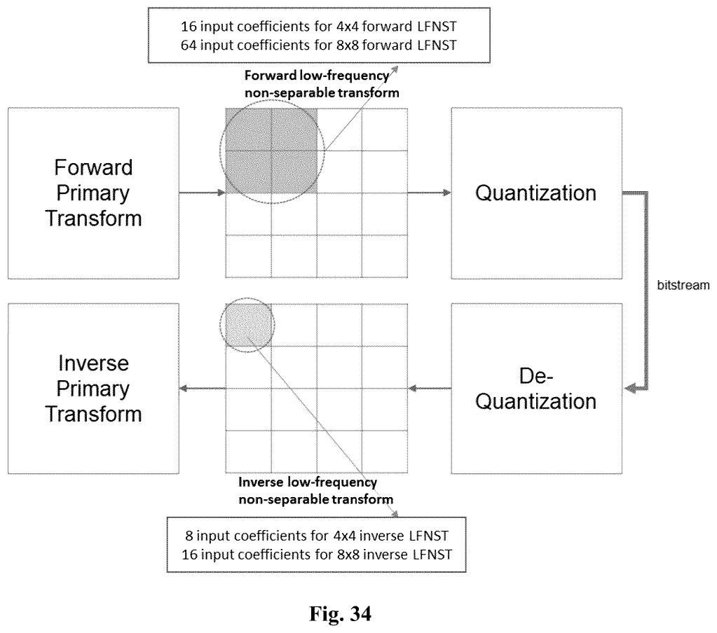

The prediction signal is generated by matching the L-shaped causal neighbor of the current block with another block in a predefined search area in FIG. 31 consisting of:
R1: current CTU,
R2: top-left CTU,
R3: above CTU,
R4: left CTU.

SAD is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$\begin{matrix}SearchRange\_w = a * BlkW , \\ SearchRange\_h = a * BlkH .\end{matrix}$$

where ‘a’ is a constant that controls the gain/complexity trade-off. In practice, ‘a’ is equal to 5.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

2.1.3.6.1 Using Block Vector Derived from IntraTMP for IBC

Block vector (BV) derived from the intra template matching prediction (IntraTMP) is used for intra block copy (IBC). The stored IntraTMP BV of the neighboring blocks along with IBC BV are used as spatial BV candidates in IBC candidate list construction.

### 2.1.3.6.2 Direct Block Vector (DBV) Mode for Chroma Prediction

For chroma components, when chroma dual tree is activated in intra slice, if one of the luma blocks (the five locations) is coded with MODE_IBC, its block vector bvL is used and scaled to derive chroma block vector bvC. The scaling factor depends on the chroma format sampling structure.

Then, by using the position of the current chroma block (xCb, yCb) and its bvC, the corresponding offset position (xCb+bvC[0], yCb+bvC[1]) is determined, and a block copying prediction is performed.

A CU level flag is signaled to indicate whether the proposed DBV mode is applied as shown in Table 2-7.

TABLE 2-7
The binarization process for intra_chroma_pred_mode
in the proposed method

| intra_chroma_pred_mode | bin string | chroma intra mode |
|---|---|---|
| 0 | 11100 | list[0] |
| 1 | 11101 | list[1] |
| 2 | 11110 | list[2] |
| 3 | 11111 | list[3] |
| 4 | 110 | DIMD chroma |
| 5 | 10 | DM |
| 6 | 0 | DBV |

### 2.1.4 Transform and Quantization

2.1.4.1 Large Block-Size Transforms with High-Frequency Zeroing

In VVC, large block-size transforms, up to 64×64 in size, are enabled, which is primarily useful for higher resolution video, e.g., 1080p and 4K sequences. High frequency transform coefficients are zeroed out for the transform blocks with size (width or height, or both width and height) equal to 64, so that only the lower-frequency coefficients are retained. For example, for an M×N transform block, with M as the block width and N as the block height, when M is equal to 64, only the left 32 columns of transform coefficients are kept. Similarly, when N is equal to 64, only the top 32 rows of transform coefficients are kept. When transform skip mode is used for a large block, the entire block is used without zeroing out any values. In addition, transform shift is removed in transform skip mode. The VTM also supports configurable max transform size in SPS, such that encoder has the flexibility to choose up to 32-length or 64-length transform size depending on the need of specific implementation.

### 2.1.4.2 Multiple Transform Selection (MTS) for Core Transform

In addition to DCT-II which has been employed in HEVC, a Multiple Transform Selection (MTS) scheme is used for residual coding both inter and intra coded blocks. It uses multiple selected transforms from the DCT8/DST7. The newly introduced transform matrices are DST-VII and DCT-VIII. Table 2-8 shows the basis functions of the selected DST/DCT.

TABLE 2-8
Transform basis functions of DCT-II/ VIII and DSTVII for N-point input

| Transform Type | Basis function Tᵢ(j), i, j = 0, 1, . . . , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ |
| | $where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 1} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

In order to keep the orthogonality of the transform matrix, the transform matrices are quantized more accurately than the transform matrices in HEVC. To keep the intermediate values of the transformed coefficients within the 16-bit range, after horizontal and after vertical transform, all the coefficients are to have 10-bit.

In order to control MTS scheme, separate enabling flags are specified at SPS level for intra and inter, respectively. When MTS is enabled at SPS, a CU level flag is signalled to indicate whether MTS is applied or not. Here, MTS is applied only for luma. The MTS signaling is skipped when one of the below conditions is applied.
The position of the last significant coefficient for the luma TB is less than 1 (i.e., DC only).
The last significant coefficient of the luma TB is located inside the MTS zero-out region.

If MTS CU flag is equal to zero, then DCT2 is applied in both directions. However, if MTS CU flag is equal to one, then two other flags are additionally signalled to indicate the transform type for the horizontal and vertical directions, respectively. Transform and signalling mapping table as shown in Table 2-9. Unified the transform selection for ISP and implicit MTS is used by removing the intra-mode and block-shape dependencies. If current block is ISP mode or if the current block is intra block and both intra and inter explicit MTS is on, then only DST7 is used for both horizontal and vertical transform cores. When it comes to transform matrix precision, 8-bit primary transform cores are used. Therefore, all the transform cores used in HEVC are kept as the same, including 4-point DCT-2 and DST-7, 8-point, 16-point and 32-point DCT-2. Also, other transform cores including 64-point DCT-2, 4-point DCT-8, 8-point, 16-point, 32-point DST-7 and DCT-8, use 8-bit primary transform cores.

TABLE 2-9
Transform and signalling mapping table

| MTS_CU_{—} | MTS_Hor_{—} | MTS_Ver_{—} | Intra/inter | |
|---|---|---|---|---|
| flag | flag | flag | Horizontal | Vertical |
| 0 | | | DCT2 | |
| 1 | 0 | 0 | DST7 | DST7 |
| | 0 | 1 | DCT8 | DST7 |
| | 1 | 0 | DST7 | DCT8 |
| | 1 | 1 | DCT8 | DCT8 |

To reduce the complexity of large size DST-7 and DCT-8, High frequency transform coefficients are zeroed out for the DST-7 and DCT-8 blocks with size (width or height, or both width and height) equal to 32. Only the coefficients within the 16×16 lower-frequency region are retained.

As in HEVC, the residual of a block can be coded with transform skip mode. To avoid the redundancy of syntax coding, the transform skip flag is not signalled when the CU level MTS_CU_flag is not equal to zero. Note that implicit MTS transform is set to DCT2 when LFNST or MIP is activated for the current CU. Also the implicit MTS can be still enabled when MTS is enabled for inter coded blocks.

### 2.1.4.3 Low-Frequency Non-Separable Transform (LFNST)

In VVC, LFNST is applied between forward primary transform and quantization (at encoder) and between de-quantization and inverse primary transform (at decoder side). In LFNST, 4×4 non-separable transform or 8×8 non-separable transform is applied according to block size. For example, 4×4 LFNST is applied for small blocks (i.e., min(width, height)<8) and 8×8 LFNST is applied for larger blocks (i.e., min(width, height)>4).

Application of a non-separable transform, which is being used in LFNST, is described as follows using input as an example. To apply 4×4 LFNST, the 4×4 input block X

$$X = [ \begin{matrix}{X}_{00} & {X}_{01} & {X}_{02} & {X}_{03} \\ {X}_{10} & {X}_{11} & {X}_{12} & {X}_{13} \\ {X}_{20} & {X}_{21} & {X}_{22} & {X}_{23} \\ {X}_{30} & {X}_{31} & {X}_{32} & {X}_{33}\end{matrix} ] \qquad ( 2 - 35 )$$

is first represented as a vector [symbol] :

$$\vec{X} = {[ \begin{matrix}{X}_{00} & {X}_{01} & {X}_{02} & {X}_{03} & {X}_{10} & {X}_{11} & {X}_{12} & {X}_{13} & {X}_{20} & {X}_{21} & {X}_{22} & {X}_{23} & {X}_{30} & {X}_{31} & {X}_{32} & {X}_{33}\end{matrix} ]}^{T} \qquad ( 2 - 36 )$$

The non-separable transform is calculated as [symbol] =T· [symbol] , where [symbol] indicates the transform coefficient vector, and T is a 16×16 transform matrix. The 16×1 coefficient vector [symbol] is subsequently re-organized as 4×4 block using the scanning order for that block (horizontal, vertical or diagonal). The coefficients with smaller index will be placed with the smaller scanning index in the 4×4 coefficient block.

### 2.1.4.3.1 Reduced Non-Separable Transform

LFNST (low-frequency non-separable transform) is based on direct matrix multiplication approach to apply non-separable transform so that it is implemented in a single pass without multiple iterations. However, the non-separable transform matrix dimension needs to be reduced to minimize computational complexity and memory space to store the transform coefficients. Hence, reduced non-separable transform (or RST) method is used in LFNST. The main idea of the reduced non-separable transform is to map an N (N is commonly equal to 64 for 8×8 NSST) dimensional vector to an R dimensional vector in a different space, where N/R (R<N) is the reduction factor. Hence, instead of N×N matrix, RST matrix becomes an R×N matrix as follows:

$${T}_{R \times N} = [ \begin{matrix}{t}_{11} & {t}_{12} & {t}_{13} & … & {t}_{1 N} \\ {t}_{21} & {t}_{22} & {t}_{23} & & {t}_{2 N} \\ & ⋮ & & ⋱ & ⋮ \\ {t}_{R 1} & {t}_{R 2} & {t}_{R 3} & ⋯ & {t}_{RN}\end{matrix} ] \qquad ( 2 - 37 )$$

where the R rows of the transform are R bases of the N dimensional space. The inverse transform matrix for RT is the transpose of its forward transform. For 8×8 LFNST, a reduction factor of 4 is applied, and 64×64 direct matrix, which is conventional 8×8 non-separable transform matrix size, is reduced to 16×48 direct matrix. Hence, the 48×16 inverse RST matrix is used at the decoder side to generate core (primary) transform coefficients in 8×8 top-left regions. When 16×48 matrices are applied instead of 16×64 with the same transform set configuration, each of which takes 48 input data from three 4×4 blocks in a top-left 8×8 block excluding right-bottom 4×4 block. With the help of the reduced dimension, memory usage for storing all LFNST matrices is reduced from 10 KB to 8 KB with reasonable performance drop. In order to reduce complexity LFNST is restricted to be applicable only if all coefficients outside the first coefficient sub-group are non-significant. Hence, all primary-only transform coefficients have to be zero when LFNST is applied. This allows a conditioning of the LFNST index signalling on the last-significant position, and hence avoids the extra coefficient scanning in the current LFNST design, which is needed for checking for significant coefficients at specific positions only. The worst-case handling of LFNST (in terms of multiplications per pixel) restricts the non-separable transforms for 4×4 and 8×8 blocks to 8×16 and 8×48 transforms, respectively. In those cases, the last-significant scan position has to be less than 8 when LFNST is applied, for other sizes less than 16. For blocks with a shape of 4×N and N×4 and N>8, the proposed restriction implies that the LFNST is now applied only once, and that to the top-left 4×4 region only. As all primary-only coefficients are zero when LFNST is applied, the number of operations needed for the primary transforms is reduced in such cases. From encoder perspective, the quantization of coefficients is remarkably simplified when LFNST transforms are tested. A rate-distortion optimized quantization has to be done at maximum for the first 16 coefficients (in scan order), the remaining coefficients are enforced to be zero.

### 2.1.4.3.2 LFNST Transform Selection

There are totally 4 transform sets and 2 non-separable transform matrices (kernels) per transform set are used in LFNST. The mapping from the intra prediction mode to the transform set is pre-defined as shown in Table 2-10. If one of three CCLM modes (INTRA_LT_CCLM, INTRA_T_CCLM or INTRA_L_CCLM) is used for the current block (81<=predModeIntra <=83), transform set 0 is selected for the current chroma block. For each transform set, the selected non-separable secondary transform candidate is further specified by the explicitly signalled LFNST index. The index is signalled in a bit-stream once per Intra CU after transform coefficients.

TABLE 2-10
Transform selection table

| IntraPredMode | Tr. set index |
|---|---|
| IntraPredMode < 0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode <= 80 | 1 |
| 81 <= IntraPredMode <= 83 | 0 |

2.1.4.3.3 LFNST Index Signaling and Interaction with Other Tools

Since LFNST is restricted to be applicable only if all coefficients outside the first coefficient sub-group are non-significant, LFNST index coding depends on the position of the last significant coefficient. In addition, the LFNST index is context coded but does not depend on intra prediction mode, and only the first bin is context coded. Furthermore, LFNST is applied for intra CU in both intra and inter slices, and for both Luma and Chroma. If a dual tree is enabled, LFNST indices for Luma and Chroma are signaled separately. For inter slice (the dual tree is disabled), a single LFNST index is signaled and used for both Luma and Chroma.

Considering that a large CU greater than 64×64 is implicitly split (TU tiling) due to the existing maximum transform size restriction (64×64), an LFNST index search could increase data buffering by four times for a certain number of decode pipeline stages. Therefore, the maximum size that LFNST is allowed is restricted to 64×64. Note that LFNST is enabled with DCT2 only. The LFNST index signaling is placed before MTS index signaling.

The use of scaling matrices for perceptual quantization is not evident that the scaling matrices that are specified for the primary matrices may be useful for LFNST coefficients. Hence, the uses of the scaling matrices for LFNST coefficients are not allowed. For single-tree partition mode, chroma LFNST is not applied.

### 2.1.4.4 Subblock Transform (SBT)

In VTM, subblock transform is introduced for an inter-predicted CU. In this transform mode, only a sub-part of the residual block is coded for the CU. When inter-predicted CU with cu_cbf equal to 1, cu_sbt_flag may be signaled to indicate whether the whole residual block or a sub-part of the residual block is coded. In the former case, inter MTS information is further parsed to determine the transform type of the CU. In the latter case, a part of the residual block is coded with inferred adaptive transform and the other part of the residual block is zeroed out.

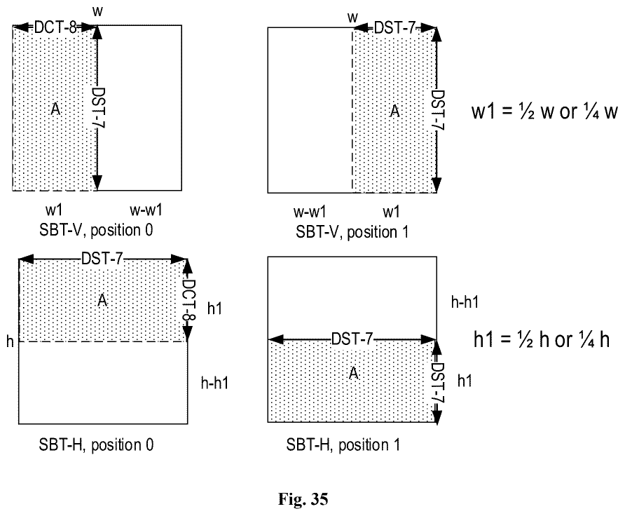

When SBT is used for an inter-coded CU, SBT type and SBT position information are signaled in the bitstream. There are two SBT types and two SBT positions, as indicated in FIG. 35. For SBT-V (or SBT-H), the TU width (or height) may equal to half of the CU width (or height) or ¼ of the CU width (or height), resulting in 2:2 split or 1:3/3:1 split. The 2:2 split is like a binary tree (BT) split while the 1:3/3:1 split is like an asymmetric binary tree (ABT) split. In ABT splitting, only the small region contains the non-zero residual. If one dimension of a CU is 8 in luma samples, the 1:3/3:1 split along that dimension is disallowed. There are at most 8 SBT modes for a CU.

Position-dependent transform core selection is applied on luma transform blocks in SBT-V and SBT-H (chroma TB always using DCT-2). The two positions of SBT-H and SBT-V are associated with different core transforms. More specifically, the horizontal and vertical transforms for each SBT position is specified in FIG. 35. For example, the horizontal and vertical transforms for SBT-V position 0 is DCT-8 and DST-7, respectively. When one side of the residual TU is greater than 32, the transform for both dimensions is set as DCT-2. Therefore, the subblock transform jointly specifies the TU tiling, cbf, and horizontal and vertical core transform type of a residual block.

The SBT is not applied to the CU coded with combined inter-intra mode.

### 2.1.4.5 Maximum Transform Size and Zeroing-Out of Transform Coefficients

Both CTU size and maximum transform size (i.e., all MTS transform kernels) are extended to 256, where the maximum intra coded block can have a size of 128×128. The maximum CTU size is set to 256 for UHD sequences and it is set to 128, otherwise. In the primary transformation process, there is no normative zeroing out operation applied on transform coefficients. However, if LFNST is applied, the primary transform coefficients outside the LFNST region are normatively zeroed-out.

### 2.1.4.6 Enhanced MTS for Intra Coding

In the current VVC design, for MTS, only DST7 and DCT8 transform kernels are utilized which are used for intra and inter coding.

Additional primary transforms including DCT5, DST4, DST1, and identity transform (IDT) are employed. Also MTS set is made dependent on the TU size and intra mode information. 16 different TU sizes are considered, and for each TU size 5 different classes are considered depending on intra-mode information. For each class, 4 different transform pairs are considered, the same as that of VVC. Note, although a total of 80 different classes are considered, some of those different classes often share exactly same transform set. So there are 58 (less than 80) unique entries in the resultant LUT.

For angular modes, a joint symmetry over TU shape and intra prediction is considered. So, a mode i (i>34) with TU shape A×B will be mapped to the same class corresponding to the mode j=(68−i) with TU shape B×A. However, for each transform pair the order of the horizontal and vertical transform kernel is swapped. For example, for a 16×4 block with mode 18 (horizontal prediction) and a 4×16 block with mode 50 (vertical prediction) are mapped to the same class. However, the vertical and horizontal transform kernels are swapped. For the wide-angle modes the nearest conventional angular mode is used for the transform set determination. For example, mode 2 is used for all the modes between −2 and −14. Similarly, mode 66 is used for mode 67 to mode 80.

MTS index [0,3] is signalled with 2 bit fixed-length coding.

2.1.4.7 Secondary Transformation: LFNST Extension with Large Kernel

The LFNST design in VVC is extended as follows:
The number of LFNST sets(S) and candidates (C) are extended to S=35 and C=3, and the LFNST set (lfnstTrSetIdx) for a given intra mode (predModeIntra) is derived according to the following formula:
   For predModeIntra<2, lfnstTrSetIdx is equal to 2.
   lfnstTrSetIdx=predModeIntra, for predModeIntra in [0,34].
   lfnstTrSetIdx=68-predModeIntra, for predModeIntra in [35,66].
Three different kernels, LFNST4, LFNST8, and LFNST16, are defined to indicate LFNST kernel sets, which are applied to 4×N/N×4 (N≥4), 8×N/N×8 (N≥8), and M×N (M, N≥16), respectively.

The kernel dimensions are specified by:

$$( LFSNT 4 , LFNST {8}^{*} , LFNST {16}^{*} ) = ( 16 \times 16 , 32 \times 32 , 32 \times 96 ) .$$

The forward LFNST is applied to top-left low frequency region, which is called Region-Of-Interest (ROI). When LFNST is applied, primary-transformed coefficients that exist in the region other than ROI are zeroed out, which is not changed from the VVC standard.

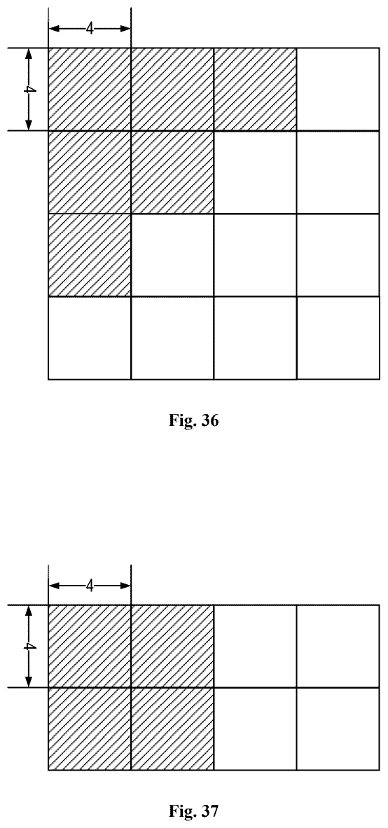

The ROI for LFNST16 is depicted in FIG. 36. It consists of six 4×4 sub-blocks, which are consecutive in scan order. Since the number of input samples is 96, transform matrix for forward LFNST16 can be R×96. R is chosen to be 32 in this contribution, 32 coefficients (two 4×4 sub-blocks) are generated from forward LFNST16 accordingly, which are placed following coefficient scan order.

The ROI for LFNST8 is shown in FIG. 37. The forward LFNST8 matrix can be R×64 and R is chosen to be 32.

The generated coefficients are located in the same manner as with LFNST16.

The mapping from intra prediction modes to these sets is shown in Table 2-11.

TABLE 2-11
Mapping of intra prediction modes to LFNST set index

| Intra pred. mode | −14 | −13 | −12 | −11 | −10 | −9 | −8 | −7 | −6 | −5 | −4 | −3 | −2 | −1 | 0 | 1 |
|---|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 | 0 | 1 |

| Intra pred. mode | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|
| LFNST set index | 2 | 3 | 4 | 5 | 6 | 7 | 8 | 9 | 10 | 11 | 12 | 13 | 14 | 15 | 16 | 17 |
| Intra pred. mode | 18 | 19 | 20 | 21 | 22 | 23 | 24 | 25 | 26 | 27 | 28 | 29 | 30 | 31 | 32 | 33 |
| LFNST set index | 18 | 19 | 20 | 21 | 22 | 23 | 24 | 25 | 26 | 27 | 28 | 29 | 30 | 31 | 32 | 33 |
| Intra pred. mode | 34 | 35 | 36 | 37 | 38 | 39 | 40 | 41 | 42 | 43 | 44 | 45 | 46 | 47 | 48 | 49 |
| LFNST set index | 34 | 33 | 32 | 31 | 30 | 29 | 28 | 27 | 26 | 25 | 24 | 23 | 22 | 21 | 20 | 19 |
| Intra pred. mode | 50 | 51 | 52 | 53 | 54 | 55 | 56 | 57 | 58 | 59 | 60 | 61 | 62 | 63 | 64 | 65 |
| LFNST set index | 18 | 17 | 16 | 15 | 14 | 13 | 12 | 11 | 10 | 9 | 8 | 7 | 6 | 5 | 4 | 3 |

| Intra pred. mode | 66 | 67 | 68 | 69 | 70 | 71 | 72 | 73 | 74 | 75 | 76 | 77 | 78 | 79 | 80 |
|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 | 2 |

### 2.1.4.8 Non-Separable Primary Transform for Intra Coding (NSPT)

DCT-II+LFNST is replaced by NSPT for the block sizes 4×4, 4×8, 8×4 and 8×8. The NSPTs follows the design of LFNST, i.e. 3 candidates and 35 sets, chosen based on the intra mode. The kernel sizes are as follows:
NSPT4×4: 16×16,
NSPT4×8/NSPT8×4: 32×20,
NSPT8×8: 64×32.

Therefore, 12 and 32 coefficients are zeroed-out for NSPT4×8/NSPT8×4 and NSPT8×8 respectively.

### 2.1.4.9 Sign Prediction

The basic idea of the coefficient sign prediction method (JVET-D0031 and JVET-J0021) is to calculate reconstructed residual for both negative and positive sign combinations for applicable transform coefficients and select the hypothesis that minimizes a cost function.

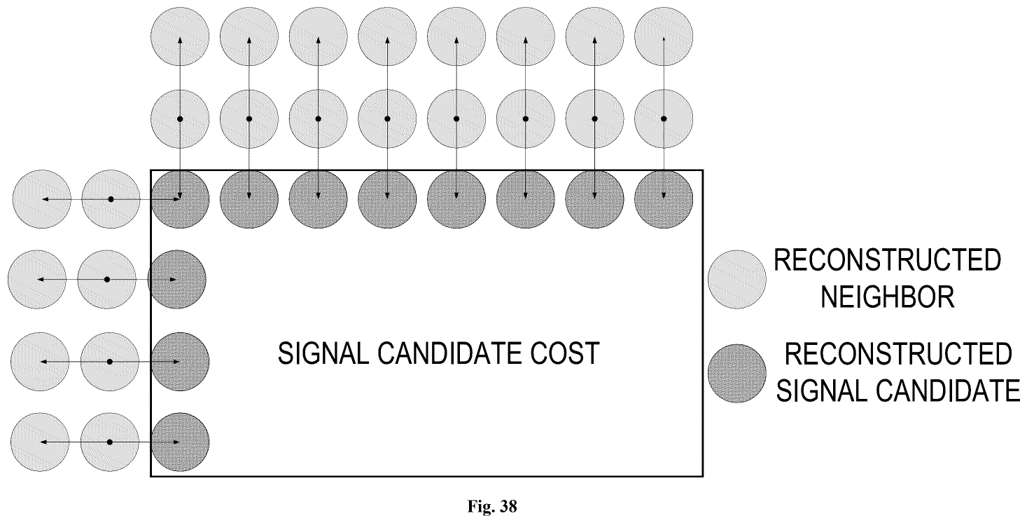

To derive the best sign, the cost function is defined as discontinuity measure across block boundary shown on FIG. 38. It is measured for all hypotheses, and the one with the smallest cost is selected as a predictor for coefficient signs.

The cost function is defined as a sum of absolute second derivatives in the residual domain for the above row and left column as follows:

$$cost = {\sum }_{x = 0}^{w} \vert ( - {R}_{x , - 1} + 2 {R}_{x , 0} - {P}_{x , 1} ) - {r}_{x , 1} \vert + {\sum }_{y = 0}^{h} \vert ( - {R}_{- 1 , y} + 2 {R}_{0 , y} - {P}_{1 , y} ) - {r}_{1 , y} \vert$$

where R is reconstructed neighbors, P is prediction of the current block, and r is the residual hypothesis. The term (−R₋₁+2R₀−P₁) can be calculated only once per block and only residual hypothesis is subtracted.

### 2.2 On Block Level Adaptive OBMC in Video Coding—Neighbor Prediction Mode Dependent

The detailed solutions below should be considered as examples to explain general concepts. These solutions should not be interpreted in a narrow way. Furthermore, these solutions can be combined in any manner.

The terms ‘video unit’ or ‘coding unit’ or ‘block’ may represent a coding tree block (CTB), a coding tree unit (CTU), a coding block (CB), a CU, a PU, a TU, a PB, a TB.

In this section, regarding “a block coded with mode N”, here “mode N” may be a prediction mode (e.g., MODE_INTRA, MODE_INTER, MODE_PLT, MODE_IBC, and etc.), or a coding technique (e.g., AMVP, SMVD, Merge, BDOF, PROF, DMVR, AMVR, TM, Affine, CIIP, GPM, spatial GPM, SGPM, GPM inter-inter, GPM intra-intra, GPM inter-intra, MHP, GEO, TPM, MMVD, BCW, HMVP, SbTMVP, LIC, OBMC, DIMD, TIMD, PDPC, CCLM, CCCM, GLM, intraTMP, ALF, deblocking, SAO, bilateral filter, LMCS, and the corresponding variants, and etc.).

It is noted that the terminologies mentioned below are not limited to the specific ones defined in existing standards. Any variance of the coding tool is also applicable.
2.2.1 In one example, whether OBMC is applied to the current block may be dependent on the prediction mode of spatial/temporal neighboring blocks adjacent/non-adjacent to the current block.
   1) For example, the current block may be inter merge coded.
   2) For example, the current block may be inter AMVP coded.
   3) For example, it may be based on whether there is a neighbor block coded with IBC.
   4) For example, it may be based on whether there is a neighbor block coded with PLT.
   5) For example, it may be based on whether there is a neighbor block coded with intraTMP.
   6) For example, it may be based on whether there is a neighbor block coded with BDPCM.
   7) For example, it may be based on whether there is a neighbor block coded with transform skip.
   8) For example, the neighbor block may be adjacent to the current block.
   9) For example, the neighbor block may be non-adjacent to the current block.
   10) For example, the neighbor block may be a spatial neighbor block inside the current picture.
   11) For example, the neighbor block may be a temporal block in a reference picture.
   12) For example, the neighbor block may be a subblock (e.g., 4×4 or 8×8) which is smaller than the current block.
   13) For example, the neighbor block may be a video unit which is larger than or equal to the current block.
   14) For example, the neighbor block may be a sample location.
   15) For example, a series of adjacent neighboring blocks/subblocks left and/or above the current block may be checked one by one (e.g., following pre-defined positions and pre-defined checking orders).
      a. For example, if there is one neighbor coded with a particular mode, the process is terminated, and it is perceived that OBMC is not applied to the current block.
      b. For example, if there is one neighbor coded with INTER mode, it is further checked whether its reference block is coded with a particular mode, (e.g., the reference block is identified by adding the motion vector associated with such INTER coded neighbor and the position of such INTER coded neighbor), and if the reference block is coded with the particular mode, the process is terminated, and it is perceived that OBMC is not applied to the current block.
         i. For example, the reference block is in a reference picture.
      c. For example, if there is one neighbor coded with intraTMP, it may be further checked whether its reference block is coded with a particular mode, (e.g., the reference block is identified by adding the block vector associated with such intraTMP coded neighbor and the position of such intraTMP coded neighbor), and if the reference block is coded with the particular mode, the process is terminated, and it is perceived that OBMC is not applied to the current block.
         i. For example, the reference block is in the current picture.
      d. For example, the particular mode may be IBC, and/or PLT.
      e. For example, the particular mode may be intraTMP.
      f. For example, the particular mode may be BDPCM.
   g. For example, the particular mode may be transform skip.
   16) For example, a series of non-adjacent neighboring blocks/subblocks in the already coded area of the current picture may be checked one by one (e.g., following pre-defined positions and pre-defined checking orders).
      h. For example, if there is one neighbor coded with a particular mode, the process is terminated, and it is perceived that OBMC is not applied to the current block.
      i. For example, if there is one neighbor coded with INTER mode, it is further checked whether its reference block is coded with a particular mode, (e.g., the reference block is identified by adding the motion vector associated with such INTER coded neighbor and the position of such INTER coded neighbor), and if the reference block is coded with the particular mode, the process is terminated, and it is perceived that OBMC is not applied to the current block.
         i. For example, the reference block is in a reference picture.
      j. For example, if there is one neighbor coded with intraTMP, it is further checked whether its reference block is coded with a particular mode, (e.g., the reference block is identified by adding the block vector associated with such intraTMP coded neighbor and the position of such intraTMP coded neighbor), and if the reference block is coded with the particular mode, the process is terminated, and it is perceived that OBMC is not applied to the current block.
         i. For example, the reference block is in the current picture.
      k. For example, the particular mode may be IBC, and/or PLT.
      l. For example, the particular mode may be intraTMP.
      m. For example, the particular mode may be BDPCM.
      n. For example, the particular mode may be transform skip.
   17) For example, a series of temporal blocks/subblocks in a reference picture may be checked one by one (e.g., following a pre-defined positions and orders).
      o. For example, if there is one temporal block coded with a particular mode, the process is terminated, and it is perceived that OBMC is not applied to the current block.
      p. For example, if there is one temporal block coded with INTER mode, it is further checked whether a reference block is coded with a particular mode, (e.g., the reference block is identified by adding the motion vector associated with such INTER coded temporal block and the position of such INTER coded temporal block), and if the reference block is coded with the particular mode, the process is terminated, and it is perceived that OBMC is not applied to the current block.
      q. For example, if there is one temporal block coded with intraTMP, it is further checked whether its reference block is coded with a particular mode, (e.g., the reference block is identified by adding the block vector associated with such intraTMP coded temporal block and the position of such intraTMP coded temporal block), and if the reference block is coded with the particular mode, the process is terminated, and it is perceived that OBMC is not applied to the current block.
      r. For example, the particular mode may be IBC, and/or PLT.
      s. For example, the particular mode may be intraTMP.
      t. For example, the particular mode may be BDPCM.
      u. For example, the particular mode may be transform skip.
2.2.2 In one example, whether OBMC is applied to the current block may be dependent on the prediction mode of a reference block.
   1) For example, the current block may be inter merge coded.
   2) For example, the current block may be inter AMVP coded.
   3) For example, the reference block may be a block/subblock identified based on adding a displacement (e.g., pre-defined, or based on motion vector, or based on block vector) to the location of a first block.
      a. For example, the first block may be the current block.
      b. For example, the first block may be a neighbor block adjacent to the current block.
      c. For example, the first block may be a neighbor block non-adjacent to the current block.
      d. For example, the first block may be a reference block of the current block.
      e. For example, the first block may be a reference block of a neighbor block.
      f. For example, the reference block may be identified based on the location of an INTER mode coded current block and its motion information (e.g., motion vectors and reference indexes) associated to the current block.
         i. For example, in such case, the reference block is in a reference picture.
      g. For example, the reference block may be identified based on the location of a IntraTMP mode coded current block and its motion information (e.g., block vectors) associated to the current block.
         i. For example, in such case, the reference block is in the current picture.
      h. For example, the reference block may be identified based on the location of an INTER mode coded neighbor block and its motion information (e.g., motion vectors and reference indexes) associated to this INTER mode coded neighbor.
         i. For example, in such case, the reference block is in a reference picture.
      i. For example, the reference block may be identified based on the location of a IntraTMP mode coded neighbor block and its motion information (e.g., block vectors) associated to this IntraTMP mode coded neighbor.
         i. For example, in such case, the reference block is in the current picture.
      j. For example, the reference block may be identified based on the location of an INTER mode coded reference block and its motion information (e.g., motion vectors and reference indexes) associated to this INTER mode coded reference block.
         i. For example, in such case, the reference block is in another reference picture (rather than the reference picture where the INTER mode coded reference block locates at).
      k. For example, the reference block may be identified based on the location of a IntraTMP mode coded reference block and its motion information (e.g., block vectors) associated to this IntraTMP mode coded reference block.
         i. For example, in such case, the reference block is in the same reference picture where the IntraTMP mode coded reference block locates at.
   4) For example, a reference block may be checked in case that the neighbor block is coded with INTER mode.
      a. If the neighbor is INTER coded, a reference block is then identified by adding the motion vector associated with such INTER coded neighbor and the position of such INTER coded neighbor, and if the reference block is coded with the particular mode, it is perceived that OBMC is not applied to the current block.
      b. For example, the particular mode may be IBC, and/or PLT.
      c. For example, the particular mode may be intraTMP.
      d. For example, the particular mode may be BDPCM.
      e. For example, the particular mode may be transform skip.
   5) For example, a reference block may be checked in case that the neighbor block is coded with IntraTMP mode.
      a. If the neighbor is intraTMP coded, a reference block is then identified by adding the block vector associated with such intraTMP coded neighbor and the position of such intraTMP coded neighbor, and if the reference block is coded with the particular mode, it is perceived that OBMC is not applied to the current block.
      b. For example, the particular mode may be IBC, and/or PLT.
      c. For example, the particular mode may be BDPCM.
      d. For example, the particular mode may be transform skip.
2.2.3 in One Example, Whether OBMC is Applied to the Current Block May be Dependent on the Prediction Mode of a Reference Block of a Reference Block.
   1) For example, the current block may be inter merge coded.
   2) For example, the current block may be inter AMVP coded.
   3) For example, the reference block of a reference block may be identified by adding a motion vector associated with an INTER mode coded reference block and the position of such INTER coded reference block.
   4) For example, the reference block of a reference block may be identified by adding a block vector associated with a IntraTMP mode coded reference block and the position of such IntraTMP coded reference block.
   5) For example, a historical/propagated prediction mode may be stored in a buffer.
      a. For example, either a block itself is coded with a particular mode or it ever has a reference block coded with the particular mode, the particular mode may be stored in a buffer associated with the block information, indicating it has a historical/propagated information with the particular mode.
   6) For example, the particular mode may be IBC, and/or PLT.
   7) For example, the particular mode may be intraTMP.
   8) For example, the particular mode may be BDPCM.
   9) For example, the particular mode may be transform skip.
2.2.4 In one example, whether a block in the current picture is coded as a particular mode may be stored in a buffer.
   1) For example, the particular mode may be IBC.
   2) For example, the particular mode may be PLT.
   3) For example, the particular mode may be intraTMP.
   4) For example, the particular mode may be BDPCM.
   5) For example, the particular mode may be transform skip.
   6) For example, whether a block is coded with IBC or PLT, may be stored using a shared parameter/buffer.
      a. For example, a single parameter/buffer may be needed for the storage.
   7) For example, whether a block is coded with IBC or PLT or intraTMP or BDPCM, may be stored using individual parameters/buffers.
      b. For example, multiple parameters/buffers may be needed for the storage.
   8) For example, it may be stored in a granularity of M×M (e.g., M=4 or 8) subblock.
2.2.5 In one example, whether a block and/or its reference block is coded as a particular mode may be stored in a buffer.
   1) For example, the particular mode may be IBC.
   2) For example, the particular mode may be PLT.
   3) For example, the particular mode may be intraTMP.
   4) For example, the particular mode may be BDPCM.
   5) For example, the particular mode may be transform skip.
   6) For example, either the block or its reference block is coded with IBC or PLT, a parameter equal to true (e.g., indicating it is a historical/propagated screen content block) may be stored in a buffer.
      a. Alternatively, on the other hand, a parameter equal to false (e.g., indicating it is not a historical/propagated screen content block) may be stored in a buffer.
   7) For example, whether a block is coded with IBC or PLT, and whether a reference block of such block is coded with IBC or PLT, may be stored as separate parameters and in separate buffers.
   8) For example, it may be stored in a granularity of M×M (e.g., M=4 or 8) subblock.
2.2.6 In one example, whether to enable OBMC may be coupled with whether a particular tool is enabled.
   1) For example, the particular tool may be IBC.
   2) For example, the particular tool may be PLT.
   3) For example, the particular tool may be intraTMP.
   4) For example, the particular tool may be BDPCM.
   5) For example, the particular tool may be transform skip.
   6) In one example, whether to apply the particular tool may be controlled by a first syntax element (SE), such as in VPS/SPS/PPS/slice header/CTU/CU/etc.
   7) In one example, whether to apply OBMC may be controlled by a second syntax element (SE), such as in VPS/SPS/PPS/slice header/CTU/CU/etc.
   8) In one example, it may be constrained that the second SE must indicate OBMC to be disabled if the first SE indicates the particular tool is enabled.
   9) In one example, it may be set at the encoder that the second SE must indicate OBMC to be disabled if the first SE indicates the particular tool is enabled.
2.2.7 Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
2.2.8 Whether to and/or how to apply the disclosed methods above may be signalled at PB/TB/CB/PU/TU/CU/VPDU/CTU/CTU row/slice/tile/sub-picture/other kinds of region contain more than one sample or pixel.
2.2.9 Whether to and/or how to apply the disclosed methods above may be dependent on coded information, such as block size, colour format, single/dual tree partitioning, colour component, slice/picture type.

### 2.3 on Block Level Adaptive OBMC in Video Coding—Sample Value Dependent

The detailed solutions below should be considered as examples to explain general concepts. These solutions should not be interpreted in a narrow way. Furthermore, these solutions can be combined in any manner. The terms ‘video unit’ or ‘coding unit’ or ‘block’ may represent a coding tree block (CTB), a coding tree unit (CTU), a coding block (CB), a CU, a PU, a TU, a PB, a TB.

In this section, regarding “a block coded with mode N”, here “mode N” may be a prediction mode (e.g., MODE_INTRA, MODE_INTER, MODE_PLT, MODE_IBC, and etc.), or a coding technique (e.g., AMVP, SMVD, Merge, BDOF, PROF, DMVR, AMVR, TM, Affine, CIIP, GPM, spatial GPM, SGPM, GPM inter-inter, GPM intra-intra, GPM inter-intra, MHP, GEO, TPM, MMVD, BCW, HMVP, SbTMVP, LIC, OBMC, DIMD, TIMD, PDPC, CCLM, CCCM, GLM, intraTMP, ALF, deblocking, SAO, bilateral filter, LMCS, and the corresponding variants, and etc.).

It is noted that the terminologies mentioned below are not limited to the specific ones defined in existing standards. Any variance of the coding tool is also applicable.
2.3.1 In one example, whether OBMC is applied to the current block may be dependent on sample values of samples inside the current block (and/or neighboring to the current block).
   1) For example, the current block may be inter merge coded.
   2) For example, the current block may be inter AMVP coded.
   3) For example, it may be based on the prediction samples (before OBMC) of the current block.
   4) For example, it may be based on the prediction samples of neighboring to the current block.
   5) For example, it may be based on the reconstruction samples of neighboring to the current block.
   6) For example, it may be based on the gradients/directions/angles (or histogram of gradients/directions/angles) of samples inside the current block (and/or neighboring to the current block).
      a. For example, current prediction samples before OBMC may be used.
      b. For example, neighboring reconstruction samples may be used.
      c. For example, the histogram of gradients/directions/angles may be computed based on counting gradients along certain directions/angles.
         i. For example, the certain directions/angles may be pre-defined.
         ii. For example, the certain directions/angles may be based on the directions of intra prediction angular modes in video coding.
         iii. For example, for a certain direction/angle, a gradient amplitude may be computed based on counting the (amplitudes of) gradients of at least one sample in the current block.
         1. For example, the (amplitude of) gradient at a certain position (e.g., center) in the current block may be counted.
         2. For example, the (amplitude of) gradient at a series of certain positions in the current block may be counted.
         3. For example, the (amplitudes of) gradients of all samples in the current block may be counted.
         4. For example, the (amplitudes of) gradients of all samples except the first row, last row, first column, last column samples in the current block may be counted.
         iv. For example, for a certain direction/angle, a gradient amplitude may be computed based on counting the (amplitudes of) gradients of at least one sample neighboring to the current block.
         1. For example, the (amplitude of) gradient at certain positions neighboring to the current block may be counted.
         2. For example, the (amplitudes of) gradients of all samples (on the left and/or top) neighboring to the current block may be counted.
      d. For example, the histogram of gradients/directions/angles may be computed based on dividing the entire range of directions/angles into a series of intervals/bins.
      e. For example, the histogram of gradients/directions/angles may be computed based on counting the (amplitudes of) gradients in each interval/bin/direction/angle.
   7) For example, it may be based on the colors/luminance/intensity (or histogram of colors/luminance/intensity) of the samples inside the current block (and/or neighboring to the current block).
      a. For example, current prediction samples before OBMC may be used.
      b. For example, neighboring reconstruction samples may be used.
      c. For example, the histogram of colors/luminance/intensity may be computed based on counting the sample values in Y and/or U and/or V (or, R and/or G and/or B) component domain.
         i. For example, the sample values at a series of certain positions in the current block may be counted.
         ii. For example, the sample values of all samples in the current block may be counted.
         iii. For example, the sample values at certain positions neighboring to the current block may be counted.
         iv. For example, the sample values of all samples (on the left and/or top) neighboring to the current block may be counted.
      d. For example, the histogram of colors/luminance/intensity may be computed based on dividing the entire range of colors/luminance/intensity values into a series of intervals/bins.
      e. For example, the histogram of colors/luminance/intensity may be computed based on counting the number of samples in each interval/bin.
   8) For example, it may be based on the number of main gradients/directions/angles/colors/luminance/intensity of samples inside the current block (and/or neighboring to the current block).
      a. For example, it may be calculated based on prediction samples (before OBMC) inside the current block.
      b. For example, it may be calculated based on reconstruction samples neighboring to the current block.
      c. For example, the main gradients/directions/angles/colors/luminance/intensity may be derived based on the histogram of gradients/directions/angles/colors/luminance/intensity.
      d. For example, the main gradients/directions/angles/colors/luminance/intensity may be derived based on how many intervals/bins in the histogram show values (e.g., gradient amplitudes, color values, luminance values) greater than a threshold.
      e. For example, the main gradients/directions/angles/colors/luminance/intensity may be derived based on how many intervals/bins in the histogram provide much greater values (e.g., gradient amplitudes, color values, luminance values) than the values of other intervals/bins.
         i. For example, the values of intervals/bins in the histogram may be sorted firstly—assume the values after sorting (e.g., from large to small) are represented by X₀, X₁, X₂ . . . , Xₙ₋₂, Xₙ₋₁, wherein n intervals/bins are included in the histogram—if Xᵢ>=a*(Xᵢ₊₁), then the intervals/bins from 0 to i may be treated as main gradients, wherein a denotes a scale factor (e.g., a may be equal to a constant between 2 and 20).
         ii. For example, if the number of main gradients/directions/angles/colors/luminance/intensity is less than a certain number (e.g., 1 or 2 or 3 or 4 or 5 or 6 or 7 or 8 or 9), OBMC may not be applied to the block.
2.3.2 In one example, whether OBMC is applied to the current block may be dependent on template costs.
   1) For example, the current block may be inter merge coded.
   2) For example, the current block may be inter AMVP coded.
   3) For example, it may be based on a first non-blended template cost and a second blended template cost.
      a. For example, the first template cost may be computed based on a SAD between a current template and a reference template (wherein the reference template is identified by adding the current motion vector to the position of the current template).
      b. For example, the second template cost may be computed based on a SAD between a current template and a blended reference template (wherein the blended reference template may be generated by blending a template identified by current motion vector and a template identified by a neighbor motion vector).
      c. For example, if the non-blended template cost is smaller, OBMC may not be applied to the block.
         i. Alternatively, if the blended template cost is smaller, OBMC may be applied to the block.
2.3.3 In one example, whether OBMC is applied to the current block may be dependent on the motion vector precision of the current block.
   1) For example, the current block may be inter merge coded.
   2) For example, the current block may be inter AMVP coded.
   3) For example, it may be based on whether the motion vectors of the block are integer (rather than fractional) precision motion vectors.
   4) For example, it may be based on whether the motion vector differences of the block are integer (rather than fractional) precision motion vector differences.
2.3.4 In one example, when a second block's coding information is used for current block's coding process, the location of the second block may be restricted based on a certain rule.
   1) For example, the current block's coding process may refer to at least one of the followings:
      a. mode decision.
      b. motion candidate derivation.
      c. motion list generation.
      d. block vector candidate derivation.
      e. block vector list generation.
      f. intra mode candidate derivation.
      g. intra luma MPM list generation.
      h. intra chroma block vector candidate derivation under dual tree.
      i. intra chroma mode candidate derivation under dual tree.
      j. block level OBMC on/off decision.
   2) For example, the second block may be a reference block of the current block.
   3) For example, the second block may be a reference block of a reference block of the current block.
   4) For example, the second block may be a luma block collocated or non-collocated of the current chroma block.
   5) For example, the second block may be required to not exceed a valid range.
      a. For example, the valid search range may be pre-defined.
      b. For example, the valid search range may be based on CTU size/information.
      c. For example, the valid search range may be based on VPDU size/information.
      d. For example, the valid search range may be based on tile size/information.
      e. For example, the valid search range may be based on subpicture size/information.
   6) For example, when the second block represents a reference block derived by a motion vector (e.g., from a inter mode), the requirement of the location of the reference block may be based on the location of the CTU/CTU row/tile/subpicture where the current block locates.
      a. For example, the location of the reference block may be required to not exceed the collocated CTU (i.e., the CTU in the reference picture and collocated to the current CTU) and X (such as X=3) sample columns on the right side adjacent to the collocated CTU.
      b. For example, the location of the reference block may be required to not exceed the collocated CTU and the CTU on the right side adjacent to the collocated CTU.
      c. For example, the location of the reference block may be required to not exceed the collocated CTU row.
      d. For example, the location of the reference block may be required to not exceed Y (such as Y=3) sample rows above the collocated CTU.
      e. For example, the location of the reference block may be required to not exceed the collocated subpicture.
      f. For example, the location of the reference block may be required to not exceed the collocated tile.
   7) For example, when the second block represents a reference block B of a reference block A of the current block, the requirement of the location of the reference block B may be based on the location of the CTU/CTU row/tile/subpicture where the current block locates.
      a. For example, the location of the reference block B may be required to not exceed the collocated CTU and X (such as X=3) sample columns on the right side adjacent to the collocated CTU.
      b. For example, the location of the reference block may be required to not exceed the collocated CTU and the CTU on the right side adjacent to the collocated CTU.
      c. For example, the location of the reference block may be required to not exceed the collocated CTU row.
      d. For example, the location of the reference block may be required to not exceed Y (such as Y=3) sample rows above the collocated CTU.
      e. For example, the location of the reference block may be required to not exceed the collocated CTU and the CTU on the left side adjacent to the collocated CTU.
      f. For example, the location of the reference block may be required to not exceed the collocated CTU and the CTU on the left side and the CTU on the right side adjacent to the collocated CTU.
      g. For example, the location of the reference block may be required to not exceed the collocated subpicture.
      h. For example, the location of the reference block may be required to not exceed the collocated tile.
   8) For example, when the second block is a luma block of the current chroma block, the location of the luma block may be required to not exceed the collocated luma CU.
      a. Alternatively, the location of the luma block may be required to not exceed the current luma CTU.
      b. Alternatively, the location of the luma block may be required to not exceed the current luma CTU and one CTU on the right side adjacent to the current luma CTU.
      c. Alternatively, the location of the luma block may be required to not exceed the current luma CTU row.
   9) For example, when the second block exceeds the valid range (or, outside the required location range), the second block may be treated as not available.
      a. For example, in such case, a pre-defined coding information may be used instead.
      b. For example, in such case, the coding information of the second block is not used.
2.3.5 For example, how many and/or which prediction samples are used for a mode decision may be based on coding information and/or pre-defined rules.
   1) For example, the mode decision may refer to at least one of the followings:
      a. Gradient/DIMD based OBMC on/off determination.
      b. Gradient/DIMD based transform kernel determination.
      c. Gradient/DIMD based intra mode derivation for primary transform.
      d. Gradient/DIMD based intra mode derivation for secondary transform.
      e. Gradient/DIMD based intra mode derivation for separable transform.
      f. Gradient/DIMD based intra mode derivation for non-separable transform.
      g. LFNST kernel derivation for a particular mode (e.g., MIP mode).
      h. NSPT kernel derivation for a particular mode (e.g., MIP mode).
   2) For example, not all prediction samples within the current block are used for the mode decision.
   3) For example, partial of prediction samples within the current block are used for mode decision.
   4) For example, the prediction samples used for the mode decision may be subsampled.
   5) For example, the prediction samples inside the current block may be subsampled by a subsampling factor.
      a. For example, the subsampling factor in width direction may be equal to 1 or 2 or 4 or 8.
      b. For example, the subsampling factor in height direction may be equal to 1 or 2 or 4 or 8.
      c. For example, the value of subsampling factor in width and/or height direction may be derived based on the block width and/or height.
         i. For example, larger subsample factor may be used for larger blocks.
         ii. For example, smaller subsample factor may be used for smaller blocks.
   6) For example, whether the prediction samples are subsampled may be determined based on block information.
      a. For example, it may be based on the number of samples in the block.
      b. For example, it may be based on the block width.
      c. For example, it may be based on the block height.
      d. For example, the subsampling method may be based on at least one threshold.
   7) For example, the first and/or last row and/or columns of samples in a prediction block may not be used for the mode decision.
      a. For example, the prediction block may be subsampled.
      b. For example, the prediction block may not be subsampled.
   8) For example, partial/subsampled samples may be used for the mode decision.
   9) For example, gradients and/or histogram of gradients/colors/luminance/intensity may be calculated based on the partial/subsampled samples.
2.3.6 Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
2.3.7 Whether to and/or how to apply the disclosed methods above may be signalled at PB/TB/CB/PU/TU/CU/VPDU/CTU/CTU row/slice/tile/sub-picture/other kinds of region contain more than one sample or pixel.
2.3.8 Whether to and/or how to apply the disclosed methods above may be dependent on coded information, such as block size, colour format, single/dual tree partitioning, colour component, slice/picture type.

### 3. Problems

In ECM-7.0, coding tools are applied to both natural and screen content tools. For some coding tools (such as IBC, PLT, and etc.), the tool on/off can be controlled by sequence level syntax element, however, without adaptive block level video content detection.

### 4. Detailed Solutions

The detailed solutions below should be considered as examples to explain general concepts. These solutions should not be interpreted in a narrow way. Furthermore, these solutions can be combined in any manner.

The terms ‘video unit’ or ‘coding unit’ or ‘block’ may represent a coding tree block (CTB), a coding tree unit (CTU), a coding block (CB), a CU, a PU, a TU, a PB, a TB.

In this section, regarding “a block coded with mode N”, here “mode N” may be a prediction mode (e.g., MODE_INTRA, MODE_INTER, MODE_PLT, MODE_IBC, and etc.), or a coding technique (e.g., AMVP, SMVD, Merge, BDOF, PROF, DMVR, AMVR, TM, Affine, CIIP, GPM, spatial GPM, SGPM, GPM inter-inter, GPM intra-intra, GPM inter-intra, MHP, GEO, TPM, MMVD, BCW, HMVP, SbTMVP, LIC, OBMC, DIMD, TIMD, PDPC, CCLM, CCCM, GLM, intraTMP, ALF, deblocking, SAO, bilateral filter, LMCS, and the corresponding variants, and etc.).

It is noted that the terminologies mentioned below are not limited to the specific ones defined in existing standards. Any variance of the coding tool is also applicable.
4.1 For example, the content type of a video unit may be determined based on sample values within or neighboring to the video unit.
   1) For example, the video unit may be a block/subblock/CU/PU/TU/tile/slice/subpicture.
   2) For example, it may be based on prediction samples of the current video unit.
      a. For example, the prediction samples may be before OBMC blending/fusion/weighting.
      b. For example, the prediction samples may be before MHP blending/fusion/weighting.
      c. For example, the prediction samples may be before BCW blending/fusion/weighting.
      d. For example, the prediction samples may be before CIIP blending/fusion/weighting.
      e. For example, the prediction samples may be before GPM/SGPM blending/fusion/weighting.
      f. For example, the prediction samples may be before bi-directional blending/fusion/weighting.
      g. For example, the prediction samples may be before prediction sample refinement process (such as BDOF, PROF, LIC, OBMC, etc.).
      h. For example, the prediction samples may be before sample filtering process (such as PDPC, CIIP-PDPC, gradient-PDPC, reference sample filtering/smoothing, prediction sample filtering/smoothing, etc.).
   3) For example, it may be based on prediction samples neighboring to the current video unit.
   4) For example, it may be based on reconstruction samples neighboring to the current video unit.
      a. For example, the reconstruction samples may be before sample filtering process (such as bilateral filtering, deblocking, neural-network-based filtering, LMCS, SAO, CCSAO, ALF, CCALF, motion compensation based temporal filtering, etc.).
   5) For example, the samples used for the determination may be derived based on subsampling process.
      a. For example, the subsampling factor may be determined based on the current block width/height.
      b. For example, the subsampling factor may be determined based on the neighbor block width/height.
      c. For example, the subsampling factor may be pre-defined as a fixed value.
   6) For example, it may be based on gradients/directions/angles (or histogram of gradients/directions/angles) of certain samples.
      a. For example, the histogram of gradients/directions/angles may be computed based on counting gradients along certain directions/angles.
         i. For example, the certain directions/angles may be pre-defined.
         ii. For example, the certain directions/angles may be based on the directions of intra prediction angular modes in video coding.
         iii. For example, for a certain direction/angle, a gradient amplitude may be computed based on counting the (amplitudes of) gradients of at least one sample in specified region.
      b. For example, the histogram of gradients/directions/angles may be computed based on dividing the entire range of directions/angles into a series of intervals/bins.
      c. For example, the histogram of gradients/directions/angles may be computed based on counting the (amplitudes of) gradients in each interval/bin/direction/angle.
   7) For example, it may be based on colors/luminance/intensity (or histogram of colors/luminance/intensity) of certain samples.
      a. For example, the histogram of colors/luminance/intensity may be computed based on counting the sample values in Y and/or U and/or V (or, R and/or G and/or B) component domain.
         i. For example, the sample values at a series of certain positions in the current video unit may be counted.
         ii. For example, the sample values of all samples in the current video unit may be counted.
         iii. For example, the sample values at certain positions neighboring to the current video unit may be counted.
         iv. For example, the sample values of all samples (on the left and/or top) neighboring to the current video unit may be counted.
      b. For example, the histogram of colors/luminance/intensity may be computed based on dividing the entire range of colors/luminance/intensity values into a series of intervals/bins.
      c. For example, the histogram of colors/luminance/intensity may be computed based on counting the number of samples in each interval/bin.
   8) For example, it may be based on the number of main gradients/directions/angles/colors/luminance/intensity of samples inside the current video unit (and/or neighboring to the current video unit).
      a. For example, it may be derived based on the histogram of gradients/directions/angles/colors/luminance/intensity.
      b. For example, it may be derived based on how many intervals/bins in the histogram show values (e.g., gradient amplitudes, color values, luminance values) greater than a threshold.
      c. For example, it may be derived based on how many intervals/bins in the histogram provide much greater values (e.g., gradient amplitudes, color values, luminance values) than the values of other intervals/bins.
         i. For example, the values of intervals/bins in the histogram may be sorted firstly—assume the values after sorting (e.g., from large to small) are represented by X₀, X₁, X₂ . . . , Xₙ₋₂, Xₙ₋₁, wherein n intervals/bins are included in the histogram—if Xᵢ>=a*(Xᵢ₊₁), then the intervals/bins from 0 to i may be treated as main gradients, wherein a denotes a scale factor (e.g., a may be equal to a constant between 2 and 20).
         ii. For example, if the number of main gradients/directions/angles/colors/luminance/intensity is less than a certain number (e.g., 1 or 2 or 3 or 4 or 5 or 6 or 7 or 8 or 9), a particular coding tool may not be applied to the video unit.
4.2 For example, the content type of a video unit may be determined based on the prediction mode of neighbor video units.
   1) For example, the neighbor may be spatial/temporal neighboring blocks adjacent/non-adjacent to the current block.
      a. For example, the neighbor blocks may be adjacent to the current block.
      b. For example, the neighbor blocks may be non-adjacent to the current block.
      c. For example, the neighbor blocks may be spatial neighbor blocks inside the current picture.
      d. For example, the neighbor blocks may be temporal blocks in a reference picture.
      e. For example, the neighbor blocks may be subblocks (e.g., 4×4 or 8×8) smaller than the current block.
      f. For example, the neighbor blocks may be video units larger than or equal to the current block.
   2) For example, the neighbor may be a reference block.
      a. For example, the reference block may be a block/subblock identified based on adding a displacement (e.g., pre-defined, or based on motion vector, or based on block vector) to the location of a first block.
         a. For example, the first block may be the current block.
         b. For example, the first block may be a neighbor of the current block.
         c. For example, the first block may be a reference of the current block.
   3) For example, the neighbor may be a reference block of a reference block.
      a. For example, the reference block of a reference block may be identified by adding a motion vector associated with an INTER mode coded reference block and the position of such INTER coded reference block.
      b. For example, the reference block of a reference block may be identified by adding a block vector associated with a IntraTMP mode coded reference block and the position of such IntraTMP coded reference block.
      c. For example, the reference block of a reference block may be identified by adding a block vector associated with a IBC mode coded reference block and the position of such IBC coded reference block.
4.3 For example, a prediction mode decision may be implicitly determined by the results of video content detection.
   1) For example, if the content type resultant from a video content detection indicates that the current video unit belongs to a certain type (e.g., screen content), a particular tool may not be allowed/used/applied to the video unit.
      a. For example, a tool on/off flag for a particular prediction mode at the video unit level may not be signalled.
      b. For example, a tool on/off flag for a particular prediction mode at the video unit level may be implicitly determined without signaling (e.g., the flag is inferred to a value indicating that a particular prediction mode is not used to the video unit).
      c. For example, the particular prediction mode may be at least one of the followings:
         i. Intra luma fusion and/or it variant.
         ii. Chroma fusion and/or it variant.
         iii. IntraTMP fusion and/or it variant.
         iv. DIMD blending and/or it variant.
         v. TIMD blending and/or it variant.
         vi. Regular inter AMVP/MERGE and/or it variant.
         vii. Affine AMVP/MERGE and/or it variant.
         viii. Affine AMVP/MERGE at a certain granularity (e.g., 1×1/pixel/sample based, 4×4 subblock based) and/or it variant.
         ix. OBMC and/or it variant.
         x. LIC (and/or it variant).
         xi. SGPM blending and/or it variant.
         xii. GPM blending and/or it variant.
         xiii. CIIP and/or it variant.
         xiv. MHP and/or it variant.
         xv. BDOF and/or it variant.
         xvi. BDOF at a certain granularity (e.g., sample based, 4×4/8×8/16×16 subblock based).
         xvii. PROF and/or it variant.
         xviii. DMVR and/or it variant.
         xix. DMVR at a certain granularity (e.g., sample based, 4×4/8×8/16×16 subblock based).
         xx. AMVP-MERGE and/or it variant.
         xxi. MMVD and/or it variant.
         xxii. TM and/or it variant.
      d. For example, the particular prediction mode may be a combination of at least two of the above tools:
         i. For example, OBMC for Affine AMVP.
         ii. For example, OBMC for Affine MERGE.
         iii. For example, OBMC for Inter AMVP.
         iv. For example, OBMC for Inter MERGE.
         v. For example, OBMC for MHP when the base hypothesis is affine AMVP/MERGE.
   2) For example, if the content type resultant from a video content detection indicates that the current video unit belongs to a certain type (e.g., natural content, camera-captured content), a particular tool may not be used to the video unit.
      a. For example, the block level on/off flag may not be signalled.
      b. For example, the block level on/off flag may be implicitly derived (e.g., equal to a value indicating that the particular tool is not used to the video unit).
      c. For example, the particular tool may be at least one of the followings:
         i. IBC and/or it variant.
         ii. PLT and/or it variant.
         iii. BDPCM and/or it variant.
         iv. intraTMP and/or it variant.
         v. 1×1/pixel/sample based Affine AMVP/MERGE.
4.4 In one example, once an inter propagated mode is used for current block's coding, the location of the temporal reference block which used to derive the inter propagated mode may be restricted to the collocated CTU row.
   1) Alternatively, it may be restricted to the collocated CTU and a CTU right to the collocated CTU.
   2) Alternatively, it may be restricted to the collocated CTU and a CTU left to the collocated CTU.
   3) Alternatively, it may be restricted to not exceed M (such as M=3 or 4 or 8) row of samples above the collocated CTU.
   4) Furthermore, alternatively, only if the temporal reference block is within the restricted range/area, an inter propagated mode may be stored in a buffer.
4.5 In one example, once a temporal mode is used for current block's coding, the location of the temporal reference block which used to derive the temporal mode may be restricted to not exceed M (such as M=3 or 4 or 8) row of samples above the collocated CTU.
   1) Alternatively, it may be restricted to the collocated CTU and a CTU right to the collocated CTU.
   2) Alternatively, it may be restricted to the collocated CTU and a CTU left to the collocated CTU.
   3) Alternatively, it may be restricted to the collocated CTU row.
4.6 In one example, whether and/or how a sample blending method is applied around a certain boundary may be based on the type/characteristics of such boundary.
   1) For example, the boundary may be a left boundary of a block.
   2) For example, the boundary may be an above boundary of a block.
   3) For example, the boundary may be a partitioning boundary within a block.
   4) For example, the sample blending method may be OBMC.
   5) For example, the sample blending method may be SGPM/GPM/CIIP/MHP and/or its variant.
   6) For example, the sample blending method may be a kind of fusion based method (e.g., DIMD blending, TIMD blending, intra chroma fusion, intra luma fusion, intraTMP fusion, etc.).
   7) For example, the type/characteristics of the boundary may be determined based on samples around (or, adjacent to) the boundary.
      a. In one example, it may be based on prediction samples before the blending.
      b. In one example, it may be based on reference samples of a reference block.
      c. In one example, it may be based on gradients/directions/angles/colors/luminance/intensities of the samples.
      d. In one example, it may be based on difference between a first sample on one side of the boundary and a second sample on the other side of the boundary.
         i. For example, more than one pair of samples may be considered for the difference accumulation.
   8) For example, if the boundary belongs to a certain type, the blending method may not be applied around such boundary (e.g. but may be applied around other boundaries of the video unit).
      a. In one example, if the boundary belongs to screen content, OBMC may not be applied around such boundary.
4.7 For example, whether a certain coding tool is applied to a video unit, may be determined based on boundary types of boundaries associated with the video unit.
   1) For example, if there is one boundary of a video unit belongs to a certain type, a certain coding tool may not be applied to the video unit (e.g., inferred without signalling).
      a. In one example, if there is one boundary belongs to screen content,
         i. For example, OBMC may not be applied to the video unit.
         ii. For example, sample/pixel/1×1 affine may be applied to the video unit (e.g., inferred without signalling).
      b. In one example, if there is one boundary belongs to natural content,
         i. For example, OBMC may be applied for the video unit.
         ii. For example, sample/pixel/1×1 affine may not be applied to the video unit (e.g., inferred without signalling).
   2) Alternatively, if more than one boundary of a video unit belongs to a certain type, a certain coding tool may not be applied (e.g., inferred without signalling).
      a. In one example, if both left boundary and above boundary of the video unit belong to screen content,
         i. For example, OBMC may not be applied for the video unit.
         ii. For example, sample/pixel/1×1 affine may be applied to the video unit (e.g., inferred without signalling).
4.8 For example, whether and/or how a sample blending method is applied may be dependent on reference samples (and/or reference block) in a reference frame.
   1) For example, the sample blending method may be OBMC.
   2) For example, the sample blending method may be SGPM/GPM/CIIP/MHP and/or its variant.
   3) For example, the sample blending method may be a kind of fusion based method (e.g., DIMD blending, TIMD blending, intra chroma fusion, intra luma fusion, intraTMP fusion, etc.).
   4) For example, it may be based on gradients/directions/angles/colors/luminance/intensities of the reference samples.
   5) For example, it may be based on boundary types of the reference block.
   6) For example, it may be based on differences between reference samples around at least one reference block boundary.
   7) For example, whether to apply OBMC to an inter merge coded block may be determined based on reference samples in a reference block.
      a. For example, the inter merge coded block may be coded with one of the following modes.
         i. Regular inter merge mode (e.g., with MMVD, without MMVD, etc.).
         ii. Inter TM merge mode.
         iii. ADMVR merge mode.
         iv. CIIP merge mode (e.g., CIIP, CIIP-TM, CIIP-TIMD, etc.).
         v. GPM merge mode (e.g., GPM, GPM-MMVD, GPM-TM, GPM inter-intra, etc.).
         vi. Affine merge mode (e.g., Affine, Affine MMVD, Affine TM, regression based Affine, DMVR based Affine, sample/pixel Affine, etc.).
         vii. sbTMVP merge mode (e.g., sbTMVP, sbTMVP with TM, enhanced sbTMVP, etc.).
      b. For example, which reference picture is used for the OBMC derivation may be based on a pre-defined rule.
         i. For example, reference picture from reference list 0 may be used for a bi-directional prediction block.
         ii. For example, for a uni-directional prediction block, reference picture from the available reference list may be used by default.
      c. For example, which reference picture is used for the OBMC derivation may be based on TM cost.
      d. For example, the motion vector used to identify the position of the reference block may be the motion vector after motion vector refinement (e.g., DMVR, and/or TM refine).
         i. Alternatively, the motion vector used to identify the position of the reference block may be the motion vector before motion vector refinement (e.g., DMVR, and/or TM refine).
      e. For example, motion interpolation may not be used to identify the reference block.
         i. For example, the motion vector may be firstly rounded to integer precision then identify the reference block by such integer motion.
      f. For example, for a subblock/subpartition based inter merge mode, more than one motion vector may be used to identify the reference block.
         i. For example, more than one reference subblock may be identified by more than one subblock motion vector. The final reference block may be constructed from more than one reference subblock.
         ii. For example, for affine coded block, the motion vectors of subblocks may be calculated from control point motion vectors and the associated affine model.
      g. For example, for a subblock/subpartition based inter merge mode, the motion vector at a pre-defined position of the whole block may be used to identify the reference block.
         i. For example, the pre-defined position may refer to the center subblock.
         ii. For example, the pre-defined position may refer to the top-left subblock.
         iii. For example, for affine coded block, control point motion vectors, associated affine model, and the pre-defined position may be taken into account.
      h. For example, for a subblock/subpartition based inter merge mode, the usage of OBMC to such block may not be determined based on reference samples.
         i. For example, the inter merge mode may be affine AMVP, and/or affine merge, and/or sbTMVP merge.
         ii. For example, the inter merge mode may be GPM merge mode.
         iii. For example, the inter merge mode may be GPM inter-intra merge mode.
   8) For example, whether to apply OBMC to a block may be determined based on gradients calculated from its reference samples.
      a. For example, it may be based on histogram of gradients (e.g., HOG).
      b. For example, if the number of main gradient directions is less than a threshold T1 (e.g., T1=1 or 2 or 3), OBMC may not be applied to such block.
         i. For example, determination of main gradient directions may be based on the amplitudes of gradients calculated from HOG.
4.9 For example, whether a certain coding tool is applied to a video unit may be determined by the enabling/disabling of a blending method on the video unit.
   1) For example, sample/pixel/1×1 affine may not be applied to a video unit if OBMC is applied to such video unit.
      a. Furthermore, the enabling/disabling of OBMC on the video unit may be implicitly determined based on the above methods in bullet 4.1-4.8.
4.10 For example, whether to apply pixel/sample based affine to an affine coded block may be determined by the usage of OBMC on such block, whereas the usage of OBMC may be determined by prediction samples and/or reference information and/or neighbor information.
   1) For example, the block may be affine merge coded.
   2) For example, the neighbor information may refer to prediction/historical modes of neighboring blocks.
      a. For example, whether the prediction/historical mode is SCC coded.
      b. For example, a historical mode may refer to a prediction mode that ever used in a previous coded block in a previous coded picture and stored associated with the motion information of such neighbor block.
   3) For example, the neighbor information may refer to neighboring samples.
      a. For example, the gradients information calculated from neighboring samples.
   4) For example, the reference information may refer to prediction/historical modes of reference blocks.
      a. For example, whether the prediction/historical mode is SCC coded.
      b. For example, a historical mode may refer to a prediction mode that ever used in a previous coded block in a previous coded picture and stored associated with the motion information of such reference block.
   5) For example, the reference information may refer to reference samples in the reference block(s).
      a. For example, the gradients information calculated from reference samples.
   6) For example, the prediction samples may refer to prediction samples before the OBMC stage.
      a. For example, the gradients information calculated from prediction samples.
4.11 In above bullets, once gradients are calculated, the gradients of which samples are computed may be based on a pre-defined rule.
   1) For example, the gradient of all samples in the prediction block (or reference block, or neighbor block) may be computed.
   2) For example, the gradient of partial of samples at pre-defined locations in the prediction block (or reference block, or neighbor block) may be computed.
      a. For example, the gradient of subsampled samples at pre-defined locations in the prediction block (or reference block, or neighbor block) may be computed.
         i. For example, suppose samples are looped along with width and height directions with a step size, the values of step sizes in width and/or height directions (e.g., denoted by wStep and hStep) may be determined based on block width and/or block height (e.g., denoted by uiWidth and uiHeight).
         1. For example, wStep may be set as one of the following:
         a. wStep=uiWidth<=T1?F1:(uiWidth<=T2?F2:F3), wherein T1=64, T2=128, F1=1, F2=2, F3=4.
         b. wStep=uiWidth<=T0?F0: (uiWidth<=T1?F1:(uiWidth<=T2?F2:F3)), wherein T0=32, T1=64, T2=128, F0=1, F1=2, F2=4, F3=8.
         c. wStep=(uiWidth>>S0)+offset, wherein S0=1, offset=−1 or 0.
         2. For example, hStep may be set as one of the following:
         a. hStep=uiHeight<=T1?F1:(uiHeight<=T2?F2:F3), wherein T1=64, T2=128, F1=1, F2=2, F3=4.
         b. hStep=uiHeight<=T0?F0:(uiHeight<=T1?F1:(uiHeight<=T2?F2:F3)), wherein T0=32, T1=64, T2=128, F0=1, F1=2, F2=4, F3=8.
         c. hStep=(uiHeight>>S0)+offset, wherein S0=1, offset=−1 or 0.
      b. For example, the gradient of corner samples in the prediction block (or reference block, or neighbor block) may be computed.
         i. For example, the corner samples may refer to top-left, and/or top-right, and/or bottom-left, and/or bottom-right samples in the block.
      c. For example, the gradient of the center sample in the prediction block (or reference block, or neighbor block) may be computed.
4.12 Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
4.13 Whether to and/or how to apply the disclosed methods above may be signalled at PB/TB/CB/PU/TU/CU/VPDU/CTU/CTU row/slice/tile/sub-picture/other kinds of region contain more than one sample or pixel.
4.14 Whether to and/or how to apply the disclosed methods above may be dependent on coded information, such as block size, colour format, single/dual tree partitioning, colour component, slice/picture type.

More details of the embodiments of the present disclosure will be described below which are related to coding tool control. The embodiments of the present disclosure should be considered as examples to explain the general concepts and should not be interpreted in a narrow way. Furthermore, these embodiments can be applied individually or combined in any manner.

As used herein, the term “video unit” may represent a block, a subblock, a coding tree block (CTB), a coding tree unit (CTU), a coding block (CB), a coding unit (CU), a prediction unit (PU), a transform unit (TU), a prediction block (PB), a transform block (TB), a tile, a slice, a subpicture, a video processing unit comprising multiple samples/pixels, and/or the like. A video unit may be rectangular or non-rectangular.

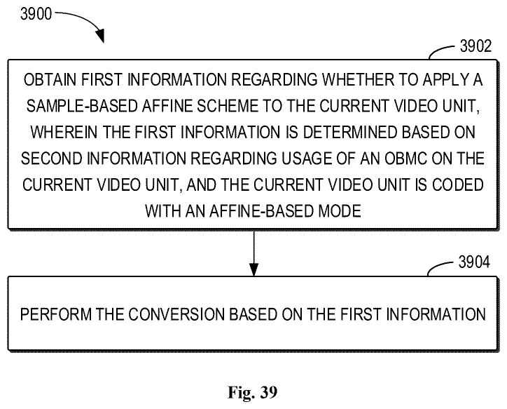

FIG. 39 illustrates a flowchart of a method 3900 for video processing in accordance with some embodiments of the present disclosure. The method 3900 may be implemented during a conversion between a current video unit of a video and a bitstream of the video. As shown in FIG. 39, the method 3900 starts at 3902, where first information regarding whether to apply a sample-based affine scheme to the current video unit is obtained. The first information is determined based on second information regarding usage of an overlap subblock based motion compensation (OBMC) on the current video unit, and the current video unit is coded with an affine-based mode. For example, the affine-based mode may comprise a regular affine mode, an affine merge mode, or the like.

For example, whether the affine-based mode used to code the current video unit is sample-based is dependent on the second information regarding usage of OBMC. As used herein, the sample based affine mode may also be referred to as a pixel-based affine mode.

In some embodiments, the second information may comprise whether to use the OBMC on the current video unit. Additionally or alternatively, the second information may comprise how to use the OBMC on the current video unit. It should be understood that the second information may also comprise any other suitable information regarding the usage of OBMC, e.g., the object to which the OBMC is applied, when to apply the OBMC, and/or the like.

In some embodiments, the second information may be determined based on prediction samples of the current video unit, information associated with a reference video unit of the current video unit, and/or information associated with a neighboring video unit of the current video unit. This will be described in details below.

At 3904, the conversion is performed based on the first information. For example, if the first information indicates that the sample-based affine scheme is applied on the current video unit, the sample-based affine scheme may be used to coding the current video block. If the first information indicates that the sample-based affine scheme is not applied on the current video unit, the current video block may be coded without using the sample-based affine scheme.

In some embodiments, the conversion may include encoding the current video unit into the bitstream. Alternatively or additionally, the conversion may include decoding the current video unit from the bitstream. It should be understood that the above illustrations are described merely for purpose of description. The scope of the present disclosure is not limited in this respect.

In view of the above, the information regarding whether to apply a sample-based affine scheme to an affine coded video unit is dependent on the usage of OBMC. Compared with the conventional solution, the proposed method can advantageously enable adaptive control of the sample-based affine scheme, and thus the sample-based affine scheme can be controlled more flexibly. Thereby, the coding quality can be improved.

As used herein, the information associated with the neighboring video unit may also be referred to as neighbor information. In some embodiments, the neighbor information may comprise a prediction mode of the neighboring video unit, a historical mode of the neighboring video unit, and/or the like. For example, the neighbor information may comprise at least one of the following: whether a prediction mode of the neighboring video unit is a screen content coding (SCC) mode, or whether a historical mode of the neighboring video unit is an SCC mode. By way of example, the historical mode of the neighboring video unit may comprise a prediction mode that is used to code a video unit of a previously coded picture and stored associated with motion information of the neighboring video unit. The previously coded picture is coded before the neighboring video unit.

Additionally or alternatively, the neighbor information may comprise samples of the neighboring video unit. For example, the neighbor information may comprise gradient information determined based on samples of the neighboring video unit.

As used herein, the information associated with the reference video unit may also be referred to as reference information. For example, the reference information may comprise a prediction mode of the reference video unit, a historical mode of the reference video unit, and/or the like. By way of example, the reference information may comprise at least one of the following: whether a prediction mode of the reference video unit is an SCC mode, or whether a historical mode of the reference video unit is an SCC mode. By way of example, the historical mode of the reference video unit may comprise a prediction mode that is used to code a video unit of a previously coded picture and stored associated with motion information of the reference video unit. The previously coded picture is coded before the reference video unit.

Additionally or alternatively, the reference information may comprise samples of the reference video unit. For example, the reference information may comprise gradient information determined based on samples of the reference video unit.

In some embodiments, the prediction samples of the current video unit are determined without applying the OBMC. In other words, the prediction samples of the current video unit may refer to prediction samples before the OBMC stage. For example, the second information may be determined based on gradient information generated based on the prediction samples of the current video unit.

In some embodiments, if gradient information is determined from a first video unit associated with the current video unit, a set of samples in the first video unit that is used for determining the gradient information may be selected based on a pre-determined rule. For example, dependent on the solutions described above, the first video unit may comprise at least one of the following: a prediction for the current video unit, a reference video unit of the current video unit, or a neighboring video unit of the current video unit.

In some embodiments, the set of samples may comprise all samples of the first video unit. In other words, all samples of the first video unit are used to determine the gradient information. Alternatively, the set of samples may comprise a plurality of samples of the first video unit that are at predetermined positions.

In one example embodiment, the plurality of samples may be obtained based on a subsampling process. For example, the plurality of samples may be looped along a width direction of the first video unit with a first step size and along a height direction of the first video unit a second step size. By way of example, the first step size and/or the second step size may be determined based on a width of the first video unit and/or a height of the first video unit.

In one example, the first step size may be determined as follows:

$$wStep = uiWidth <= T 1 ? F 1 : ( uiWidth <= T 2 ? F 2 : F 3 ) ,$$

where wStep represents the first step size, uiWidth represents the width of the first video unit, each of T1, F1, T2, F2, and F3 may be a non-negative integer. A ternary conditional operation (a?b:c) is defined as follows: if condition a is true, then the result of the ternary conditional operation is equal to b; otherwise the result of ternary conditional operation is equal to c.

In another example, the first step size may be determined as follows:

$$wStep = uiWidth <= T 0 ? F 0 : ( uiWidth <= T 1 ? F 1 : ( uiWidth <= T 2 ? F 2 : F 3 ) ) ,$$

where wStep represents the first step size, uiWidth represents the width of the first video unit, each of T0, F0, T1, F1, T2, F2, and F3 may be a non-negative integer.

In a further example, the first step size may be determined as follows:

$$wStep = ( uiWidth ≫ S 0 ) + offset ,$$

where wStep represents the first step size, uiWidth represents the width of the first video unit, each of S0 and offset may be an integer.

Additionally or alternatively, the second step size may be determined as follows:

$$hStep = uiHeight <= T 1 ? F 1 : ( uiHeight <= T 2 ? F 2 : F 3 ) ,$$

where hStep represents the second step size, uiHeight represents the height of the second video unit, each of T1, F1, T2, F2, and F3 may be a non-negative integer.

In another example, the second step size may be determined as follows:

$$hStep = uiHeight <= T 0 ? F 0 : ( uiHeight <= T 1 ? F 1 : ( uiHeight <= T 2 ? F 2 : F 3 ) ) ,$$

where hStep represents the second step size, uiHeight represents the height of the second video unit, each of T0, F0, T1, F1, T2, F2, and F3 may be a non-negative integer.

In a further example, the second step size may be determined as follows:

$$hStep = ( uiHeight ≫ S 0 ) + offset ,$$

where hStep represents the second step size, uiHeight represents the height of the second video unit, each of S0 and offset may be an integer. It should be understood that the above examples are described merely for purpose of description. The scope of the present disclosure is not limited in this respect.

In some further embodiments, the set of samples may comprise at least one corner sample within the first video unit. By way of example, the at least one corner sample may comprise a top-left sample, a top-right sample, a bottom-left sample, and/or a bottom-right sample. In some still further embodiments, the set of samples may comprise a center sample within the first video unit.

In view of the above, the solutions in accordance with some embodiments of the present disclosure can advantageously improve coding efficiency and coding quality.

According to further embodiments of the present disclosure, a non-transitory computer-readable recording medium is provided. The non-transitory computer-readable recording medium stores a bitstream of a video which is generated by a method performed by an apparatus for video processing. In the method, first information regarding whether to apply a sample-based affine scheme to a current video unit of the video is obtained. The first information is determined based on second information regarding usage of an overlap subblock based motion compensation (OBMC) on the current video unit, and the current video unit is coded with an affine-based mode. Moreover, the bitstream is generated based on the first information.

According to still further embodiments of the present disclosure, a method for storing bitstream of a video is provided. In the method, first information regarding whether to apply a sample-based affine scheme to a current video unit of the video is obtained. The first information is determined based on second information regarding usage of an overlap subblock based motion compensation (OBMC) on the current video unit, and the current video unit is coded with an affine-based mode. Moreover, the bitstream is generated based on the first information, and stored in a non-transitory computer-readable recording medium.

Implementations of the present disclosure can be described in view of the following clauses, the features of which can be combined in any reasonable manner.

Clause 1. A method for video processing, comprising: obtaining, for a conversion between a current video unit of a video and a bitstream of the video, first information regarding whether to apply a sample-based affine scheme to the current video unit, wherein the first information is determined based on second information regarding usage of an overlap subblock based motion compensation (OBMC) on the current video unit, and the current video unit is coded with an affine-based mode; and performing the conversion based on the first information.

Clause 2. The method of clause 1, wherein the second information comprises whether to use the OBMC on the current video unit.

Clause 3. The method of any of clauses 1-2, wherein the second information is determined based on at least one of the following: prediction samples of the current video unit, information associated with a reference video unit of the current video unit, or information associated with a neighboring video unit of the current video unit.

Clause 4. The method of any of clauses 1-3, wherein the affine-based mode comprises an affine merge mode.

Clause 5. The method of any of clauses 3-4, wherein the information associated with the neighboring video unit comprises at least one of the following: a prediction mode of the neighboring video unit, or a historical mode of the neighboring video unit.

Clause 6. The method of any of clauses 3-5, wherein the information associated with the neighboring video unit comprises at least one of the following: whether a prediction mode of the neighboring video unit is a screen content coding (SCC) mode, or whether a historical mode of the neighboring video unit is an SCC mode.

Clause 7. The method of any of clauses 5-6, wherein the historical mode of the neighboring video unit comprises a prediction mode that is used to code a video unit of a picture and stored associated with motion information of the neighboring video unit, and the picture is coded before the neighboring video unit.

Clause 8. The method of any of clauses 3-7, wherein the information associated with the neighboring video unit comprises samples of the neighboring video unit.

Clause 9. The method of any of clauses 3-8, wherein the information associated with the neighboring video unit comprises gradient information determined based on samples of the neighboring video unit.

Clause 10. The method of any of clauses 3-9, wherein the information associated with the reference video unit comprises at least one of the following: a prediction mode of the reference video unit, or a historical mode of the reference video unit.

Clause 11. The method of any of clauses 3-10, wherein the information associated with the reference video unit comprises at least one of the following: whether a prediction mode of the reference video unit is an SCC mode, or whether a historical mode of the reference video unit is an SCC mode.

Clause 12. The method of any of clauses 10-11, wherein the historical mode of the reference video unit comprises a prediction mode that is used to code a video unit of a picture and stored associated with motion information of the reference video unit, and the picture is coded before the reference video unit.

Clause 13. The method of any of clauses 3-12, wherein the information associated with the reference video unit comprises samples of the reference video unit.

Clause 14. The method of any of clauses 3-13, wherein the information associated with the reference video unit comprises gradient information determined based on samples of the reference video unit.

Clause 15. The method of any of clauses 3-14, wherein the prediction samples of the current video unit are determined without applying the OBMC.

Clause 16. The method of any of clauses 3-15, wherein the second information is determined based on gradient information generated based on the prediction samples of the current video unit.

Clause 17. The method of any of clauses 1-16, wherein if gradient information is determined from a first video unit associated with the current video unit, a set of samples in the first video unit that is used for determining the gradient information is selected based on a pre-determined rule.

Clause 18. The method of clause 17, wherein the first video unit comprises at least one of the following: a prediction for the current video unit, a reference video unit of the current video unit, or a neighboring video unit of the current video unit.

Clause 19. The method of any of clauses 17-18, wherein the set of samples comprises all samples of the first video unit.

Clause 20. The method of any of clauses 17-18, wherein the set of samples comprises a plurality of samples of the first video unit that are at predetermined positions.

Clause 21. The method of clause 20, wherein the plurality of samples are obtained based on a subsampling process.

Clause 22. The method of clause 21, wherein the plurality of samples are looped along a width direction of the first video unit with a first step size and along a height direction of the first video unit a second step size.

Clause 23. The method of clause 22, wherein the first step size and/or the second step size is determined based on at least one of the following: a width of the first video unit, or a height of the first video unit.

Clause 24. The method of clause 23, wherein the first step size is determined as follows: wStep=uiWidth<=T1?F1:(uiWidth<=T2?F2:F3), where wStep represents the first step size, uiWidth represents the width of the first video unit, each of T1, F1, T2, F2, and F3 is a non-negative integer.

Clause 25. The method of clause 23, wherein the first step size is determined as follows: wStep=uiWidth<=T0?F0:(uiWidth<=T1?F1:(uiWidth<=T2?F2:F3)), where wStep represents the first step size, uiWidth represents the width of the first video unit, each of T0, F0, T1, F1, T2, F2, and F3 is a non-negative integer.

Clause 26. The method of clause 23, wherein the first step size is determined as follows: wStep=(uiWidth>>S0)+offset, where wStep represents the first step size, uiWidth represents the width of the first video unit, each of S0 and offset is an integer.

Clause 27. The method of any of clauses 23-26, wherein the second step size is determined as follows: hStep=uiHeight<=T1?F1:(uiHeight<=T2?F2:F3), where hStep represents the second step size, uiHeight represents the height of the second video unit, each of T1, F1, T2, F2, and F3 is a non-negative integer.

Clause 28. The method of any of clauses 23-26, wherein the second step size is determined as follows: hStep=uiHeight<=T0?F0:(uiHeight<=T1?F1:(uiHeight<=T2?F2:F3)), where hStep represents the second step size, uiHeight represents the height of the second video unit, each of T0, F0, T1, F1, T2, F2, and F3 is a non-negative integer.

Clause 29. The method of any of clauses 23-26, wherein the second step size is determined as follows: hStep=(uiHeight>>S0)+offset, where hStep represents the second step size, uiHeight represents the height of the second video unit, each of S0 and offset is an integer.

Clause 30. The method of any of clauses 20-29, wherein the set of samples comprises at least one corner sample within the first video unit.

Clause 31. The method of clause 30, wherein the at least one corner sample comprises at least one of the following: a top-left sample, a top-right sample, a bottom-left sample, or a bottom-right sample.

Clause 32. The method of clauses 20-31, wherein the set of samples comprises a center sample within the first video unit.

Clause 33. The method of any of clauses 1-32, wherein the current video unit comprises one of the following: a block, a subblock, a coding unit (CU), a prediction unit (PU), a transform unit (TU), a tile, a slice, or a subpicture.

Clause 34. The method of any of clauses 1-33, wherein the conversion includes encoding the current video unit into the bitstream.

Clause 35. The method of any of clauses 1-33, wherein the conversion includes decoding the current video unit from the bitstream.

Clause 36. An apparatus for video processing comprising a processor and a non-transitory memory with instructions thereon, wherein the instructions upon execution by the processor, cause the processor to perform a method in accordance with any of clauses 1-35.

Clause 37. A non-transitory computer-readable storage medium storing instructions that cause a processor to perform a method in accordance with any of clauses 1-35.

Clause 38. A non-transitory computer-readable recording medium storing a bitstream of a video which is generated by a method performed by an apparatus for video processing, wherein the method comprises: obtaining first information regarding whether to apply a sample-based affine scheme to a current video unit of the video, wherein the first information is determined based on second information regarding usage of an overlap subblock based motion compensation (OBMC) on the current video unit, and the current video unit is coded with an affine-based mode; and generating the bitstream based on the first information.

Clause 39. A method for storing a bitstream of a video, comprising: obtaining first information regarding whether to apply a sample-based affine scheme to a current video unit of the video, wherein the first information is determined based on second information regarding usage of an overlap subblock based motion compensation (OBMC) on the current video unit, and the current video unit is coded with an affine-based mode; generating the bitstream based on the first information; and storing the bitstream in a non-transitory computer-readable recording medium.

### Example Device

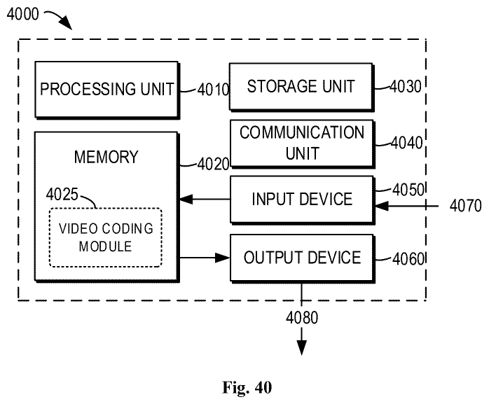

FIG. 40 illustrates a block diagram of a computing device 4000 in which various embodiments of the present disclosure can be implemented. The computing device 4000 may be implemented as or included in the source device 110 (or the video encoder 114 or 200) or the destination device 120 (or the video decoder 124 or 300).

It would be appreciated that the computing device 4000 shown in FIG. 40 is merely for purpose of illustration, without suggesting any limitation to the functions and scopes of the embodiments of the present disclosure in any manner.

As shown in FIG. 40, the computing device 4000 includes a general-purpose computing device 4000. The computing device 4000 may at least comprise one or more processors or processing units 4010, a memory 4020, a storage unit 4030, one or more communication units 4040, one or more input devices 4050, and one or more output devices 4060.

In some embodiments, the computing device 4000 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 4000 can support any type of interface to a user (such as “wearable” circuitry and the like).

The processing unit 4010 may be a physical or virtual processor and can implement various processes based on programs stored in the memory 4020. In a multi-processor system, multiple processing units execute computer executable instructions in parallel so as to improve the parallel processing capability of the computing device 4000. The processing unit 4010 may also be referred to as a central processing unit (CPU), a microprocessor, a controller or a microcontroller.

The computing device 4000 typically includes various computer storage medium. Such medium can be any medium accessible by the computing device 4000, including, but not limited to, volatile and non-volatile medium, or detachable and non-detachable medium. The memory 4020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 4030 may be any detachable or non-detachable medium and may include a machine-readable medium such as a memory, flash memory drive, magnetic disk or another other media, which can be used for storing information and/or data and can be accessed in the computing device 4000.

The computing device 4000 may further include additional detachable/non-detachable, volatile/non-volatile memory medium. Although not shown in FIG. 40, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 4040 communicates with a further computing device via the communication medium. In addition, the functions of the components in the computing device 4000 can be implemented by a single computing cluster or multiple computing machines that can communicate via communication connections. Therefore, the computing device 4000 can operate in a networked environment using a logical connection with one or more other servers, networked personal computers (PCs) or further general network nodes.

The input device 4050 may be one or more of a variety of input devices, such as a mouse, keyboard, tracking ball, voice-input device, and the like. The output device 4060 may be one or more of a variety of output devices, such as a display, loudspeaker, printer, and the like. By means of the communication unit 4040, the computing device 4000 can further communicate with one or more external devices (not shown) such as the storage devices and display device, with one or more devices enabling the user to interact with the computing device 4000, or any devices (such as a network card, a modem and the like) enabling the computing device 4000 to communicate with one or more other computing devices, if required. Such communication can be performed via input/output (I/O) interfaces (not shown).

In some embodiments, instead of being integrated in a single device, some or all components of the computing device 4000 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 4000 may be used to implement video encoding/decoding in embodiments of the present disclosure. The memory 4020 may include one or more video coding modules 4025 having one or more program instructions. These modules are accessible and executable by the processing unit 4010 to perform the functionalities of the various embodiments described herein.

In the example embodiments of performing video encoding, the input device 4050 may receive video data as an input 4070 to be encoded. The video data may be processed, for example, by the video coding module 4025, to generate an encoded bitstream. The encoded bitstream may be provided via the output device 4060 as an output 4080.

In the example embodiments of performing video decoding, the input device 4050 may receive an encoded bitstream as the input 4070. The encoded bitstream may be processed, for example, by the video coding module 4025, to generate decoded video data. The decoded video data may be provided via the output device 4060 as the output 4080.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
obtaining, for a conversion between a current video unit of a video and a bitstream of the video, first information regarding whether to apply a sample-based affine scheme to the current video unit, wherein the first information is determined based on second information regarding usage of an overlap subblock based motion compensation (OBMC) on the current video unit, and the current video unit is coded with an affine-based mode; and
performing the conversion based on the first information.

2. The method of claim 1, wherein the second information comprises whether to use the OBMC on the current video unit.

3. The method of claim 1, wherein the second information is determined based on at least one of the following:
prediction samples of the current video unit,
information associated with a reference video unit of the current video unit, or
information associated with a neighboring video unit of the current video unit.

4. The method of claim 1, wherein the affine-based mode comprises an affine merge mode.

5. The method of claim 1, wherein the information associated with the neighboring video unit comprises at least one of the following:
a prediction mode of the neighboring video unit, or
a historical mode of the neighboring video unit.

6. The method of claim 3, wherein the information associated with the neighboring video unit comprises at least one of the following:
whether a prediction mode of the neighboring video unit is a screen content coding (SCC) mode, or
whether a historical mode of the neighboring video unit is an SCC mode.

7. The method of claim 5, wherein the historical mode of the neighboring video unit comprises a prediction mode that is used to code a video unit of a picture and stored associated with motion information of the neighboring video unit, and the picture is coded before the neighboring video unit.

8. The method of claim 3, wherein the information associated with the neighboring video unit comprises samples of the neighboring video unit.

9. The method of claim 3, wherein the information associated with the neighboring video unit comprises gradient information determined based on samples of the neighboring video unit.

10. The method of claim 3, wherein the information associated with the reference video unit comprises at least one of the following:
a prediction mode of the reference video unit, or
a historical mode of the reference video unit.

11. The method of claim 3, wherein the information associated with the reference video unit comprises at least one of the following:
whether a prediction mode of the reference video unit is an SCC mode, or
whether a historical mode of the reference video unit is an SCC mode.

12. The method of claim 10, wherein the historical mode of the reference video unit comprises a prediction mode that is used to code a video unit of a picture and stored associated with motion information of the reference video unit, and the picture is coded before the reference video unit.

13. The method of claim 3, wherein the information associated with the reference video unit comprises samples of the reference video unit.

14. The method of claim 3, wherein the information associated with the reference video unit comprises gradient information determined based on samples of the reference video unit, or
wherein the prediction samples of the current video unit are determined without applying the OBMC, or
wherein the second information is determined based on gradient information generated based on the prediction samples of the current video unit.

15. The method of claim 1, wherein the current video unit comprises one of the following:
a block,
a subblock,
a coding unit (CU),
a prediction unit (PU),
a transform unit (TU),
a tile,
a slice, or
a subpicture.

16. The method of claim 1, wherein the conversion includes encoding the current video unit into the bitstream.

17. The method of claim 1, wherein the conversion includes decoding the current video unit from the bitstream.

18. An apparatus for video processing comprising a processor and a non-transitory memory with instructions thereon, wherein the instructions upon execution by the processor, cause the processor to perform acts comprising:
obtaining, for a conversion between a current video unit of a video and a bitstream of the video, first information regarding whether to apply a sample-based affine scheme to the current video unit, wherein the first information is determined based on second information regarding usage of an overlap subblock based motion compensation (OBMC) on the current video unit, and the current video unit is coded with an affine-based mode; and
performing the conversion based on the first information.

19. A non-transitory computer-readable storage medium storing instructions that cause a processor to perform acts comprising:
obtaining, for a conversion between a current video unit of a video and a bitstream of the video, first information regarding whether to apply a sample-based affine scheme to the current video unit, wherein the first information is determined based on second information regarding usage of an overlap subblock based motion compensation (OBMC) on the current video unit, and the current video unit is coded with an affine-based mode; and
performing the conversion based on the first information.

20. A non-transitory computer-readable recording medium storing a bitstream of a video which is generated by a method performed by an apparatus for video processing, wherein the method comprises:
obtaining first information regarding whether to apply a sample-based affine scheme to a current video unit of the video, wherein the first information is determined based on second information regarding usage of an overlap subblock based motion compensation (OBMC) on the current video unit, and the current video unit is coded with an affine-based mode; and
generating the bitstream based on the first information.
